(19) United States
(12) Patent Application Publication
(10) Pub. No.: US 2010/0149652 A1
(43) Pub. Date: Jun. 17, 2010

(54) Zoom lens having diffraction-type optical element and image pickup apparatus using the same

(76) Inventors: Ayami Imamura, Tokyo-to (JP); Hisashi Goto, Tokyo-to (JP)

Correspondence Address: KENYON & KENYON LLP, ONE BROADWAY, NEW YORK, NY, 10004, US

(21) Appl. No.: 12/590,799

(22) Filed: Nov. 12, 2009

(30) Foreign Application Priority Data
Nov. 17, 2008 (JP) 2008-293156

(51) Int. Cl. G02B 15/00

(52) U.S. Cl. 359/676

(57) ABSTRACT

A zoom lens is provided with, in order from the object side, at least, a positive first group with a diffraction-type optical element, a positive second group, and a negative third group. A space between the first and second groups and a space between the second and third groups are increased in changing a magnification from the wide-angle end position to the telephoto end position, and the third group is fixed.

This application claims benefits of Japanese Patent Application No. 2008-293156 filed in Japan on Nov. 17, 2008, the contents of which are hereby incorporated by reference.

### BACKGROUND OF THE INVENTION

1. Field of the Invention

This invention relates to a telephoto zoom lens with a large diameter which is applicable to an exchange lens for a film-based or digital single-lens reflex camera and relates to an electronic image pickup apparatus using the same.

2. Description of the Related Art

Up to now, a telephoto zoom lens having a diffraction-type optical element is known as a telephoto zoom lens which is used as an exchange lens for a single-lens reflex camera. Japanese Patent Kokai No. 2003-215457 and Japanese Patent Kokai No. Hei 11-133305 disclose one example of such telephoto zoom lens.

### SUMMARY OF THE INVENTION

A zoom lens of the present first invention is characterized in that: the zoom lens comprises, in order from the object side, at least, a positive first group with a diffraction-type optical element, a positive second group, and a negative third group; a space between the first and second groups and a space between the second and third groups increase in changing a magnification from the wide-angle end position to the telephoto end position; and the third group is fixed.

Besides, it is preferred that: a zoom lens of the present first invention comprises, in order from the object side, the positive first group with a diffraction-type optical element, the positive second group, the negative third group, a positive fourth group, and a positive fifth group; and the zoom lens is formed in such a way that each of spaces between the groups changes in changing a magnification.

A zoom lens of the present second invention is characterized in that: the zoom lens comprises, in order from the object side, a positive first group with a diffraction-type optical element, a positive second group, a negative third group, a positive fourth group, and a positive fifth group; and, in changing a magnification, at least the first group is capable of moving, and each of spaces between the groups changes.

Besides, it is preferred that, in a zoom lens of the present second invention, the first group is located on the object side more in the telephoto end position than in the wide-angle end position.

An image pickup apparatus of the present invention comprises any one of the above-described zoom lenses and an image pickup element which is arranged on the image side of the zoom lens and transforms an image formed by the zoom lens into electrical signals.

### BRIEF DESCRIPTION OF THE DRAWINGS

FIGS. 1A and 1B are a sectional view showing an optical formation in infinite object point focusing of an image pickup apparatus provided with a zoom lens according to the first embodiment of the present invention, taken along the optical axis. And, FIGS. 1A and 1B show the states in wide-angle end and telephoto end positions, respectively.

FIGS. 2A, 2B, 2C, and 2D are views showing spherical aberration, astigmatism, distortion, and chromatic aberration of magnification in infinite object point focusing of the zoom lens shown in FIGS. 1A and 1B in the wide-angle end position, respectively. And, FIGS. 2E, 2F, 2G, and 2H are views showing spherical aberration, astigmatism, distortion, and chromatic aberration of magnification in infinite object point focusing of the zoom lens shown in FIGS. 1A and 1B in the telephoto end position, respectively.

FIGS. 3A and 3B are a sectional view showing an optical formation in infinite object point focusing of an image pickup apparatus provided with a zoom lens according to the second embodiment of the present invention, taken along the optical axis. And, FIGS. 3A and 3B show the states in wide-angle end and telephoto end positions, respectively.

FIGS. 4A and 4B are a sectional view showing an optical formation in close-far object point focusing of the image pickup apparatus provided with the zoom lens according to the second embodiment of the present invention, taken along the optical axis. And, FIGS. 4A and 4B show the states in wide-angle end and telephoto end positions, respectively.

FIGS. 5A, 5B, 5C, and 5D are views showing spherical aberration, astigmatism, distortion, and chromatic aberration of magnification in infinite object point focusing of the zoom lens shown in FIGS. 3A, 3B, 4A, and 4B in the wide-angle end position, respectively. And, FIGS. 5E, 5F, 5G, and 5H are views showing spherical aberration, astigmatism, distortion, and chromatic aberration of magnification in infinite object point focusing of the zoom lens shown in FIGS. 3A, 3B, 4A, and 4B in the telephoto end position, respectively.

FIGS. 6A, 6B, 6C, and 6D are views showing spherical aberration, astigmatism, distortion, and chromatic aberration of magnification in close object point focusing of the zoom lens shown in FIGS. 3A, 3B, 4A, and 4B in the wide-angle end position, respectively. And, FIGS. 6E, 6F, 6G, and 6H are views showing spherical aberration, astigmatism, distortion, and chromatic aberration of magnification in close object point focusing of the zoom lens shown in FIGS. 3A, 3B, 4A, and 4B in the telephoto end position, respectively.

FIGS. 7A and 7B are a sectional view showing an optical formation in infinite object point focusing of an image pickup apparatus provided with a zoom lens according to the third embodiment of the present invention, taken along the optical axis. And, FIGS. 7A and 7B show the states in wide-angle end and telephoto end positions, respectively.

FIGS. 8A, 8B, 8C, and 8D are views showing spherical aberration, astigmatism, distortion, and chromatic aberration of magnification in infinite object point focusing of the zoom lens shown in FIGS. 7A and 7B in the wide-angle end position, respectively. And, FIGS. 8E, 8F, 8G, and 8H are views showing spherical aberration, astigmatism, distortion, and chromatic aberration of magnification in infinite object point focusing of the zoom lens shown in FIGS. 7A and 7B in the telephoto end position, respectively.

FIGS. 9A and 9B are a sectional view showing an optical formation in infinite object point focusing of an image pickup apparatus provided with a zoom lens according to the fourth embodiment of the present invention, taken along the optical axis. And, FIGS. 9A and 9B show the states in wide-angle end and telephoto end positions, respectively.

FIGS. 10A, 10B, 10C, and 10D are views showing spherical aberration, astigmatism, distortion, and chromatic aberration of magnification in infinite object point focusing of the zoom lens shown in FIGS. 9A and 9B in the wide-angle end position, respectively. And, FIGS. 10E, 10F, 10G, and 10H are views showing spherical aberration, astigmatism, distortion, and chromatic aberration of magnification in infinite object point focusing of the zoom lens shown in FIGS. 9A and 9B in the telephoto end position, respectively.

FIGS. 11A and 11B are a sectional view showing an optical formation in infinite object point focusing of an image pickup apparatus provided with a zoom lens according to the fifth embodiment of the present invention, taken along the optical axis. And, FIGS. 11A and 11B show the states in wide-angle end and telephoto end positions, respectively.

FIGS. 12A and 12B are a sectional view showing an optical formation in close-far object point focusing of the image pickup apparatus provided with the zoom lens according to the fifth embodiment of the present invention, taken along the optical axis. And, FIGS. 12A and 12B show the states in wide-angle end and telephoto end positions, respectively.

FIGS. 13A, 13B, 13C, and 13D are views showing spherical aberration, astigmatism, distortion, and chromatic aberration of magnification in infinite object point focusing of the zoom lens shown in FIGS. 11A, 11B, 12A, and 12B in the wide-angle end position, respectively. And, FIGS. 13E, 13F, 13G, and 13H are views showing spherical aberration, astigmatism, distortion, and chromatic aberration of magnification in infinite object point focusing of the zoom lens shown in FIGS. 11A, 11B, 12A, and 12B in the telephoto end position, respectively.

FIGS. 14A, 14B, 14C, and 14D are views showing spherical aberration, astigmatism, distortion, and chromatic aberration of magnification in close object point focusing of the zoom lens shown in FIGS. 11A, 11B, 12A, and 12B in the wide-angle end position, respectively. And, FIGS. 14E, 14F, 14G, and 14H are views showing spherical aberration, astigmatism, distortion, and chromatic aberration of magnification in close object point focusing of the zoom lens shown in FIGS. 11A, 11B, 12A, and 12B in the telephoto end position, respectively.

FIGS. 15A and 15B are a sectional view showing an optical formation in infinite object point focusing of an image pickup apparatus provided with a zoom lens according to the sixth embodiment of the present invention, taken along the optical axis. And, FIGS. 15A and 15B show the states in wide-angle end and telephoto end positions, respectively.

FIGS. 16A, 16B, 16C, and 16D are views showing spherical aberration, astigmatism, distortion, and chromatic aberration of magnification in infinite object point focusing of the zoom lens shown in FIGS. 15A and 15B in the wide-angle end position, respectively. And, FIGS. 16E, 16F, 16G, and 16H are views showing spherical aberration, astigmatism, distortion, and chromatic aberration of magnification in infinite object point focusing of the zoom lens shown in FIGS. 15A and 15B in the telephoto end position, respectively.

FIGS. 17A and 17B are a sectional view showing an optical formation in infinite object point focusing of an image pickup apparatus provided with a zoom lens according to the seventh embodiment of the present invention, taken along the optical axis. And, FIGS. 17A and 17B show the states in wide-angle end and telephoto end positions, respectively.

FIGS. 18A, 18B, 18C, and 18D are views showing spherical aberration, astigmatism, distortion, and chromatic aberration of magnification in infinite object point focusing of the zoom lens shown in FIGS. 17A and 17B in the wide-angle end position, respectively. And, FIGS. 18E, 18F, 18G, and 18H are views showing spherical aberration, astigmatism, distortion, and chromatic aberration of magnification in infinite object point focusing of the zoom lens shown in FIGS. 17A and 17B in the telephoto end position, respectively.

FIGS. 19A and 19B are a sectional view showing an optical formation in infinite object point focusing of an image pickup apparatus provided with a zoom lens according to the eighth embodiment of the present invention, taken along the optical axis. And, FIGS. 19A and 19B show the states in wide-angle end and telephoto end positions, respectively.

FIGS. 20A, 20B, 20C, and 20D are views showing spherical aberration, astigmatism, distortion, and chromatic aberration of magnification in infinite object point focusing of the zoom lens shown in FIGS. 19A and 19B in the wide-angle end position, respectively. And, FIGS. 20E, 20F, 20G, and 20H are views showing spherical aberration, astigmatism, distortion, and chromatic aberration of magnification in infinite object point focusing of the zoom lens shown in FIGS. 19A and 19B in the telephoto end position, respectively.

FIGS. 21A and 21B are a sectional view showing an optical formation in infinite object point focusing of an image pickup apparatus provided with a zoom lens according to the ninth embodiment of the present invention, taken along the optical axis. And, FIGS. 21A and 21B show the states in wide-angle end and telephoto end positions, respectively.

FIGS. 22A, 22B, 22C, and 22D are views showing spherical aberration, astigmatism, distortion, and chromatic aberration of magnification in infinite object point focusing of the zoom lens shown in FIGS. 21A and 21B in the wide-angle end position, respectively. And, FIGS. 22E, 22F, 22G, and 22H are views showing spherical aberration, astigmatism, distortion, and chromatic aberration of magnification in infinite object point focusing of the zoom lens shown in FIGS. 21A and 21B in the telephoto end position, respectively.

FIGS. 23A and 23B are a sectional view showing an optical formation in infinite object point focusing of an image pickup apparatus provided with a zoom lens according to the tenth embodiment of the present invention, taken along the optical axis. And, FIGS. 23A and 23B show the states in wide-angle end and telephoto end positions, respectively.

FIGS. 24A, 24B, 24C, and 24D are views showing spherical aberration, astigmatism, distortion, and chromatic aberration of magnification in infinite object point focusing of the zoom lens shown in FIGS. 23A and 23B in the wide-angle end position, respectively. And, FIGS. 24E, 24F, 24G, and 24H are views showing spherical aberration, astigmatism, distortion, and chromatic aberration of magnification in infinite object point focusing of the zoom lens shown in FIGS. 23A and 23B in the telephoto end position, respectively.

FIGS. 25A and 25B are a sectional view showing an optical formation in infinite object point focusing of an image pickup apparatus provided with a zoom lens according to the eleventh embodiment of the present invention, taken along the optical axis. And, FIGS. 25A and 25B show the states in wide-angle end and telephoto end positions, respectively.

FIGS. 26A and 26B are a sectional view showing an optical formation in close-far object point focusing of the image pickup apparatus provided with the zoom lens according to the eleventh embodiment of the present invention, taken along the optical axis. And, FIGS. 26A and 26B show the states in wide-angle end and telephoto end positions, respectively.

FIGS. 27A, 27B, 27C, and 27D are views showing spherical aberration, astigmatism, distortion, and chromatic aberration of magnification in infinite object point focusing of the zoom lens shown in FIGS. 25A, 25B, 26A, and 26B in the wide-angle end position, respectively. And, FIGS. 27E, 27F, 27G, and 27H are views showing spherical aberration, astigmatism, distortion, and chromatic aberration of magnification in infinite object point focusing of the zoom lens shown in FIGS. 25A, 25B, 26A, and 26B in the telephoto end position, respectively.

FIGS. 28A, 28B, 28C, and 28D are views showing spherical aberration, astigmatism, distortion, and chromatic aberration of magnification in close object point focusing of the zoom lens shown in FIGS. 25A, 25B, 26A, and 26B in the wide-angle end position, respectively. And, FIGS. 28E, 28F, 28G, and 28H are views showing spherical aberration, astigmatism, distortion, and chromatic aberration of magnification in close object point focusing of the zoom lens shown in FIGS. 25A, 25B, 26A, and 26B in the telephoto end position, respectively.

FIG. 29 is a front perspective view showing the appearance of a digital camera into which a zoom lens of the present invention is incorporated.

FIG. 30 is a rear elevation of the digital camera shown in FIG. 29.

FIG. 31 is an illustration showing the formation of the digital camera shown in FIG. 29.

### DETAILED DESCRIPTION OF THE PREFERRED EMBODIMENTS

Before undertaking the description of the embodiments of the present invention, the operation and effects by the constitutions of a zoom lens of the present invention will be explained.

A zoom lens of the present first invention is formed in such a way that: the zoom lens comprises, in order from the object side, a positive first group with a diffraction-type optical element, a positive second group, and a negative third group; a space between the first and second groups and a space between the second and third groups increase respectively in changing a magnification from the wide-angle end position to the telephoto end position; and the third group is fixed.

As described above, the first group comprises a diffraction-type optical element in the zoom lens of the present first invention, so that it is possible to check occurrence of chromatic aberration in the first group. As a result, it is easy to make a change of chromatic aberration caused by a variable magnification small, and it is possible to obtain a high capability for an image formation.

Also, the first and second groups share positive power in the zoom lens of the present first invention, so that it is possible to fix the negative third group the capability of which is widely changed by a manufacturing error, and it is possible to obtain a good capability for aberration.

Also, the zoom lens of the present first invention is formed in such a way that a space between the first and second groups and a space between the second and third groups increase together in changing a magnification from the wide-angle end position to the telephoto end position with the third group being fixed. That is to say, the zoom lens of the present first invention is formed in such a way that the two groups with positive power are moved toward the object side in changing a magnification from the wide-angle end position to the telephoto end position, so that it is possible to secure a high variable magnification ratio.

Further, it is preferred that: the zoom lens of the present first invention comprises, in order from the object side, a positive first group with a diffraction-type optical element, a positive second group, a negative third group, a positive fourth group, and a positive fifth group; and each of spaces between the groups changes in changing a magnification, and, especially, a space between the first and second groups and a space between the second and third groups increase respectively in changing a magnification from the wide-angle end position to the telephoto end position, and the third group is fixed.

Such formation of the zoom lens comprising the five groups makes it possible to make an optimum arrangement of powers, and the formation of the zoom lens easily makes a good capability for aberration.

Also, a zoom lens of the present second invention is formed in such a way that: the zoom lens comprises, in order from the object side, a positive first group with a diffraction-type optical element, a positive second group, a negative third group, a positive fourth group, and a positive fifth group; and, in changing a magnification, at least the first group is capable of moving, and each of spaces between the groups changes.

As described above, the first group comprises a diffraction-type optical element in the zoom lens of the present second invention, so that it is possible to check occurrence of chromatic aberration in the first group. Also, the formation of the zoom lens comprising the five groups makes it possible to make an optimum arrangement of powers, and the formation of the zoom lens easily makes a good capability for aberration.

Also, the zoom lens of the present second invention is formed in such a way that, in changing a magnification, at least the first group is capable of moving and each of spaces between the groups changes respectively, so that it is possible to set the first group on the object side more in the telephoto end position than in the wide-angle end position. That is to say, it is possible to secure a sufficient quantity of movement of the first group, so that the zoom lens of the present second invention can be formed in such a way that: the total length of the zoom lens is small in the wide-angle end position; the zoom lens has a large diameter and a large variable magnification ratio; and a change of chromatic aberration caused by a variable magnification is small.

Besides, it is possible to check occurrence quantity of chromatic aberration in the first group in a zoom lens of the present invention, as described above. That is to say, it is possible to lighten a load of aberration correction on the lens groups except the first group which are arranged nearer to the image side than the first group, so that a large quantity of a material with a relatively low refractive index can be used for lenses which constitute the lens groups except the first group. In general, it is difficult to make a shape of a lens in making coincide entirely with a shape of a lens in a draft. For this reason, a material with a relatively low refractive index in which a relatively large tolerance can be set is used in making a lens, so that it is easy to embody a capability in a draft. Accordingly, the zoom lens of the present invention also has an effect of easily embodying a capability in a draft.

A zoom lens of the present invention may be formed as follows.

It is preferable to make a focusing by moving only the second group in a zoom lens of the present invention. Methods of a focusing for a zoom lens with the formation like the present invention include, for example, a method in which the first and second groups with a small change of aberration are moved integratedly, and a method in which only the fifth group is moved when the zoom lens comprises five groups and the first to fourth lens groups constitute a almost afocal optical system.

However, the method of a focusing by moving the first and second groups integratedly has the problem of a large load on a driving mechanism due to large lens diameters and large weight of lenses constituting the first group in the zoom lens having a large aperture.

Also, in the method of a focusing by moving the fifth group, a load on the driving mechanism is small because lens diameters and weight of lenses constituting the fifth group are small in the case of the formation of the zoom lens comprising five groups even though an aperture of the zoom lens is large. However, the method of moving only the fifth group has the problem of large changes of spherical aberration and astigmatism.

On the other hand, in the method of a focusing by moving only the second group, the method has only to move only the second group composed of lenses, the lens diameters and weight of which are smaller than those of the first group, so that it is possible to check a load on the driving mechanism with the load being small.

Also, changes including a change of the image plane in the case of moving only the second group can be checked with the changes being relatively small, as compared with the case of moving the first and second groups integratedly.

Besides, a change of spherical aberration in the case of moving only the second group becomes larger than that in the case of moving the first and second groups integratedly. However, in a zoom lens of the present invention, the first group comprises a diffraction-type optical element, so that a change of chromatic aberration is small and it is possible to substantially reduce a deterioration of an image quality due to the change of spherical aberration. As a result, it also is possible to form the zoom lens of the present invention in which the closest photographing distance is about one meter.

Also, it is preferred that a zoom lens of the present invention satisfies the following condition (1):

2≦f₂/f_{w}≦3.5

where f₂ is a focal length of the second group, and f_{w} is a focal length of the zoom lens in the wide-angle end position.

In a zoom lens of the present invention, aberrations occurring in the first and second groups are intensified by the lens groups except the first and second groups. However, when a zoom lens of the present invention is formed in such a way that the first group comprises a diffraction-type optical element and the zoom lens satisfies the condition (1) which prescribes a focal length of the second group, it is possible to check aberrations, in particular, axial chromatic aberration, which occur in the first and second groups, in a small degree of the occurrence of aberrations to the utmost.

Besides, if f₂/f_{w} is below the lower limit value of the condition (1), the power of the second group becomes too large, so that the occurrence quantity of an aberration becomes large and it is hard to correct an aberration by the lens groups except the first and second groups. On the other hand, if f₂/f_{w} is beyond the upper limit value of the condition (1), the power of the second group becomes too small, so that the total length of the lens becomes long.

Also, in the case of making a focusing by moving the second group, it is more preferable that a zoom lens of the present invention is formed so as to satisfy the following condition (1′) instead of the condition (1):

2.2≦f₂/f_{w}≦3 (1′)

Besides, if f₂/f_{w} is below the lower limit value of the condition (1′), a change of an aberration due to a focusing becomes too large. On the other hand, if f₂/f_{w} is beyond the upper limit value of the condition (1′), a space for movement which is necessary for a focusing becomes too large.

Further, it is more preferable that a zoom lens of the present invention is formed so as to satisfy the following condition (1″) instead of the conditions (1) and (1′):

2.5≦f₂/f_{w}≦2.8 (1″)

Besides, the upper limit value of the condition (1′) may be replaced with the upper limit value of the condition (1) or (1″), or the lower limit value of the condition (1′) may be replaced with the lower limit value of the condition (1) or (1″). Or, the upper limit value of the condition (1″) may be replaced with the upper limit value of the condition (1) or (1′), or the lower limit value of the condition (1″) may be replaced with the lower limit value of the condition (1) or (1′).

Also, it is preferred that a zoom lens of the present invention satisfies the following condition (2):

3≦f₂/f_{w}≦5 (2)

where f₁ is a focal length of the first group, and f_{w} is a focal length of the zoom lens in the wide-angle end position.

Although chromatic aberration is small and it is possible to make a good correction of a chromatic aberration in a zoom lens of the present invention because the first group comprises a diffraction-type optical element in the zoom lens, the formation of the zoom lens satisfying the condition (2) for prescribing a focal length of the first group makes it easy to also make a good correction of another aberrations in the whole of the variable magnification range.

Besides, if f₁/f_{w} is below the lower limit value of the condition (2), the power of the first group becomes too large, so that the occurrence quantity of an aberration becomes large and it is hard to correct an aberration by the lens groups except the first group. Especially, it is hard to correct a change of an aberration due to a change of a magnification by the lens groups except the first group. On the other hand, if f₁/f_{w} is beyond the upper limit value of the condition (2), the power of the first group becomes too small, so that the total length of the lens becomes long.

Also, in the case of making a focusing by moving the second group, it is more preferable that a zoom lens of the present invention is formed so as to satisfy the following condition (2′) instead of the condition (2):

3.3≦f₁/f_{w}≦4.8 (2)

Besides, if f₁/f_{w} is below the lower limit value of the condition (2′), a change of an aberration due to a focusing becomes too large. On the other hand, the larger a value of f₁/f_{w} becomes, the better a change of an aberration due to a focusing is improved. However, it is more preferable to set the upper limit value of the condition (2′) at 4.8 in the relationships to corrections of the other aberrations.

Besides, the upper limit value of the condition (2′) may be replaced with the upper limit value of the condition (2), or the lower limit value of the condition (2′) may be replaced with the lower limit value of the condition (2).

Also, it is preferred that a zoom lens of the present invention satisfies the following condition (3):

−0.16≦f₃/fₜ≦−0.08 (3)

where f₃ is a focal length of the third group, and fₜ is a focal length of the whole of the zoom lens in the telephoto end position.

The formation of the zoom lens satisfying the condition (3) for prescribing a focal length of the third group makes the zoom lens satisfy conditions about a variable magnification ratio, the total length of the lens, and a back focus and makes it easy to make good corrections of aberrations. Especially, the formation makes it easy to correct a field curvature and a distortion. Further, the formation makes it easy to correct also a spherical aberration and a coma in the telephoto end position.

Besides, if f₃/fₜ is below the lower limit value of the condition (3), a spherical aberration is easy to correct excessively. On the other hand, if f₃/fₜ is beyond the upper limit value of the condition (3), a correction of a spherical surface easily becomes insufficient.

Also, it is more preferable that a zoom lens of the present invention is formed so as to satisfy the following condition (3′) instead of the condition (3):

−0.12≦f₃/fₜ≦−0.10 (3′)

Also, the upper limit value of the condition (3′) may be replaced with the upper limit value of the condition (3), or the lower limit value of the condition (3′) may be replaced with the lower limit value of the condition (3).

Also, it is preferred that a zoom lens of the present invention satisfies the following condition (4):

0.1≦f₄/fₜ≦0.4 (4)

where f₄ is a focal length of the fourth group, and fₜ is a focal length of the whole of the zoom lens in the telephoto end position.

The formation of the zoom lens satisfying the condition (4) for prescribing a focal length of the fourth group makes the zoom lens satisfy conditions about a variable magnification ratio, the total length of the lens, and a back focus and makes it easy to make good corrections of aberrations. Especially, the formation makes it easy to correct a spherical aberration in the wide-angle end position.

Besides, if f₄/fₜ is below the lower limit value of the condition (4), the power of the fourth group becomes too large and it easily becomes hard to correct a spherical aberration. On the other hand, if f₄/fₜ is beyond the upper limit value of the condition (4), the power of the fourth group becomes too small and the total length of the lens easily becomes large.

Also, it is more preferable that a zoom lens of the present invention is formed so as to satisfy the following condition (4′) instead of the condition (4):

0.1≦f₄/fₜ≦0.38 (4′)

Further, it is more preferable that a zoom lens of the present invention is formed so as to satisfy the following condition (4″) instead of the condition (4) or (4′):

0.1≦f₄/fₜ≦0.35 (4″)

Also, it is preferred that a zoom lens of the present invention satisfies the following condition (5):

1.5≦f₅/f_{w}≦2.5 (5)

where f₅ is a focal length of the fifth group, and f_{w} is a focal length of the whole of the zoom lens in the wide-angle end position.

The formation of the zoom lens satisfying the condition (5) for prescribing a focal length of the fifth group makes it easy to make a good correction of a coma in the whole of the variable magnification range.

Besides, if f₅/f_{w} is below the lower limit value of the condition (5), the power of the fifth group becomes too large and it easily becomes hard to correct a coma. On the other hand, if f₅/f_{w} is beyond the upper limit value of the condition (5), the power of the fifth group becomes too small, so that an effect of a variable magnification becomes small and the total length of the lens easily becomes large.

Also, it is more preferable that a zoom lens of the present invention is formed so as to satisfy the following condition (5′) instead of the condition (5):

1.7≦f₅/f_{w}≦2.5 (5′)

Further, it is more preferable that a zoom lens of the present invention is formed so as to satisfy the following condition (5″) instead of the condition (5) or (5′):

1.9≦f₅/f_{w}≦2.5 (5″)

Also, it is more preferable that the fourth or five group comprises a diffraction-type optical element in a zoom lens of the present invention.

Such formation makes it easy to correct axial chromatic aberration and chromatic aberration of magnification with the corrections of these aberrations being well-balanced with each other.

Also, it is preferred that a zoom lens of the present invention satisfies the following condition (6) in the whole of the variable magnification range:

2.0≦F≦4.0 (6)

where F is the F-number.

The formation of the zoom lens satisfying the condition (6) for prescribing the F-number makes it easy to use the zoom lens as a telephoto zoom lens with a large diameter.

Besides, if F is below the lower limit value of the condition (6), the lens diameter becomes too large, so that the product value of the zoom lens is damaged. On the other hand, if F is beyond the upper limit value of the condition (6), the lens diameter of the zoom lens is too small to use the zoom lens as a telephoto zoom lens with a large diameter.

Also, it is preferred that a zoom lens of the present invention satisfies the following condition (7):

−0.35≦MG≦−0.15 (7)

where MG is the maximum photographic magnification.

The formation of the zoom lens satisfying the condition (7) for prescribing the maximum photographic magnification makes it possible to make the zoom lens of the present invention have a function as a macro lens in the telephoto end position.

Besides, in the case of making the zoom lens have a function of a macro lens, it is at least necessary that the maximum photographic magnification does not exceed the upper limit value of the condition (7). Also, the number of lenses or the F-number must be increased in order to achieve a magnification which is below the lower limit value of the condition (7), so that such magnification is not preferable.

Besides, when a zoom lens of the present invention having such formation is used for an image pickup system in which an image circle is about half as compared with 135F, it is possible to photograph at a substantially two-times magnification. In a telephoto lens, if it is possible to photograph at such magnification, it becomes possible to make macro photography despite a sufficiently long distance from an object.

Also, it is more preferable that a zoom lens of the present invention is formed so as to satisfy the following condition (7′) instead of the condition (7):

−0.35≦MG≦−0.21 (7′)

Further, it is more preferable that a zoom lens of the present invention is formed so as to satisfy the following condition (7″) instead of the condition (7) or (7′):

−0.35≦MG≦−0.24 (7″)

Also, in the case of making a focusing by moving the second group in a zoom lens of the present invention, it is preferred that the second group is moved toward the object side in making a focusing and the quantity of movement of the second group satisfies the following condition (8):

0.08≦Δd/fₜ≦0.12 (8)

where Δd is the quantity of movement in a focusing from infinity to the closest object point, fₜ is a focal length of the whole of the zoom lens in the telephoto end position.

The power of the second group is prescribed by the above-described condition (1), and, in the case of f₂/f_{w} in the range satisfying the condition (1), it becomes necessary that the quantity of movement exceeds the lower limit value of the condition (8). If Δd/fₜ is below the lower limit value of the condition (8), it is impossible to make photography in the range in which MG does not exceed the upper limit value of the condition (7), and the zoom lens having such formation becomes insufficient as a macro lens. On the other hand, if Δd/fₜ is beyond the upper limit value of the condition (8), the quantity of movement also becomes large while a macro photographic magnification becomes large, so that such formation is not preferable in view of a mechanical formation. In addition, a space between the first and second groups must be expanded in order to secure the quantity of movement, so that the total length of the lens becomes large.

Also, it is preferred that a zoom lens of the present invention satisfies the following conditions (9) and (10):

10≦IH≦13 (9)

2.8≦fb/IH≦3.8 (10)

where IH is the radius of an image circle, and fb is a distance from the most image-side surface of the zoom lens to an image pickup plane in the wide-angle end position.

The conditions (9) and (10) are used for securing a space necessary to arrange a quick return mirror or the like. The condition (9) shows the range of the radius of a supposed image circle. The condition (10) prescribes a dimension necessary to secure a space in which a mirror is arranged in a layout when the condition (9) is satisfied.

Besides, if IH is beyond the upper limit value of the condition (9) or fb/IH is beyond the upper limit value of the condition (10), the whole of the zoom lens easily becomes large. On the other hand, if IH is below the lower limit value of the condition (9) or fb/IH is below the lower limit value of the condition (10), a space for arranging a mirror easily becomes lacking.

Also, it is preferred that a zoom lens of the present invention satisfies the following condition (11):

0≦|EW|≦15 (11)

where, in the case of the image pickup area of the image pickup element in the shape of a rectangle, EW is an angle (°) at which the optical axis crosses the most off-axis principal ray which is incident on the diagonal line of the rectangle (, or a diagonal principal ray).

The formation of the zoom lens satisfying the condition (11) makes it possible to favorably apply the zoom lens of the present invention to a digital still camera or a digital video camera, (which are collectively called a digital camera hereinafter and) which is an image pickup apparatus using an image pickup element such as a charge coupled device (which is called CCD hereinafter).

In general, when a zoom lens is used for a digital camera, the image quality is largely affected by an angle at which a light ray emerging from the most image-side surface of the zoom lens is incident on a CCD or the like. For example, a too large angle of incidence of the light ray causes fear of a lack of quantity of light. Especially, a high image height makes vignetting large. The condition (11) prescribes an angle at which the optical axis crosses an emerging light ray of a diagonal principal ray and by which it is possible to minimize a reduction of quantity of light by the vignetting. That is to say, the condition (11) prescribes the absolute value of an angle of emergence of the diagonal principal ray.

Naturally, when a zoom lens of the present invention is used for a digital camera, it is preferred that not only is the zoom lens formed so as to satisfy the condition (11), but also the oblique incidence characteristic of a used image pickup element such as a CCD is fitted into the zoom lens.

Embodiments of a zoom lens of the present invention will be explained below referring to the drawings. In the drawings, subscript numerals in r₁, r₂, . . . and d₁, d₂, . . . in sectional views of the optical system correspond to surface numbers, 1, 2, . . . in numerical data, respectively. Further, in views showing aberration curves, ΔM in views for astigmatism denotes astigmatism in a meridional plane, and ΔS in views for astigmatism denotes astigmatism in a sagittal plane. In this case, the meridional plane is a plane (plane parallel to this document plane) including the optical axis and the chief ray of an optical system. The sagittal plane is a plane (plane perpendicular to this document plane) perpendicular to a plane including the optical axis and the chief ray of an optical system. In addition, FIY denotes an image height.

Further, in the numerical data of the lens in each of the following embodiments, s denotes a surface number of the lens, r denotes the radius of curvature of each surface, d denotes surface interval, nd denotes the refractive index at d line (which has a wave length of 587.5600 nm), vd denotes the Abbe's number to the d line, a surface number having “*” denotes the surface number of an aspeherical surface, K denotes a conical coefficient, and A₄, A₆, and A₈ denote aspherical surface coefficients, respectively.

In the data for the aspherical surface coefficients in the following numerical data, E denotes a power of ten. For example, “E-01” denotes “ten to the power of minus one”. In addition, the shape of each aspherical surface is expressed by the following equation with aspherical surface coefficients in each embodiment:

Z=(Y²/r)/[1+{1−(1+K)(Y/r)²}^{1/2}]+A₄Y⁴+A₆Y⁶+A₈Y⁸+ . . .

where, Z is taken as a coordinate in the direction along the optical axis, and Y is taken as a coordinate in the direction perpendicular to the optical axis.

Besides, a diffraction-type optical element as described in Japanese Patent No. 3717555 is used for a zoom lens of the present invention in the following embodiments. The diffraction-type optical element is at least one optical element on which optical materials different from one another are laminated and a relief pattern is formed on the boundary surfaces between the optical materials, and the diffraction-type optical element has high diffraction efficiency in a wide range of wave lengths. However, a diffraction-type optical element used for a zoom lens of the present invention is not limited to such diffraction-type optical element and, for example, such a diffraction-type optical element as described in Japanese Patent Kokai No. 2003-215457 or Japanese Patent Kokai No. Hei 11-133305 may be used.

### Embodiment 1

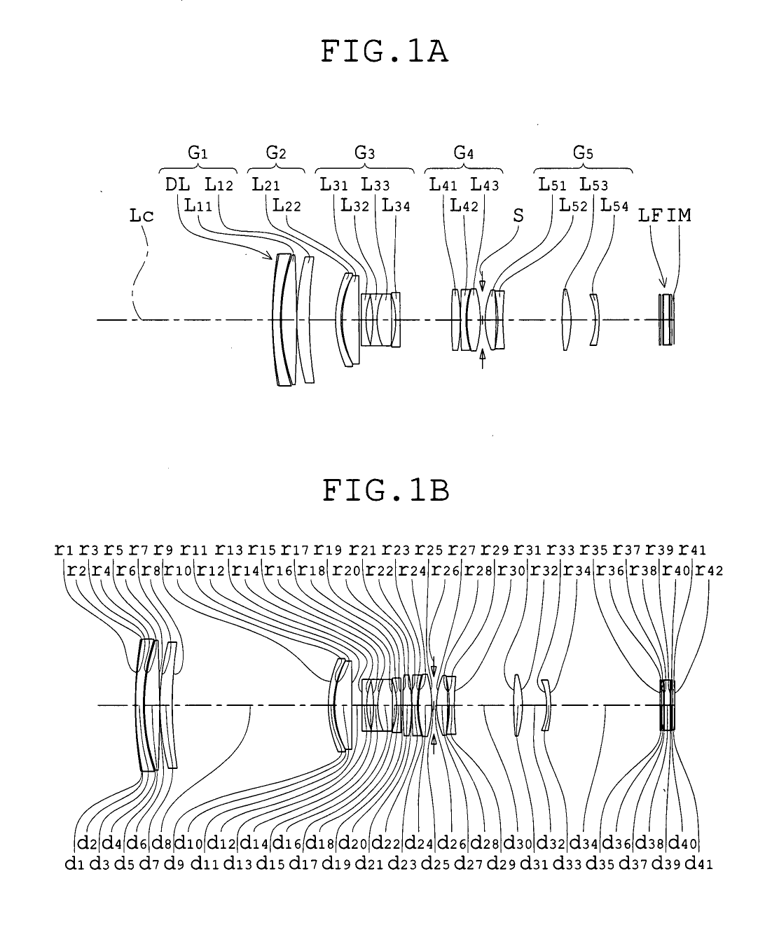

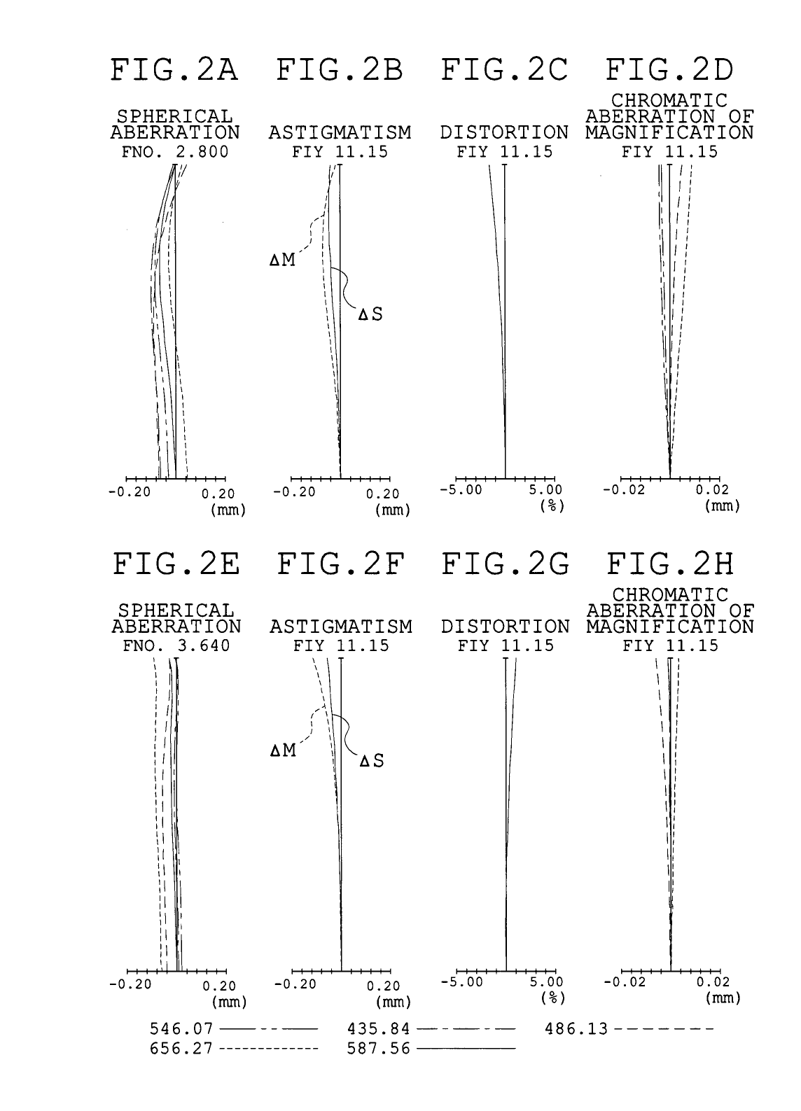

FIGS. 1A and 1B are a sectional view showing an optical formation in infinite object point focusing of an image pickup apparatus provided with a zoom lens according to the present embodiment, taken along the optical axis, and show the states in wide-angle end and telephoto end positions, respectively. FIGS. 2A, 2B, 2C, and 2D show spherical aberration, astigmatism, distortion, and chromatic aberration of magnification in infinite object point focusing of the zoom lens shown in FIGS. 1A and 1B in the wide-angle end position, respectively. And, FIGS. 2E, 2F, 2G, and 2H show spherical aberration, astigmatism, distortion, and chromatic aberration of magnification in infinite object point focusing of the zoom lens shown in FIGS. 1A and 1B in the telephoto end position, respectively.

First, the optical formation of a zoom lens of the present embodiment is explained using FIGS. 1A and 1B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises, in order from the object side, a lens L₂₁ which is a negative meniscus lens turning its convex surface toward the object side and a lens L₂₂ which is a plano-convex lens turning its convex surface toward the object side.

The third group G₃ has negative power as a whole. The third group G₃ comprises, in order from the object side, a lens L₃₁ which is a piano-concave lens turning its concave surface toward the image side, a cemented lens which comprises a biconcave lens L₃₂ and a biconvex lens L₃₃ and has positive power, and a lens L₃₄ which is a piano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ which is a biconcave lens, a lens L₅₃ which is a biconvex lens, and a lens L₅₄ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 1
Unit: millimeter (mm)
Surface data:

| | | | | | effective |
|---|---|---|---|---|---|
| s | r | d | nd | νd | diameter |
| Object surface | ∞ | ∞ | | | |
| 1 | 192.1324 | 0.2103 | 1.63762 | 34.21 | 30.225 |
| 2* | 159.3964 | 0 | 1.0E+03 | −3.45 | 30.158 |
| 3 | 159.3983 | 3.7183 | 1.60999 | 27.48 | 30.158 |
| 4 | 96.8338 | 0.5000 | | | 29.632 |
| 5 | 92.8113 | 7.4017 | 1.51633 | 64.14 | 29.661 |
| 6 | −643.8949 | 0.1000 | | | 29.500 |
| 7 | 112.4367 | 6.0086 | 1.52542 | 55.78 | 29.142 |
| 8 | 193.2763 | variable | | | 28.533 |
| 9 | 54.0332 | 2.5874 | 1.84666 | 23.78 | 20.885 |
| 10 | 42.2052 | 0.5700 | | | 19.747 |
| 11 | 46.0565 | 8.2365 | 1.51633 | 64.14 | 19.742 |
| 12 | ∞ | variable | | | 19.038 |
| 13 | ∞ | 2.2200 | 1.88300 | 40.76 | 12.070 |
| 14 | 33.0714 | 3.4000 | | | 11.416 |
| 15 | −57.8499 | 2.0000 | 1.48749 | 70.23 | 11.430 |
| 16 | 30.8504 | 7.1384 | 1.84666 | 23.78 | 12.025 |
| 17 | −217.0220 | 2.0000 | | | 12.032 |
| 18 | −34.7605 | 2.0000 | 1.77250 | 49.60 | 12.024 |
| 19 | ∞ | variable | | | 12.580 |
| 20 | 195.7247 | 4.2708 | 1.69680 | 55.53 | 14.000 |
| 21 | −82.9795 | 0.1200 | | | 14.153 |
| 22 | 281.5278 | 2.6247 | 1.80610 | 40.92 | 14.122 |
| 23 | 52.7364 | 0.5000 | | | 13.986 |
| 24 | 53.3366 | 6.5067 | 1.49700 | 81.54 | 14.070 |
| 25 | −53.1213 | variable | | | 14.118 |
| 26 (stop) | ∞ | 1.2900 | | | 13.799 |
| 27 | 35.7216 | 5.3757 | 1.49700 | 81.54 | 13.822 |
| 28 | −145.5896 | 0.8700 | | | 13.562 |
| 29 | −64.5052 | 2.3769 | 1.64769 | 33.79 | 13.545 |
| 30 | 126.4951 | 28.7620 | | | 13.300 |
| 31 | 131.4806 | 4.3281 | 1.65160 | 58.55 | 13.500 |
| 32 | −48.9864 | 11.8166 | | | 13.500 |
| 33 | −28.8135 | 1.8800 | 1.83481 | 42.72 | 11.313 |
| 34 | −56.1986 | variable | | | 11.594 |
| 35 | ∞ | 0.7000 | 1.51633 | 64.14 | 11.484 |
| 36 | ∞ | 0.9500 | | | 11.482 |
| 37 | ∞ | 0.4500 | 1.54200 | 77.40 | 11.479 |
| 38 | ∞ | 2.8000 | 1.54771 | 62.84 | 11.478 |
| 39 | ∞ | 0.4000 | | | 11.473 |
| 40 | ∞ | 0.7620 | 1.52310 | 54.49 | 11.472 |
| 41 | ∞ | variable | | | 11.471 |
| 42 (Image plane) | ∞ | | | | |

Aspherical surface data:
The second surface
K = 0, A4 = 1.5458E−12, A6 = 3.3808E−17
Various data:
Zoom ratio: 3.8786

| | Wide-angle | |
|---|---|---|
| | end position | Telephoto end position |
| f | 52.08032 | 201.99995 |
| Fno. | 2.80000 | 3.64022 |
| 2ω (°) | 24.54 | 6.25 |
| Image height | 11.15000 | 11.15000 |
| The total length of the lens | 193.34225 | 260.34909 |
| Back focus | 34.69286 | 58.67871 |
| Entrance pupil position | 84.41168 | 327.48709 |
| Exit pupil position | −82.58905 | −106.58240 |
| d8 | 12.75975 | 75.86189 |
| d12 | 1.08000 | 4.99591 |
| d19 | 24.99705 | 1.00000 |
| d25 | 1.00000 | 1.00000 |
| d34 | 29.17576 | 53.16911 |
| d41 | 1.10421 | 1.09671 |

Single lens data:

| Lens | Lens surface | f |
|---|---|---|
| 1 | 1-4 | −329.9513 |
| 2 | 5-6 | 157.6458 |
| 3 | 7-8 | 498.8582 |
| 4 | 9-10 | −253.1060 |
| 5 | 11-12 | 89.1998 |
| 6 | 13-14 | −37.4536 |
| 7 | 15-16 | −40.9708 |
| 8 | 16-17 | 32.3295 |
| 9 | 18-19 | −44.9975 |
| 10 | 20-21 | 84.1605 |
| 11 | 22-23 | −80.9159 |
| 12 | 24-25 | 54.6593 |
| 13 | 27-28 | 58.2878 |
| 14 | 29-30 | −65.6370 |
| 15 | 31-32 | 55.2954 |
| 16 | 33-34 | −73.1146 |
| 17 | 35-36 | ∞ |
| 18 | 37-38 | ∞ |
| 19 | 38-39 | ∞ |
| 20 | 40-41 | ∞ |

Zoom lens group data:

| Group | Lens surface | f | Lens constitution length |
|---|---|---|---|
| 1 | 1-8 | 189.17440 | 17.93894 |
| 2 | 9-12 | 142.06578 | 11.39382 |
| 3 | 13-19 | −21.78835 | 18.75836 |
| 4 | 20-25 | 56.70885 | 14.02220 |
| 5 | 26-34 | 105.05323 | 56.69926 |
| 6 | 35-41 | ∞ | 6.06200 |

| | Position of | Position of |
|---|---|---|
| Group | front-side principal point | rear-side principal point |
| 1 | 2.37192 | −9.43211 |
| 2 | −0.82821 | −8.23086 |
| 3 | 4.91079 | −6.84140 |
| 4 | 5.23543 | −4.00253 |
| 5 | 6.54267 | −41.62320 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.45846 | 0.57569 |
| 3 | −0.53240 | −1.07048 |
| 4 | −4.12319 | −38.31046 |
| 5 | 0.27355 | 0.04523 |
| 6 | 1.00000 | 1.00000 |

| | |
|---|---|
| f₂/f_{w} | 2.72782 |
| f₁/f_{w} | 3.63236 |
| f₃/fₜ | −0.10786 |
| f₄/fₜ | 0.28074 |
| f₅/f_{w} | 2.01714 |
| F | 2.8~3.64022 |
| IH | 11.15 |
| fb/IH | 3.11147 |
| \|EW\| | 5.92034~7.58825 |

### Embodiment 2

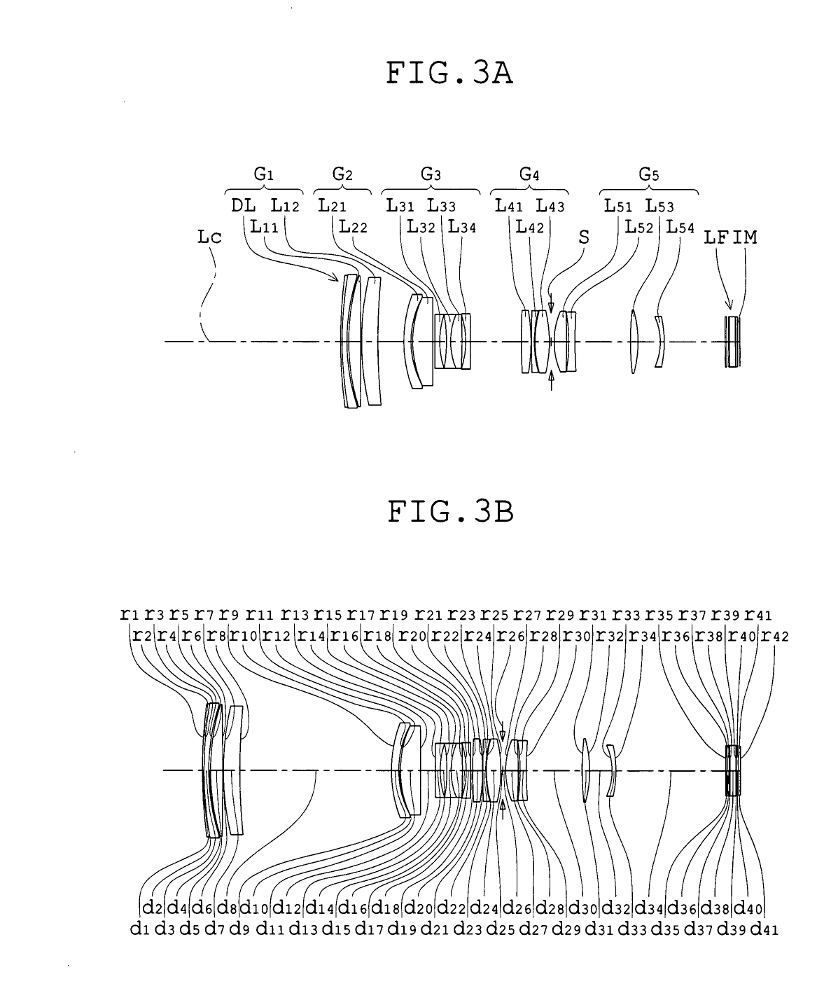

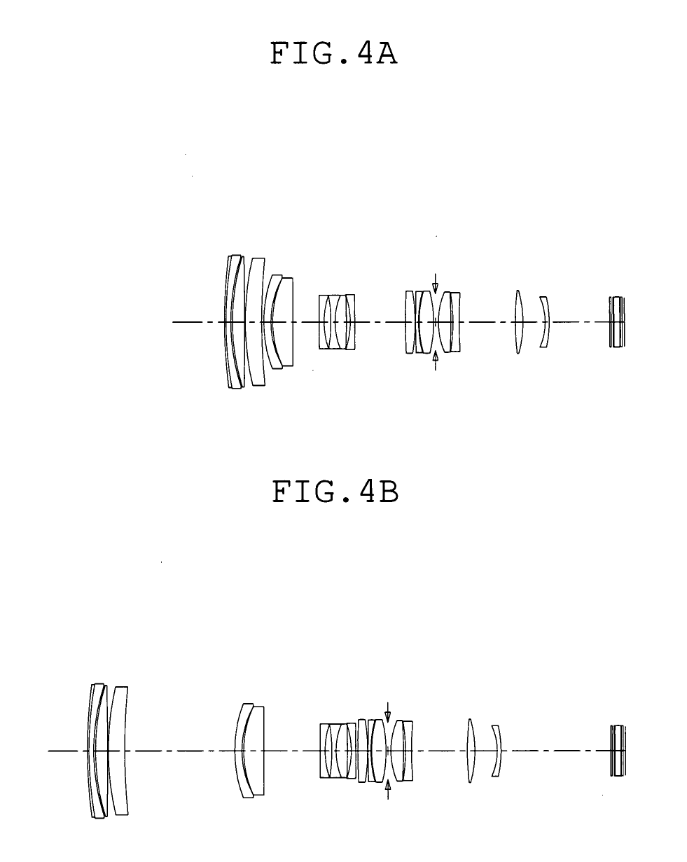

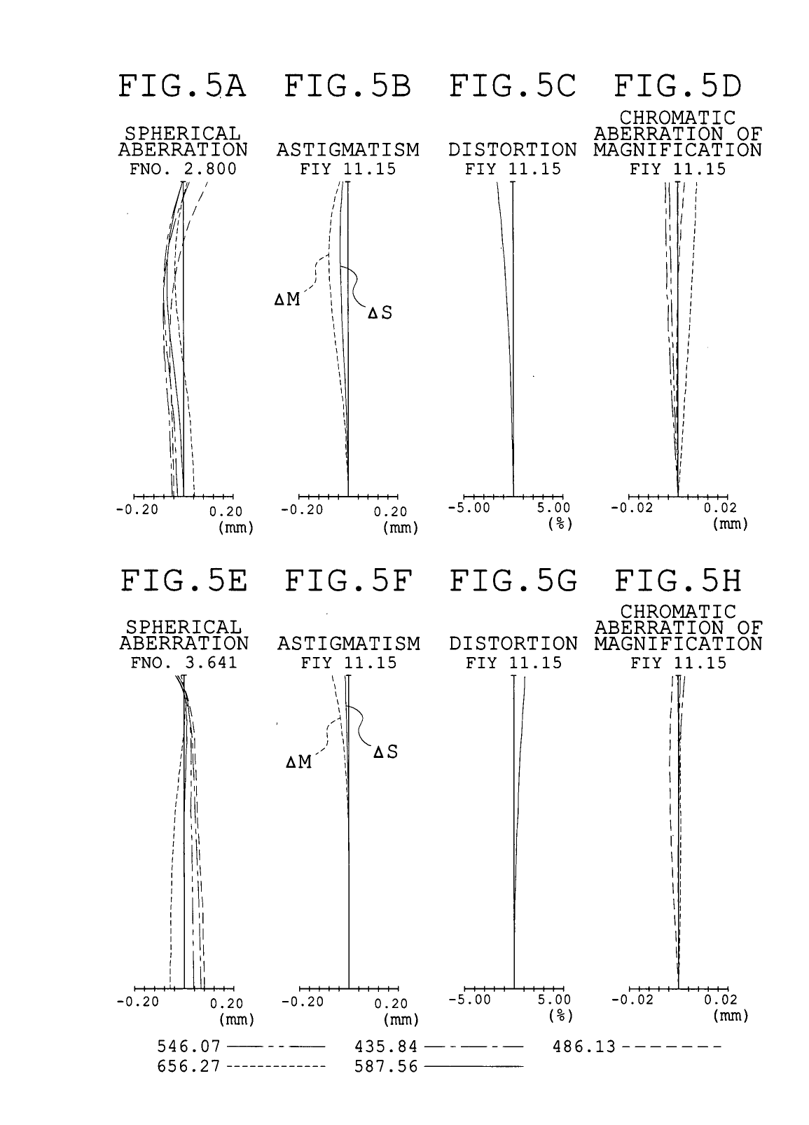

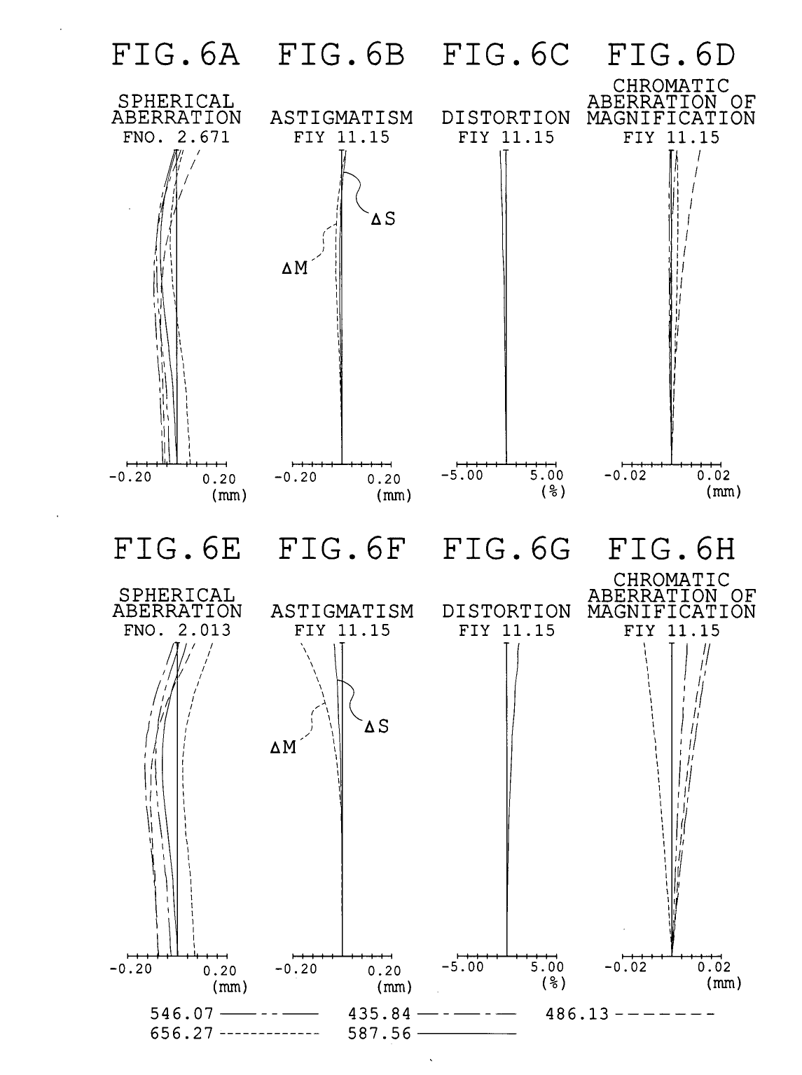

FIGS. 3A and 3B are a sectional view showing an optical formation in infinite object point focusing of an image pickup apparatus provided with a zoom lens according to the present embodiment, taken along the optical axis, and FIGS. 3A and 3B show the states in wide-angle end and telephoto end positions, respectively. FIGS. 4A and 4B are a sectional view showing an optical formation in close-far object point focusing of the image pickup apparatus provided with the zoom lens according to the present embodiment, taken along the optical axis, and FIGS. 4A and 4B show the states in wide-angle end and telephoto end positions, respectively. FIGS. 5A, 5B, 5C, and 5D are views showing spherical aberration, astigmatism, distortion, and chromatic aberration of magnification in infinite object point focusing of the zoom lens shown in FIGS. 3A, 3B, 4A, and 4B in the wide-angle end position, respectively, and FIGS. 5E, 5F, 5G, and 5H are views showing spherical aberration, astigmatism, distortion, and chromatic aberration of magnification in infinite object point focusing of the zoom lens shown in FIGS. 3A, 3B, 4A, and 4B in the telephoto end position, respectively. FIGS. 6A, 6B, 6C, and 6D are views showing spherical aberration, astigmatism, distortion, and chromatic aberration of magnification in close object point focusing of the zoom lens shown in FIGS. 3A, 3B, 4A, and 4B in the wide-angle end position, respectively, and FIGS. 6E, 6F, 6G, and 6H are views showing spherical aberration, astigmatism, distortion, and chromatic aberration of magnification in close object point focusing of the zoom lens shown in FIGS. 3A, 3B, 4A, and 4B in the telephoto end position, respectively.

First, the optical formation of a zoom lens of the present embodiment is explained using FIGS. 3A, 3B, 4A, and 4B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises, in order from the object side, a lens L₂₁ which is a negative meniscus lens turning its convex surface toward the object side and a lens L₂₂ which is a plano-convex lens turning its convex surface toward the object side.

The third group G₃ has negative power as a whole. The third group G₃ comprises in order from the object side: a lens L₃₁ which is a piano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ which is a biconcave lens, a lens L₅₃ which is a biconvex lens, and a lens L₅₄ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 2
Unit: millimeter (mm)
Surface data:

| | | | | | effective |
|---|---|---|---|---|---|
| s | r | d | nd | νd | diameter |
| Object surface | ∞ | ∞ | | | |
| 1 | 219.5314 | 0.4988 | 1.63762 | 34.21 | 30.011 |
| 2* | 159.3964 | 0 | 1.0E+03 | −3.45 | 29.900 |
| 3 | 159.3982 | 2.6167 | 1.60999 | 27.48 | 29.900 |
| 4 | 102.7731 | 0.5000 | | | 29.540 |
| 5 | 94.4329 | 6.2819 | 1.51633 | 64.14 | 29.579 |
| 6 | −751.3719 | 0.1000 | | | 29.500 |
| 7 | 120.6893 | 7.4934 | 1.52542 | 55.78 | 29.200 |
| 8 | 218.2981 | variable | | | 28.445 |
| 9 | 60.8967 | 3.5109 | 1.60999 | 27.48 | 22.145 |
| 10 | 41.4872 | 0.5700 | | | 20.490 |
| 11 | 44.5532 | 10.1928 | 1.51633 | 64.14 | 20.460 |
| 12 | ∞ | variable | | | 19.166 |
| 13 | ∞ | 2.2200 | 1.88300 | 40.76 | 12.070 |
| 14 | 32.3037 | 3.4000 | | | 11.224 |
| 15 | −60.7624 | 2.0000 | 1.48749 | 70.23 | 11.246 |
| 16 | 30.5511 | 5.6203 | 1.84666 | 23.78 | 12.000 |
| 17 | −238.2229 | 2.0000 | | | 12.000 |
| 18 | −34.7476 | 2.0000 | 1.77250 | 49.60 | 12.000 |
| 19 | ∞ | variable | | | 12.550 |
| 20 | 226.0906 | 4.8444 | 1.69680 | 55.53 | 14.000 |
| 21 | −82.6667 | 0.1200 | | | 14.129 |
| 22 | 274.9955 | 1.3033 | 1.80610 | 40.92 | 14.039 |
| 23 | 51.7028 | 0.5000 | | | 13.896 |
| 24 | 51.2891 | 7.1800 | 1.49700 | 81.54 | 13.994 |
| 25 | −52.8510 | variable | | | 14.065 |
| 26 (stop) | ∞ | 1.2900 | | | 13.754 |
| 27 | 34.3874 | 6.3115 | 1.49700 | 81.54 | 13.871 |
| 28 | −140.6211 | 0.8700 | | | 13.550 |
| 29 | −63.6370 | 2.7972 | 1.64769 | 33.79 | 13.535 |
| 30 | 123.9129 | 27.5762 | | | 13.300 |
| 31 | 129.6712 | 3.6342 | 1.65160 | 58.55 | 13.500 |
| 32 | −47.2273 | 10.9438 | | | 13.500 |
| 33 | −27.8692 | 1.8800 | 1.83481 | 42.72 | 11.550 |
| 34 | −55.1382 | variable | | | 11.636 |
| 35 | ∞ | 0.7000 | 1.51633 | 64.14 | 11.508 |
| 36 | ∞ | 0.9500 | | | 11.507 |
| 37 | ∞ | 0.4500 | 1.54200 | 77.40 | 11.505 |
| 38 | ∞ | 2.8000 | 1.54771 | 62.84 | 11.504 |
| 39 | ∞ | 0.4000 | | | 11.500 |
| 40 | ∞ | 0.7620 | 1.52310 | 54.49 | 11.499 |
| 41 | ∞ | variable | | | 11.498 |
| 42 (Image plane) | ∞ | 0 | | | |

Aspherical surface data:
The second surface
K = 0, A4 = −3.5772E−12, A6 = −5.0529E−16
Various data:
Zoom ratio: 3.8783

| | Wide-angle | |
|---|---|---|
| | end position | Telephoto end position |
| f | 52.08399 | 201.99929 |
| Fno. | 2.80000 | 3.64122 |
| 2ω (°) | 24.54 | 6.25 |
| Image height | 11.15000 | 11.15000 |
| The total length of the lens | 193.34292 | 260.35313 |
| Back focus | 34.82211 | 58.61014 |
| Entrance pupil position | 88.37352 | 331.76411 |
| Exit pupil position | −81.96210 | −105.75012 |
| Object surface | ∞ | ∞ |
| d8 | 13.40541 | 74.18940 |
| d12 | 1.08000 | 7.29825 |
| d19 | 24.78006 | 1.00000 |
| d25 | 1.00000 | 1.00000 |
| d34 | 29.28509 | 53.08729 |
| d41 | 1.12413 | 1.10995 |

| | Wide-angle end position |
|---|---|
| | in close object point focusing |
| f | 59.32727 |
| Fno. | 2.67107 |
| 2ω (°) | 20.36 |
| Image height | 11.15000 |
| The total length of the lens | 193.34292 |
| Back focus | 34.82211 |
| Entrance pupil position | 108.50275 |
| Exit pupil position | −81.96210 |
| Object surface | 855.00821 |
| d8 | 1.59176 |
| d12 | 12.89364 |
| d19 | 24.78006 |
| d25 | 1.00000 |
| d34 | 29.28509 |
| d41 | 1.12413 |
| | Telephoto end position |
| | in close object point focusing |
| f | 185.21236 |
| Fno. | 2.01257 |
| 2ω (°) | 3.73 |
| Image height | 11.15000 |
| The total length of the lens | 260.35313 |
| Back focus | 58.61014 |
| Entrance pupil position | 523.83520 |
| Exit pupil position | −105.75012 |
| Object surface | 787.99837 |
| d8 | 54.19984 |
| d12 | 27.28781 |
| d19 | 1.00000 |
| d25 | 1.00000 |
| d34 | 53.08729 |
| d41 | 1.10995 |

Single lens data:

| Lens | Lens surface | f |
|---|---|---|
| 1 | 1-4 | −322.4095 |
| 2 | 5-6 | 162.8848 |
| 3 | 7-8 | 500.4818 |
| 4 | 9-10 | −229.0895 |
| 5 | 11-12 | 86.2883 |
| 6 | 13-14 | −36.5841 |
| 7 | 15-16 | −41.4052 |
| 8 | 16-17 | 32.2923 |
| 9 | 18-19 | −44.9808 |
| 10 | 20-21 | 87.4373 |
| 11 | 22-23 | −79.1973 |
| 12 | 24-25 | 53.5995 |
| 13 | 27-28 | 56.2686 |
| 14 | 29-30 | −64.5363 |
| 15 | 31-32 | 53.5634 |
| 16 | 33-34 | −69.6890 |
| 17 | 35-36 | ∞ |
| 18 | 37-38 | ∞ |
| 19 | 38-39 | ∞ |
| 20 | 40-41 | ∞ |

Zoom lens group data:

| Group | Lens surface | f | Lens constitution length |
|---|---|---|---|
| 1 | 1-8 | 198.86005 | 17.49082 |
| 2 | 9-12 | 142.86460 | 14.27365 |
| 3 | 13-19 | −21.68727 | 17.24031 |
| 4 | 20-25 | 57.49761 | 13.94769 |
| 5 | 26-34 | 101.17074 | 55.30287 |
| 6 | 35-41 | ∞ | 6.06200 |

| | Position of | Position of |
|---|---|---|
| Group | front-side principal point | rear-side principal point |
| 1 | 1.57617 | −9.91120 |
| 2 | 0.00383 | −9.48720 |
| 3 | 4.59527 | −6.49110 |
| 4 | 5.73777 | −3.51436 |
| 5 | 5.16755 | −41.69429 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.44869 | 0.55456 |
| 3 | −0.51743 | −1.05430 |
| 4 | −4.62931 | −202.89593 |
| 5 | 0.24369 | 0.00856 |
| 6 | 1.00000 | 1.00000 |

| | Magnification |
|---|---|
| Group | (wide-angle end position in close object point focusing) |
| 1 | −0.30235 |
| 2 | 0.36600 |
| 3 | −0.51743 |
| 4 | −4.62931 |
| 5 | 0.24369 |
| 6 | 1.00000 |

| | Magnification |
|---|---|
| Group | (telephoto end position in close object point focusing) |
| 1 | −0.33664 |
| 2 | 0.41464 |
| 3 | −1.05430 |
| 4 | −202.89593 |
| 5 | 0.00856 |
| 6 | 1.00000 |

| | |
|---|---|
| f₂/f_{w} | 2.74297 |
| f₁/f_{w} | 3.81806 |
| f₃/fₜ | −0.10736 |
| f₄/fₜ | 0.28464 |
| f₅/f_{w} | 1.94245 |
| F | 2.8~3.64122 |
| MG | −0.25568 |
| Δd/fₜ | 0.09896 |
| IH | 11.15 |
| fb/IH | 3.13289 |
| \|EW\| | 6.00571~7.71092 |

### Embodiment 3

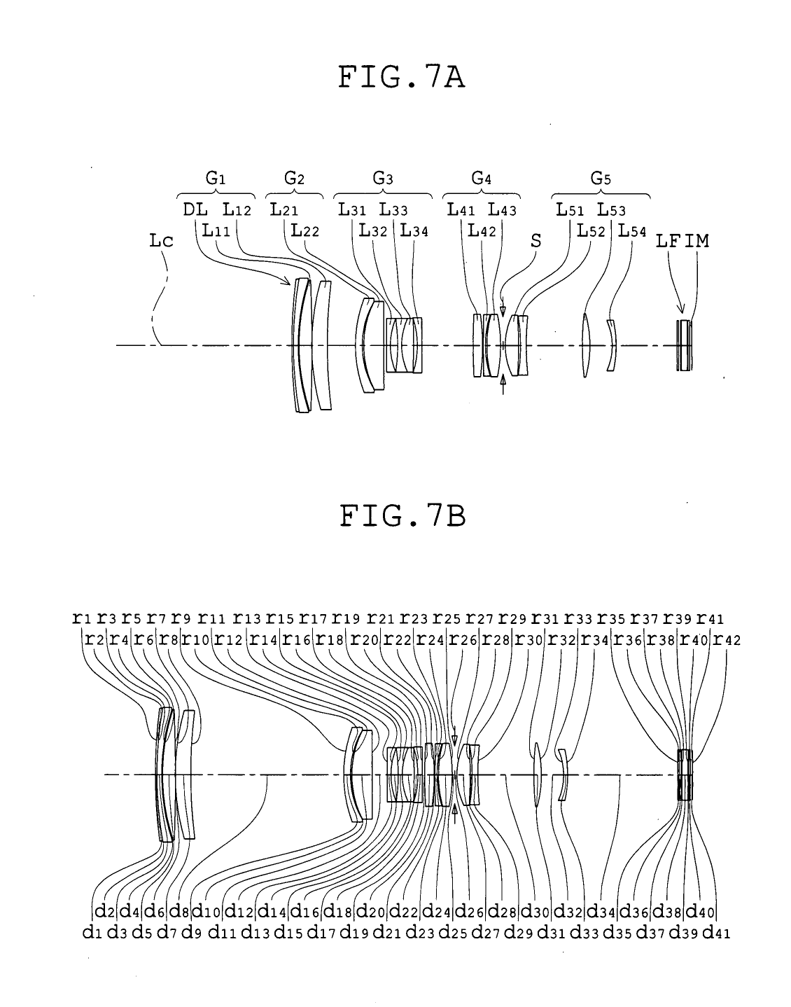

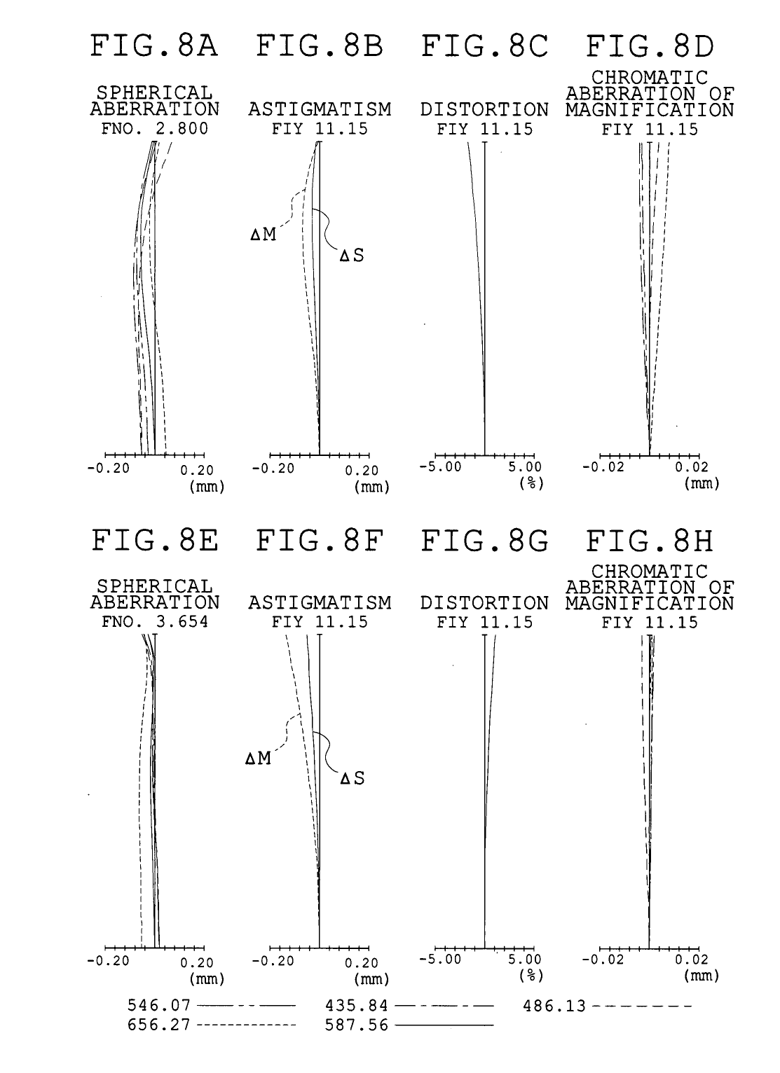

FIGS. 7A and 7B are a sectional view showing an optical formation in infinite object point focusing of an image pickup apparatus provided with a zoom lens according to the present embodiment, taken along the optical axis, and FIGS. 7A and 7B show the states in wide-angle end and telephoto end positions, respectively. FIGS. 8A, 8B, 8C, and 8D are views showing spherical aberration, astigmatism, distortion, and chromatic aberration of magnification in infinite object point focusing of the zoom lens shown in FIGS. 7A and 7B in the wide-angle end position, respectively, and FIGS. 8E, 8F, 8G, and 8H are views showing spherical aberration, astigmatism, distortion, and chromatic aberration of magnification in infinite object point focusing of the zoom lens shown in FIGS. 7A and 7B in the telephoto end position, respectively.

First, the optical formation of a zoom lens of the present embodiment is explained using FIGS. 7A and 7B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises, in order from the object side, a lens L₂₁ which is a negative meniscus lens turning its convex surface toward the object side and a lens L₂₂ which is a piano-convex lens turning its convex surface toward the object side.

The third group G₃ has negative power as a whole. The third group G₃ comprises in order from the object side: a lens L₃₁ which is a piano-concave lens turning its concave surface toward the image side; a cemented lens which comprises a biconcave lens L₃₂ and a biconvex lens L₃₃ and has positive power; and a lens L₃₄ which is a piano-concave is lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ which is a biconcave lens, a lens L₅₃ which is a biconvex lens, and a lens L₅₄ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 3
Unit: millimeter (mm)
Surface data:

| | | | | | effective |
|---|---|---|---|---|---|
| s | r | d | nd | νd | diameter |
| Object surface | ∞ | ∞ | | | |
| 1 | 218.1941 | 0.5138 | 1.63762 | 34.21 | 29.717 |
| 2* | 159.3964 | 0 | 1.0E+03 | −3.45 | 29.607 |
| 3 | 159.3982 | 2.6659 | 1.60999 | 27.48 | 29.607 |
| 4 | 103.6707 | 0.5000 | | | 29.249 |
| 5 | 96.4333 | 6.1309 | 1.51633 | 64.14 | 29.281 |
| 6 | −741.7095 | 0.1000 | | | 29.200 |
| 7 | 119.2072 | 7.3599 | 1.52542 | 55.78 | 28.911 |
| 8 | 215.0119 | variable | | | 28.176 |
| 9 | 58.9742 | 3.5412 | 1.63259 | 23.27 | 22.011 |
| 10 | 42.3636 | 0.5700 | | | 20.415 |
| 11 | 46.2892 | 9.9545 | 1.51633 | 64.14 | 20.400 |
| 12 | ∞ | variable | | | 19.054 |
| 13 | ∞ | 2.2200 | 1.88300 | 40.76 | 12.070 |
| 14 | 32.3951 | 3.4000 | | | 11.241 |
| 15 | −60.8748 | 2.0000 | 1.48749 | 70.23 | 11.263 |
| 16 | 29.9808 | 5.7294 | 1.84666 | 23.78 | 12.000 |
| 17 | −236.6854 | 2.0000 | | | 12.000 |
| 18 | −34.3639 | 2.0000 | 1.77250 | 49.60 | 12.000 |
| 19 | ∞ | variable | | | 12.550 |
| 20 | 224.4963 | 4.9092 | 1.69680 | 55.53 | 14.000 |
| 21 | −83.2259 | 0.1200 | | | 14.128 |
| 22 | 274.0749 | 1.2815 | 1.80610 | 40.92 | 14.038 |
| 23 | 51.8033 | 0.5000 | | | 13.910 |
| 24 | 51.2550 | 7.0569 | 1.49700 | 81.54 | 14.008 |
| 25 | −52.1621 | variable | | | 14.073 |
| 26 | ∞ | 1.2900 | | | 13.748 |
| (stop) | | | | | |
| 27 | 35.0273 | 6.4458 | 1.49700 | 81.54 | 13.879 |
| 28 | −142.0105 | 0.8700 | | | 13.537 |
| 29 | −62.9889 | 2.8172 | 1.64769 | 33.79 | 13.526 |
| 30 | 127.2298 | 27.5019 | | | 13.300 |
| 31 | 128.6068 | 3.6322 | 1.65160 | 58.55 | 13.400 |
| 32 | −46.9605 | 10.7788 | | | 13.400 |
| 33 | −28.1742 | 1.8800 | 1.83481 | 42.72 | 11.296 |
| 34 | −56.4151 | variable | | | 11.581 |
| 35 | ∞ | 0.7000 | 1.51633 | 64.14 | 11.492 |
| 36 | ∞ | 0.9500 | | | 11.491 |
| 37 | ∞ | 0.4500 | 1.54200 | 77.40 | 11.489 |
| 38 | ∞ | 2.8000 | 1.54771 | 62.84 | 11.488 |
| 39 | ∞ | 0.4000 | | | 11.483 |
| 40 | ∞ | 0.7620 | 1.52310 | 54.49 | 11.482 |
| 41 | ∞ | variable | | | 11.481 |
| 42 | ∞ | | | | |
| (image plane) | | | | | |

Aspherical surface data:
The second surface

K = 0, A4 = −1.9260E−13, A6 = −8.9673E−16

Various data:
Zoom ratio: 3.8787

| | Wide-angle end position | Telephoto end position |
|---|---|---|
| f | 52.07993 | 201.99997 |
| Fno. | 2.80000 | 3.65443 |
| 2ω (°) | 24.56 | 6.25 |
| Image height | 11.15000 | 11.15000 |
| The total length of the | 193.33709 | 260.36090 |
| lens | | |
| Back focus | 35.02996 | 59.12083 |
| Entrance pupil position | 88.18960 | 328.93634 |
| Exit pupil position | −82.27540 | −106.36627 |
| d8 | 13.43011 | 74.16736 |
| d12 | 1.08000 | 7.30379 |
| d19 | 25.02810 | 1.00000 |
| d25 | 1.00000 | 1.00000 |
| d34 | 29.53167 | 53.58442 |
| d41 | 1.08540 | 1.12352 |

Single lens data

| Lens | Lens surface | f |
|---|---|---|
| 1 | 1-4 | −329.7071 |
| 2 | 5-6 | 165.6908 |
| 3 | 7-8 | 496.0546 |
| 4 | 9-10 | −259.1722 |
| 5 | 11-12 | 89.6504 |
| 6 | 13-14 | −36.6876 |
| 7 | 15-16 | −40.9111 |
| 8 | 16-17 | 31.7422 |
| 9 | 18-19 | −44.4841 |
| 10 | 20-21 | 87.7116 |
| 11 | 22-23 | −79.4463 |
| 12 | 24-25 | 53.2225 |
| 13 | 27-28 | 57.2252 |
| 14 | 29-30 | −64.6714 |
| 15 | 31-32 | 53.2271 |
| 16 | 33-34 | −69.5250 |
| 17 | 35-36 | ∞ |
| 18 | 37-38 | ∞ |
| 19 | 38-39 | ∞ |
| 20 | 40-41 | ∞ |

Zoom Lens group data:

| Group | Lens surface | f | Lens constitution length |
|---|---|---|---|
| 1 | 1-8 | 199.60435 | 17.27049 |
| 2 | 9-12 | 141.62268 | 14.06567 |
| 3 | 13-19 | −21.72662 | 17.34937 |
| 4 | 20-25 | 57.06351 | 13.86752 |
| 5 | 26-34 | 103.25203 | 55.21587 |
| 6 | 35-41 | ∞ | 6.06200 |

| | | Position of rear-side |
|---|---|---|
| Group | Position of front-side principal point | principal point |
| 1 | 1.55213 | −9.78997 |
| 2 | −0.23093 | −9.54844 |
| 3 | 4.64582 | −6.48190 |
| 4 | 5.74324 | −3.44936 |
| 5 | 5.63885 | −41.28086 |
| 6 | 0 | −4.41289 |

Zoom lens group data (magnification):

| | Magnification | Magnification (telephoto |
|---|---|---|
| Group | (wide-angle end position) | end position) |
| 1 | 0 | 0 |
| 2 | 0.44502 | 0.54999 |
| 3 | −0.52232 | −1.05947 |
| 4 | −4.30197 | −62.91254 |
| 5 | 0.26093 | 0.02761 |
| 6 | 1.00000 | 1.00000 |

| | |
|---|---|
| f₂/f_{w} | 2.71933 |
| f₁/f_{w} | 3.83265 |
| f₃/fₜ | −0.10756 |
| f₄/fₜ | 0.28249 |
| f₅/f_{w} | 1.98257 |
| F | 2.8~3.65443 |
| IH | 11.15 |
| fb/IH | 3.14170 |
| \|EW\| | 5.97094~7.68105 |

### Embodiment 4

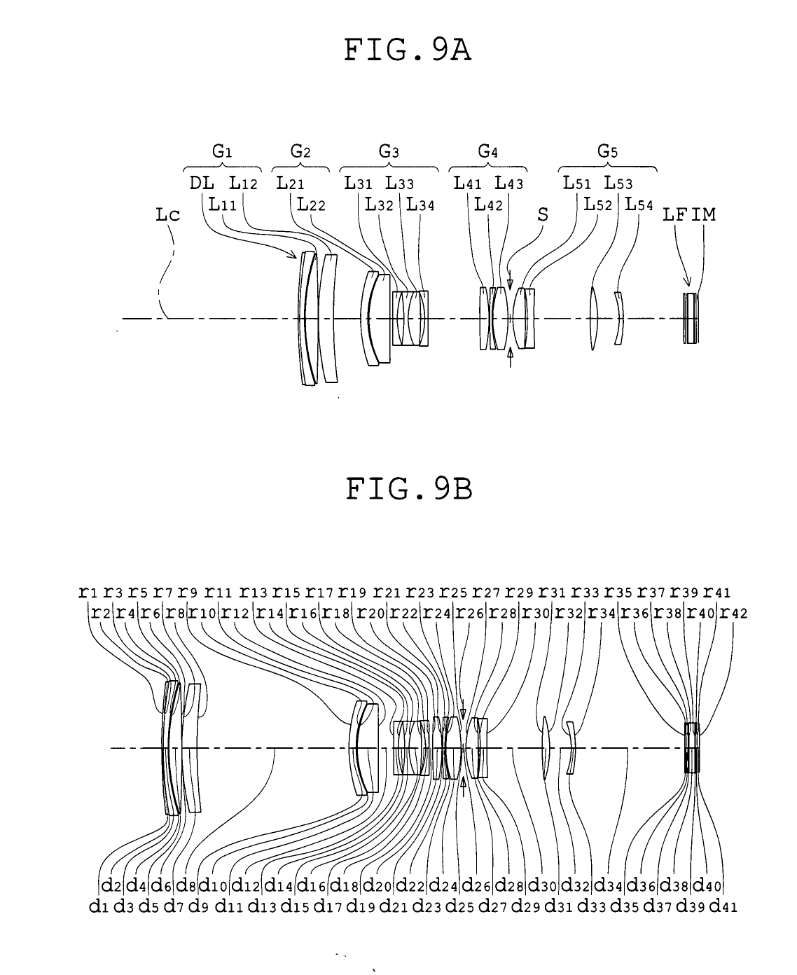

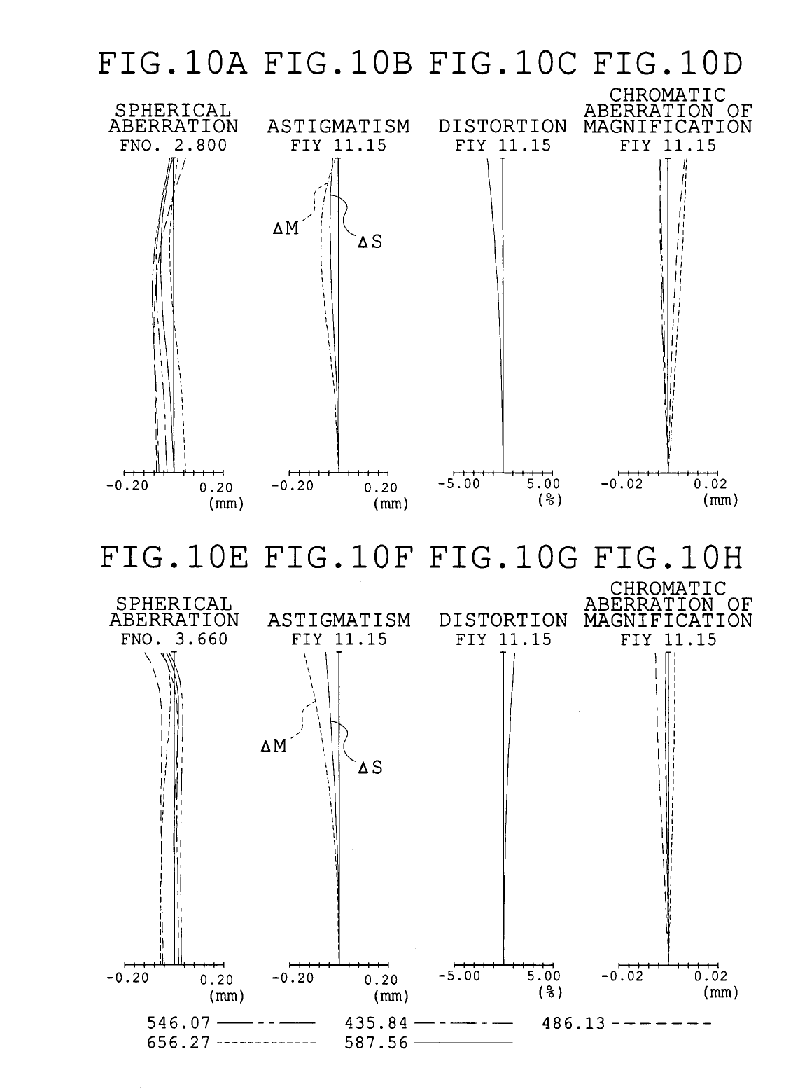

FIGS. 9A and 9B are a sectional view showing an optical formation in infinite object point focusing of an image pickup apparatus provided with a zoom lens according to the present embodiment, taken along the optical axis, and FIGS. 9A and 9B show the states in wide-angle end and telephoto end positions, respectively. FIGS. 10A, 10B, 10C, and 10D are views showing spherical aberration, astigmatism, distortion, and chromatic aberration of magnification in infinite object point focusing of the zoom lens shown in FIGS. 9A and 9B in the wide-angle end position, respectively, and FIGS. 10E, 10F, 10G, and 10H are views showing spherical aberration, astigmatism, distortion, and chromatic aberration of magnification in infinite object point focusing of the zoom lens shown in FIGS. 9A and 9B in the telephoto end position, respectively.

First, the optical formation of a zoom lens of the present embodiment is explained using FIGS. 9A and 9B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ which is a biconcave lens, a lens L₅₃ which is a biconvex lens, and a lens L₅₄ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 4
Unit: millimeter (mm)
Surface data:

| | | | | | effective |
|---|---|---|---|---|---|
| s | r | d | nd | νd | diameter |
| Object surface | ∞ | ∞ | | | |
| 1 | 209.3077 | 0.5165 | 1.63762 | 34.21 | 30.009 |
| 2* | 159.3964 | 0 | 1.0E+03 | −3.45 | 29.902 |
| 3 | 159.3984 | 2.5069 | 1.60999 | 27.48 | 29.902 |
| 4 | 102.8526 | 0.5000 | | | 29.541 |
| 5 | 95.8621 | 6.1079 | 1.51633 | 64.14 | 29.571 |
| 6 | −740.8215 | 0.1000 | | | 29.500 |
| 7 | 119.9160 | 7.3554 | 1.52542 | 55.78 | 29.190 |
| 8 | 209.4218 | variable | | | 28.433 |
| 9* | 65.6121 | 3.4564 | 1.60999 | 27.48 | 22.555 |
| 10 | 42.6134 | 0.5700 | | | 20.883 |
| 11 | 44.6922 | 10.4666 | 1.51633 | 64.14 | 20.829 |
| 12 | ∞ | variable | | | 19.374 |
| 13 | ∞ | 2.2200 | 1.88300 | 40.76 | 12.070 |
| 14 | 32.7171 | 3.4000 | | | 11.233 |
| 15 | −63.1012 | 2.0000 | 1.48749 | 70.23 | 11.260 |
| 16 | 29.7620 | 6.0878 | 1.84666 | 23.78 | 12.000 |
| 17 | −231.1268 | 2.0000 | | | 12.000 |
| 18 | −34.1739 | 2.0000 | 1.77250 | 49.60 | 12.000 |
| 19 | ∞ | variable | | | 12.550 |
| 20 | 228.6330 | 4.5386 | 1.69680 | 55.53 | 14.000 |
| 21 | −79.8916 | 0.1200 | | | 14.114 |
| 22 | 282.8491 | 1.2853 | 1.80610 | 40.92 | 14.015 |
| 23 | 50.1904 | 0.5000 | | | 13.872 |
| 24 | 49.9089 | 7.3720 | 1.49700 | 81.54 | 13.972 |
| 25 | −52.3711 | variable | | | 14.045 |
| 26 | ∞ | 1.2900 | | | 13.728 |
| (stop) | | | | | |
| 27 | 34.5534 | 6.4672 | 1.49700 | 81.54 | 13.873 |
| 28 | −146.3759 | 0.8700 | | | 13.528 |
| 29 | −64.3093 | 2.9747 | 1.64769 | 33.79 | 13.514 |
| 30 | 126.5863 | 27.4869 | | | 13.300 |
| 31 | 129.2095 | 3.7633 | 1.65160 | 58.55 | 13.000 |
| 32 | −46.4655 | 10.5276 | | | 13.000 |
| 33 | −27.8866 | 1.8800 | 1.83481 | 42.72 | 11.032 |
| 34 | −56.6405 | variable | | | 11.318 |
| 35 | ∞ | 0.7000 | 1.51633 | 64.14 | 11.460 |
| 36 | ∞ | 0.9500 | | | 11.461 |
| 37 | ∞ | 0.4500 | 1.54200 | 77.40 | 11.464 |
| 38 | ∞ | 2.8000 | 1.54771 | 62.84 | 11.465 |
| 39 | ∞ | 0.4000 | | | 11.470 |
| 40 | ∞ | 0.7620 | 1.52310 | 54.49 | 11.471 |
| 41 | ∞ | variable | | | 11.473 |
| 42 | ∞ | | | | |
| (image plane) | | | | | |

Aspherical surface data:

The second surface
K = 0, A4 = −7.0867E−13, A6 = −6.7312E−16
The ninth surface
K = 0, A4 = −1.9191E−08, A6 = −1.7646E−23

Various data:
Zoom ratio: 3.8785

| | Wide-angle end position | Telephoto end position |
|---|---|---|
| f | 52.08149 | 202.00004 |
| Fno. | 2.80000 | 3.66014 |
| 2ω (°) | 24.54 | 6.25 |
| Image height | 11.15000 | 11.15000 |
| The total length of the | 193.34768 | 260.51668 |
| lens | | |
| Back focus | 34.66291 | 58.67796 |
| Entrance pupil position | 88.45255 | 332.09408 |
| Exit pupil position | −81.52045 | −105.53550 |
| d8 | 13.40871 | 74.17649 |
| d12 | 1.08000 | 7.29909 |
| d19 | 24.83293 | 1.00000 |
| d25 | 1.00000 | 1.00000 |
| d34 | 29.20664 | 53.10819 |
| d41 | 1.04337 | 1.15688 |

Single lens data:

| Lens | Lens surface | f |
|---|---|---|
| 1 | 1-4 | −339.3372 |
| 2 | 5-6 | 164.7984 |
| 3 | 7-8 | 519.3011 |
| 4 | 9-10 | −211.3326 |
| 5 | 11-12 | 86.5574 |
| 6 | 13-14 | −37.0524 |
| 7 | 15-16 | −41.1942 |
| 8 | 16-17 | 31.4789 |
| 9 | 18-19 | −44.2381 |
| 10 | 20-21 | 85.4822 |
| 11 | 22-23 | −75.8823 |
| 12 | 24-25 | 52.6796 |
| 13 | 27-28 | 56.9220 |
| 14 | 29-30 | −65.4404 |
| 15 | 31-32 | 52.8959 |
| 16 | 33-34 | −67.8195 |
| 17 | 35-36 | ∞ |
| 18 | 37-38 | ∞ |
| 19 | 38-39 | ∞ |
| 20 | 40-41 | ∞ |

Zoom Lens group data:

| Group | Lens surface | f | Lens constitution length |
|---|---|---|---|
| 1 | 1-8 | 198.38835 | 17.08669 |
| 2 | 9-12 | 151.01804 | 14.49303 |
| 3 | 13-19 | −22.03235 | 17.70783 |
| 4 | 20-25 | 57.29534 | 13.81584 |
| 5 | 26-34 | 102.37341 | 55.25975 |
| 6 | 35-41 | ∞ | 6.06200 |

| | Position of | Position of |
|---|---|---|
| Group | front-side principal point | rear-side principal point |
| 1 | 1.31424 | −9.90521 |
| 2 | 0.12974 | −9.50947 |
| 3 | 4.74985 | −6.53320 |
| 4 | 5.67610 | −3.51582 |
| 5 | 4.78994 | −41.83249 |
| 6 | 0 | −4.41289 |

Zoom lens group data (magnification):

| | Magnification | Magnification (telephoto end |
|---|---|---|
| Group | (wide-angle end position) | position) |
| 1 | 0 | 0 |
| 2 | 0.46330 | 0.56946 |
| 3 | −0.50440 | −1.02818 |
| 4 | −4.44410 | −95.56194 |
| 5 | 0.25278 | 0.01820 |
| 6 | 1.00000 | 1.00000 |

| | |
|---|---|
| f₂/f_{w} | 2.89965 |
| f₁/f_{w} | 3.80919 |
| f₃/fₜ | −0.10907 |
| f₄/fₜ | 0.28364 |
| f₅/f_{w} | 1.96564 |
| F | 2.8~3.66014 |
| IH | 11.15 |
| fb/IH | 3.10878 |
| \|EW\| | 6.01815~7.75271 |

### Embodiment 5

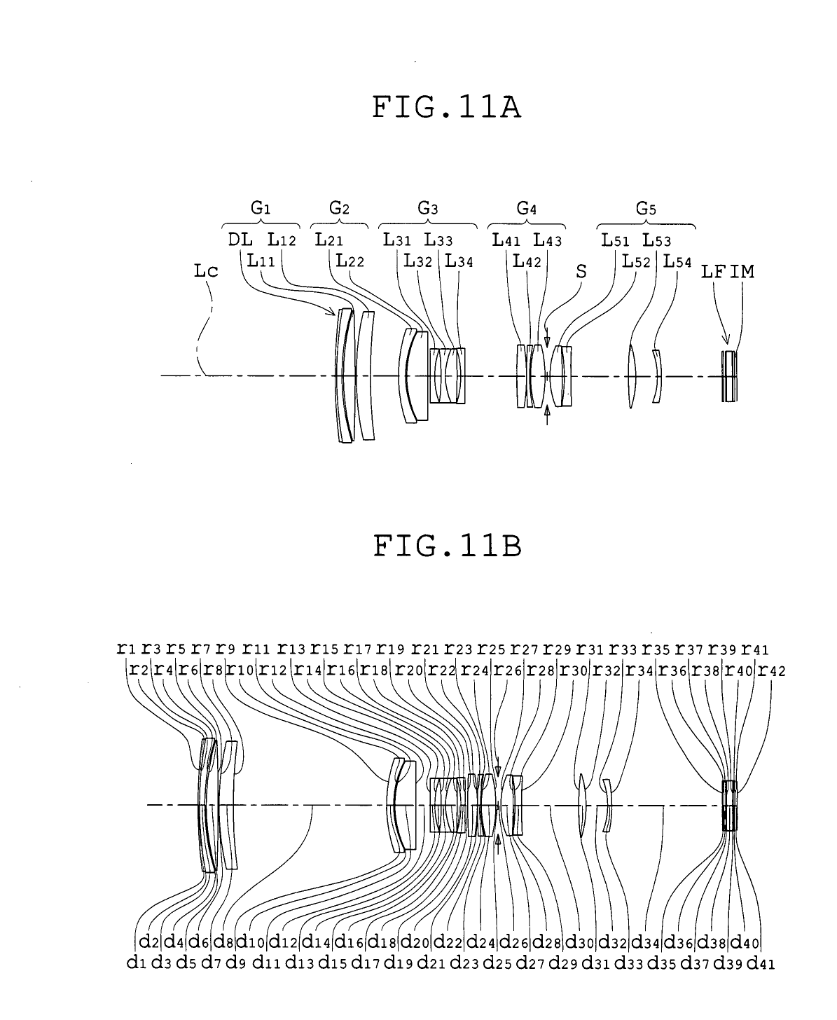

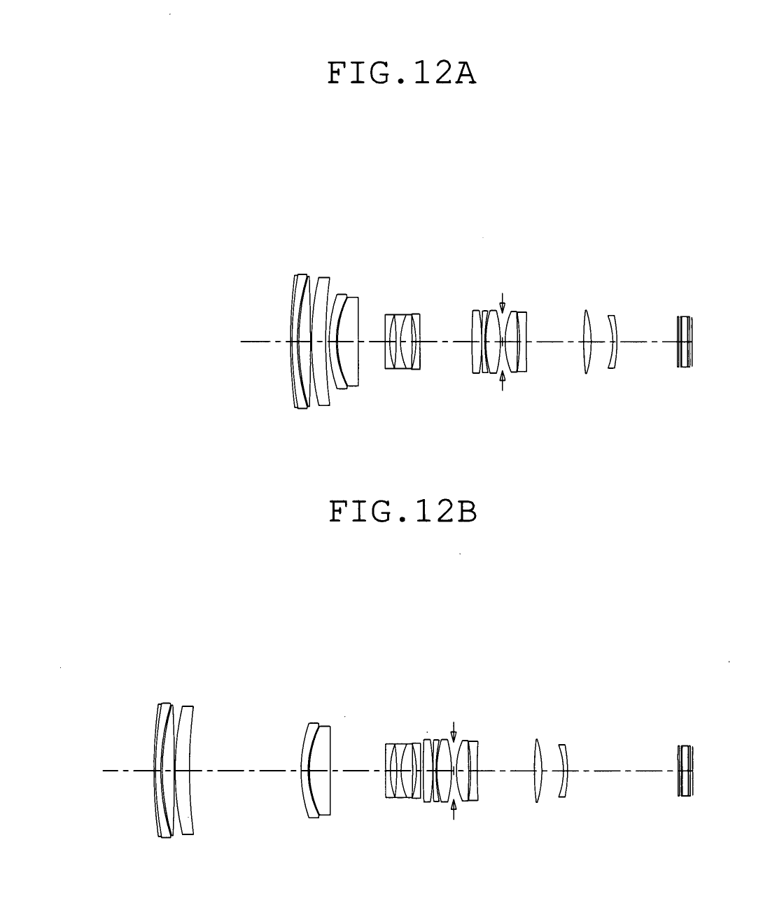

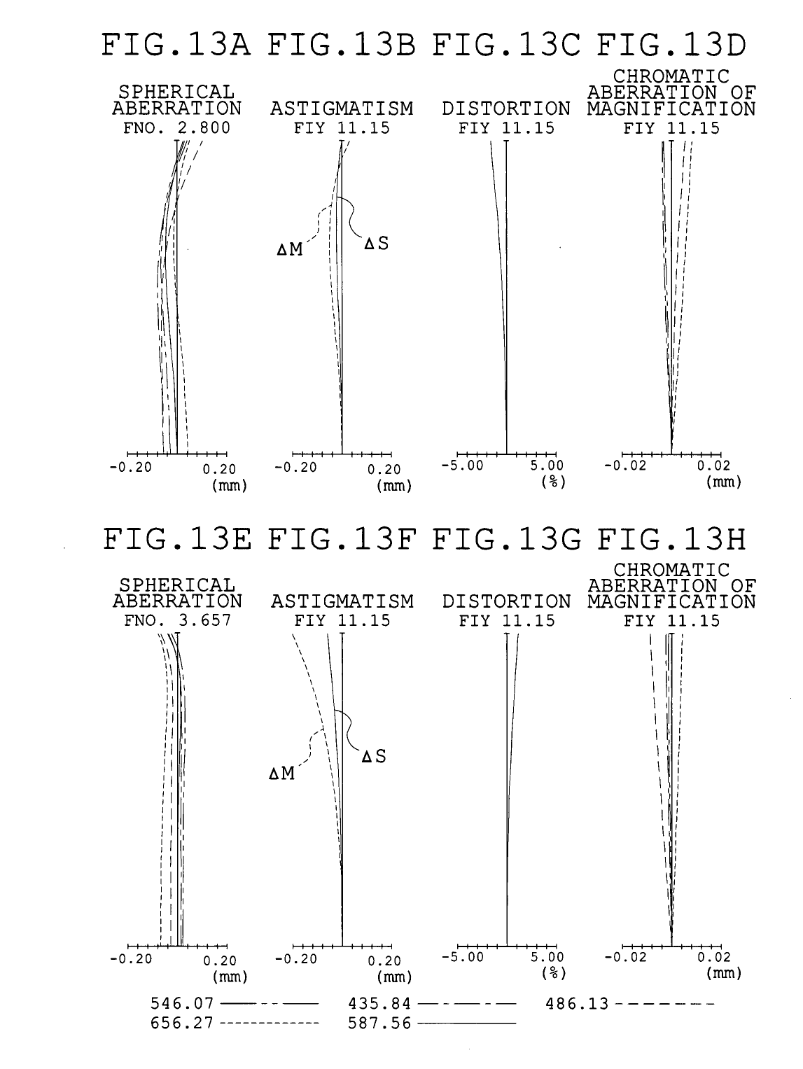

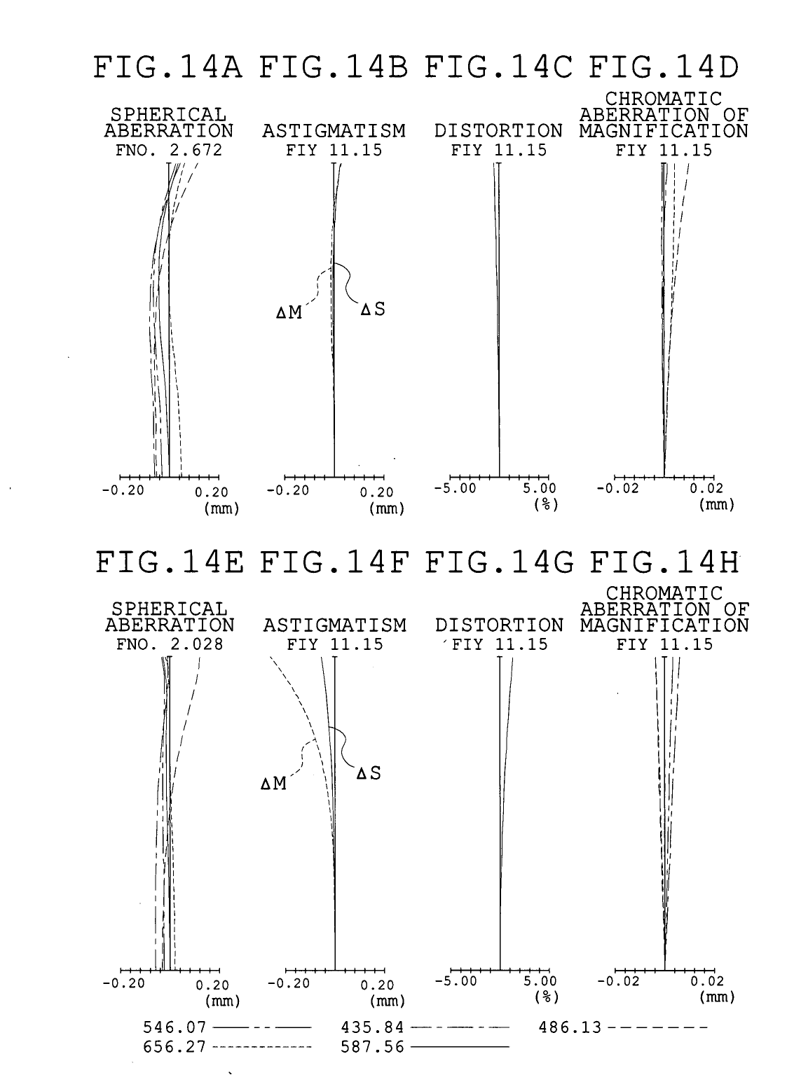

FIGS. 11A and 11B are a sectional view showing an optical formation in infinite object point focusing of an image pickup apparatus provided with a zoom lens according to the present embodiment, taken along the optical axis, and FIGS. 11A and 11B show the states in wide-angle end and telephoto end positions, respectively. FIGS. 12A and 12B are a sectional view showing an optical formation in close-far object point focusing of the image pickup apparatus provided with the zoom lens according to the present embodiment, taken along the optical axis, and FIGS. 12A and 12B show the states in wide-angle end and telephoto end positions, respectively. FIGS. 13A, 13B, 13C, and 13D are views showing spherical aberration, astigmatism, distortion, and chromatic aberration of magnification in infinite object point focusing of the zoom lens shown in FIGS. 11A, 11B, 12A, and 12B in the wide-angle end position, respectively, and FIGS. 13E, 13F, 13G, and 13H are views showing spherical aberration, astigmatism, distortion, and chromatic aberration of magnification in infinite object point focusing of the zoom lens shown in FIGS. 11A, 11B, 12A, and 12B in the telephoto end position, respectively. FIGS. 14A, 14B, 14C, and 14D are views showing spherical aberration, astigmatism, distortion, and chromatic aberration of magnification in close object point focusing of the zoom lens shown in FIGS. 11A, 11B, 12A, and 12B in the wide-angle end position, respectively, and FIGS. 14E, 14F, 14G, and 14H are views showing spherical aberration, astigmatism, distortion, and chromatic aberration of magnification in close object point focusing of the zoom lens shown in FIGS. 11A, 11B, 12A, and 12B in the telephoto end position, respectively.

First, the optical formation of a zoom lens of the present embodiment is explained using FIGS. 11A, 11B, 12A, and 12B. The zoom lens of the present embodiment comprises, in order from the object side, a first group G_{I}, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a piano-concave lens turning its concave surface toward the image side; a cemented lens which comprises a biconcave lens L₃₂ and a biconvex lens L₃₃ and has positive power; and a lens L₃₄ which is a piano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ which is a biconcave lens, a lens L₅₃ which is a biconvex lens, and a lens L₅₄ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 5
Unit: millimeter (mm)
Surface data:

| | | | | | effective |
|---|---|---|---|---|---|
| s | r | d | nd | νd | diameter |
| Object surface | ∞ | ∞ | | | |
| 1 | 218.1350 | 0.4966 | 1.63762 | 34.21 | 30.015 |
| 2* | 159.3964 | 0 | 1.0E+03 | −3.45 | 29.905 |
| 3 | 159.3984 | 2.6703 | 1.60999 | 27.48 | 29.905 |
| 4 | 103.5221 | 0.5000 | | | 29.541 |
| 5 | 96.2445 | 6.1386 | 1.51633 | 64.14 | 29.574 |
| 6 | −731.1182 | 0.1000 | | | 29.500 |
| 7 | 121.1511 | 7.1949 | 1.52542 | 55.78 | 29.204 |
| 8 | 221.8208 | variable | | | 28.494 |
| 9* | 59.5147 | 3.5981 | 1.63259 | 23.27 | 22.297 |
| 10 | 43.0583 | 0.5700 | | | 20.684 |
| 11 | 47.7205 | 10.2599 | 1.51633 | 64.14 | 20.685 |
| 12 | ∞ | variable | | | 19.228 |
| 13 | ∞ | 2.2200 | 1.88300 | 40.76 | 12.070 |
| 14 | 32.4080 | 3.4000 | | | 11.235 |
| 15 | −62.3483 | 2.0000 | 1.48749 | 70.23 | 11.259 |
| 16 | 29.6944 | 5.5230 | 1.84666 | 23.78 | 12.000 |
| 17 | −226.8395 | 2.0000 | | | 12.000 |
| 18 | −34.0693 | 2.0000 | 1.77250 | 49.60 | 12.000 |
| 19 | ∞ | variable | | | 12.550 |
| 20 | 232.8949 | 4.8970 | 1.69680 | 55.53 | 14.000 |
| 21 | −80.2713 | 0.1200 | | | 14.128 |
| 22 | 280.2635 | 1.2174 | 1.80610 | 40.92 | 14.029 |
| 23 | 51.8397 | 0.5000 | | | 13.897 |
| 24 | 50.1278 | 7.1849 | 1.49700 | 81.54 | 14.002 |
| 25 | −52.6131 | variable | | | 14.054 |
| 26 | ∞ | 1.2900 | | | 13.714 |
| (stop) | | | | | |
| 27 | 35.1385 | 6.3572 | 1.49700 | 81.54 | 13.725 |
| 28 | −140.3634 | 0.8700 | | | 13.376 |
| 29 | −61.7948 | 2.6881 | 1.64769 | 33.79 | 13.366 |
| 30 | 122.6042 | 27.9659 | | | 13.300 |
| 31 | 132.1403 | 3.8183 | 1.65160 | 58.55 | 13.000 |
| 32 | −46.9958 | 11.0406 | | | 13.000 |
| 33 | −28.1025 | 1.8800 | 1.83481 | 42.72 | 11.029 |
| 34 | −55.2399 | variable | | | 11.317 |
| 35 | ∞ | 0.7000 | 1.51633 | 64.14 | 11.452 |
| 36 | ∞ | 0.9500 | | | 11.454 |
| 37 | ∞ | 0.4500 | 1.54200 | 77.40 | 11.456 |
| 38 | ∞ | 2.8000 | 1.54771 | 62.84 | 11.457 |
| 39 | ∞ | 0.4000 | | | 11.462 |
| 40 | ∞ | 0.7620 | 1.52310 | 54.49 | 11.463 |
| 41 | ∞ | variable | | | 11.465 |
| 42 | ∞ | | | | |
| (image plane) | | | | | |

Aspherical surface data:

The second surface
K = 0, A4 = −4.8684E−13, A6 = −2.0699E−16
The ninth surface
K = 0, A4 = 4.2318E−10, A6 = 2.0082E−11

Various data:
Zoom ratio: 3.8787

| | Wide-angle end position | Telephoto end position |
|---|---|---|
| f | 52.07892 | 201.99931 |
| Fno. | 2.80000 | 3.65651 |
| 2ω (°) | 24.54 | 6.25 |
| Image height | 11.15000 | 11.15000 |
| The total length of the | 193.63462 | 260.29047 |
| lens | | |
| Back focus | 34.36366 | 58.62530 |
| Entrance pupil position | 88.55735 | 328.14564 |
| Exit pupil position | −82.47895 | −106.74059 |
| An object | ∞ | ∞ |
| d8 | 13.42544 | 73.93134 |
| d12 | 1.08000 | 7.23282 |
| d19 | 25.26452 | 1.00000 |
| d25 | 1.00000 | 1.00000 |
| d34 | 28.82163 | 53.10337 |
| d41 | 1.12914 | 1.10905 |

| | Wide-angle end position |
|---|---|
| | in close object point focusing |
| f | 59.44139 |
| Fno. | 2.67163 |
| 2ω (°) | 2.67163 |
| Image height | 11.15000 |
| The total length of the lens | 193.63462 |
| Back focus | 34.36366 |
| Entrance pupil position | 109.17144 |
| Exit pupil position | −82.47895 |
| An object | 854.71748 |
| d8 | 1.36011 |
| d12 | 13.14533 |
| d19 | 25.26452 |
| d25 | 1.00000 |
| d34 | 28.82163 |
| d41 | 1.12947 |
| | Telephoto end position in |
| | close object point focusing |
| f | 185.61055 |
| Fno. | 2.02785 |
| 2ω (°) | 2.02785 |
| Image height | 11.15000 |
| The total length of the lens | 260.29047 |
| Back focus | 58.62530 |
| Entrance pupil position | 518.40939 |
| Exit pupil position | −106.74059 |
| An object | 788.06041 |
| d8 | 53.63482 |
| d12 | 27.52934 |
| d19 | 1.00000 |
| d25 | 1.00000 |
| d34 | 53.10337 |
| d41 | 1.10905 |

Single lens data:

| Lens | Lens surface | f |
|---|---|---|
| 1 | 1-4 | −329.8123 |
| 2 | 5-6 | 165.1349 |
| 3 | 7-8 | 495.8643 |
| 4 | 9-10 | −268.9482 |
| 5 | 11-12 | 92.4225 |
| 6 | 13-14 | −36.7022 |
| 7 | 15-16 | −40.9697 |
| 8 | 16-17 | 31.3219 |
| 9 | 18-19 | −44.1027 |
| 10 | 20-21 | 86.2257 |
| 11 | 22-23 | −79.0923 |
| 12 | 24-25 | 52.8781 |
| 13 | 27-28 | 57.2340 |
| 14 | 29-30 | −63.0740 |
| 15 | 31-32 | 53.6537 |
| 16 | 33-34 | −70.7541 |
| 17 | 35-36 | ∞ |
| 18 | 37-38 | ∞ |
| 19 | 38-39 | ∞ |
| 20 | 40-41 | ∞ |

Zoom Lens group data:

| Group | Lens surface | f | Lens constitution length |
|---|---|---|---|
| 1 | 1-8 | 198.79400 | 17.10046 |
| 2 | 9-12 | 145.53579 | 14.42803 |
| 3 | 13-19 | −21.91139 | 17.14301 |
| 4 | 20-25 | 56.23119 | 13.91939 |
| 5 | 26-34 | 106.29680 | 55.91012 |
| 6 | 35-41 | ∞ | 6.06200 |

| | Position of | Position of |
|---|---|---|
| Group | front-side principal point | rear-side principal point |
| 1 | 1.68409 | −9.55763 |
| 2 | −0.31518 | −9.86713 |
| 3 | 4.61525 | −6.42008 |
| 4 | 5.73760 | −3.49760 |
| 5 | 6.30907 | −41.40812 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.45245 | 0.55728 |
| 3 | −0.51905 | −1.05314 |
| 4 | −3.88458 | −29.38329 |
| 5 | 0.28717 | 0.05892 |
| 6 | 1.00000 | 1.00000 |

| | Magnification (wide-angle end |
|---|---|
| Group | position in close object point focusing) |
| 1 | −0.30230 |
| 2 | 0.36955 |
| 3 | −0.51905 |
| 4 | −3.88458 |
| 5 | 0.28717 |
| 6 | 1.00000 |
| | Magnification (telephoto end |
| Group | position in close object point focusing) |
| 1 | −0.33640 |
| 2 | 0.41781 |
| 3 | −1.05314 |
| 4 | −29.38329 |
| 5 | 0.05892 |
| 6 | 1.00000 |

| | |
|---|---|
| f₂/f_{w} | 2.79452 |
| f₁/f_{w} | 3.81717 |
| f₃/fₜ | −0.10847 |
| f₄/fₜ | 0.27837 |
| f₅/f_{w} | 2.04107 |
| F | 2.8~3.65651 |
| MG | −0.25628 |
| Δd/fₜ | 0.10048 |
| IH | 11.15 |
| fb/IH | 3.08194 |
| \|EW\| | 5.95020~7.66237 |

### Embodiment 6

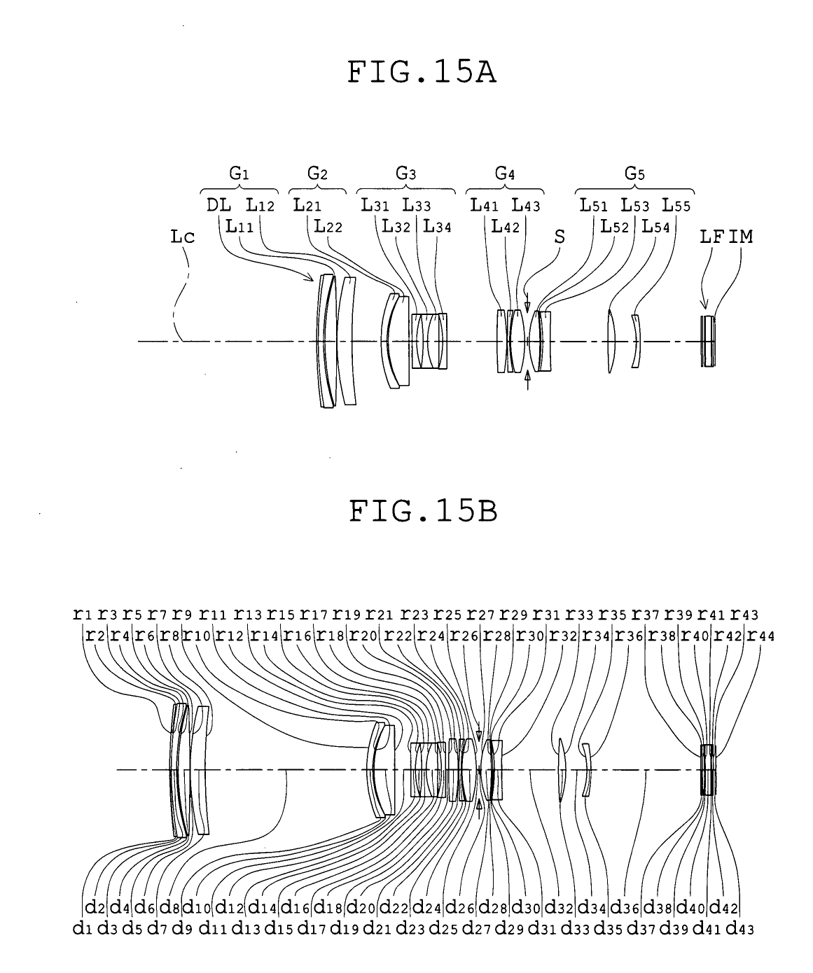

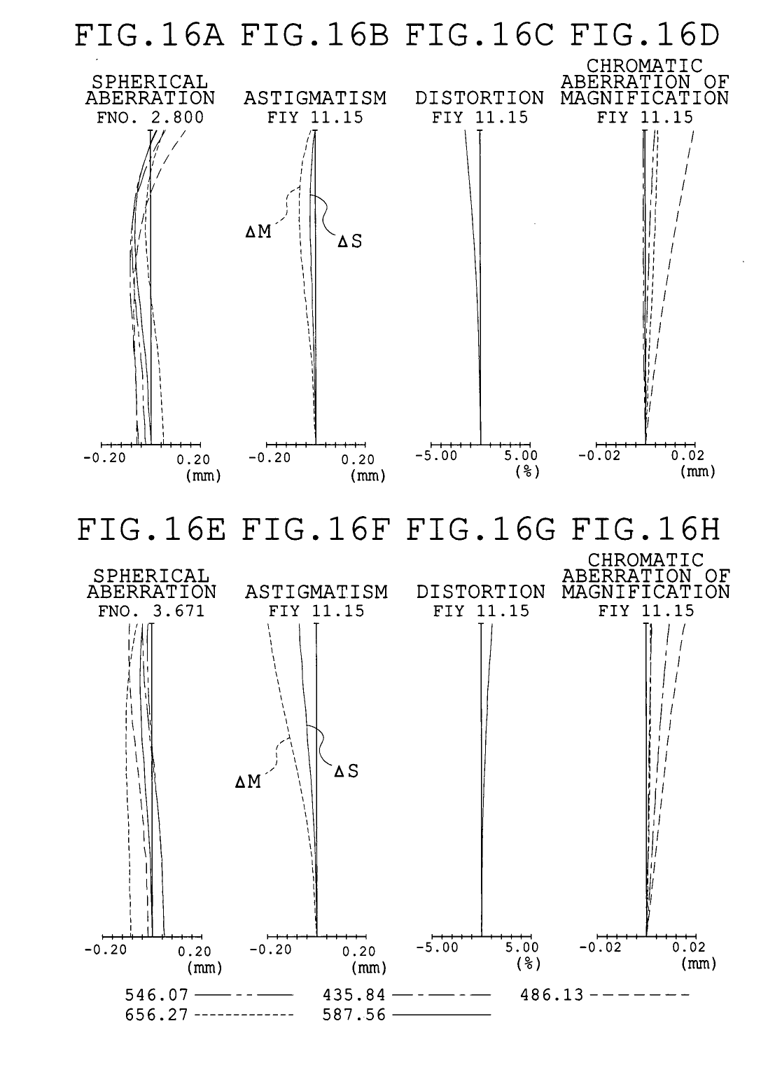

FIGS. 15A and 15B are a sectional view showing an optical formation in infinite object point focusing of an image pickup apparatus provided with a zoom lens according to the present embodiment, taken along the optical axis, and FIGS. 15A and 15B show the states in wide-angle end and telephoto end positions, respectively. FIGS. 16A, 16B, 16C, and 16D are views showing spherical aberration, astigmatism, distortion, and chromatic aberration of magnification in infinite object point focusing of the zoom lens shown in FIGS. 15A and 15B in the wide-angle end position, respectively, and FIGS. 16E, 16F, 16G, and 16H are views showing spherical aberration, astigmatism, distortion, and chromatic aberration of magnification in infinite object point focusing of the zoom lens shown in FIGS. 15A and 15B in the telephoto end position, respectively.

First, the optical formation of a zoom lens of the present embodiment is explained using FIGS. 15A and 15B. The zoom lens of the present embodiment comprises, in order from the object side, a first group G_{I}, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ the image-side surface of which is an aspherical surface and which is a negative meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 6
Unit: millimeter (mm)
Surface data:

| | | | | | effective |
|---|---|---|---|---|---|
| s | r | d | nd | νd | diameter |
| Object surface | ∞ | ∞ | | | |
| 1 | 222.1443 | 0.5365 | 1.63762 | 34.21 | 29.800 |
| 2* | 159.3964 | 0 | 1.0E+03 | −3.45 | 29.800 |
| 3 | 159.3985 | 2.9477 | 1.60999 | 27.48 | 29.800 |
| 4 | 111.5892 | 0.5000 | | | 29.800 |
| 5 | 102.4246 | 5.8455 | 1.51633 | 64.14 | 29.575 |
| 6 | −747.3523 | 0.1000 | | | 29.500 |
| 7 | 122.6882 | 7.1217 | 1.52542 | 55.78 | 29.202 |
| 8 | 196.2802 | variable | | | 28.467 |
| 9* | 55.7985 | 3.1370 | 1.63259 | 23.27 | 21.720 |
| 10 | 39.9522 | 0.5700 | | | 20.217 |
| 11 | 43.7607 | 10.2270 | 1.51633 | 64.14 | 20.211 |
| 12 | ∞ | variable | | | 19.235 |
| 13 | ∞ | 2.2200 | 1.88300 | 40.76 | 12.070 |
| 14 | 31.2983 | 3.4000 | | | 11.189 |
| 15 | −68.8901 | 2.0000 | 1.48749 | 70.23 | 11.222 |
| 16 | 28.4729 | 5.7823 | 1.84666 | 23.78 | 12.000 |
| 17 | −284.8220 | 2.0000 | | | 12.000 |
| 18 | −34.1669 | 2.0000 | 1.77250 | 49.60 | 12.000 |
| 19 | ∞ | variable | | | 12.550 |
| 20 | 234.2331 | 4.7041 | 1.69680 | 55.53 | 14.000 |
| 21 | −86.6221 | 0.1200 | | | 14.129 |
| 22 | 268.2464 | 1.1847 | 1.80610 | 40.92 | 14.055 |
| 23 | 54.6950 | 0.5000 | | | 13.928 |
| 24 | 52.7203 | 7.0005 | 1.51633 | 64.14 | 14.004 |
| 25 | −58.9238 | variable | | | 14.031 |
| 26 | ∞ | 1.2900 | | | 13.750 |
| (stop) | | | | | |
| 27 | 37.2087 | 5.1040 | 1.51633 | 64.14 | 13.918 |
| 28 | −145.4668 | 0.8700 | | | 13.729 |
| 29 | −66.8657 | 0.5277 | 1.63762 | 34.21 | 13.600 |
| 30* | −67.1122 | 0 | 1.0E+03 | −3.45 | 13.600 |
| 31 | −67.1112 | 3.5467 | 1.60999 | 27.48 | 13.600 |
| 32 | 129.6016 | 27.9199 | | | 13.600 |
| 33 | 138.7451 | 3.7188 | 1.65160 | 58.55 | 13.000 |
| 34 | −49.8445 | 10.4285 | | | 13.000 |
| 35 | −28.5939 | 1.8800 | 1.83481 | 42.72 | 11.157 |
| 36 | −55.5976 | variable | | | 11.439 |
| 37 | ∞ | 0.7000 | 1.51633 | 64.14 | 11.471 |
| 38 | ∞ | 0.9500 | | | 11.471 |
| 39 | ∞ | 0.4500 | 1.54200 | 77.40 | 11.472 |
| 40 | ∞ | 2.8000 | 1.54771 | 62.84 | 11.472 |
| 41 | ∞ | 0.4000 | | | 11.473 |
| 42 | ∞ | 0.7620 | 1.52310 | 54.49 | 11.473 |
| 43 | ∞ | variable | | | 11.474 |
| 44 | ∞ | | | | |
| (image plane) | | | | | |

Aspherical surface data:

The second surface
K = 0, A4 = −1.1868E−13, A6 = −1.7122E−15
The ninth surface
K = 0, A4 = −2.0182E−09, A6 = 7.4574E−11
The thirtieth surface
K = 0, A4 = −6.2416E−11

Various data:
Zoom ratio: 3.8787

| | Wide-angle end position | Telephoto end position |
|---|---|---|
| f | 52.07864 | 201.99906 |
| Fno. | 2.80000 | 3.67098 |
| 2ω (°) | 24.54 | 6.25 |
| Image height | 11.15000 | 11.15000 |
| The total length of the | 192.47048 | 264.19979 |
| lens | | |
| Back focus | 34.37456 | 58.88907 |
| Entrance pupil position | 88.23705 | 335.33957 |
| Exit pupil position | −81.58126 | −106.09577 |
| d8 | 14.30530 | 78.23313 |
| d12 | 1.08000 | 7.89495 |
| d19 | 24.52797 | 1.00000 |
| d25 | 1.00000 | 1.00000 |
| d36 | 29.22077 | 53.05974 |
| d43 | 0.74090 | 1.41644 |

Single lens data:

| Lens | Lens surface | f |
|---|---|---|
| 1 | 1-4 | −377.1335 |
| 2 | 5-6 | 174.8702 |
| 3 | 7-8 | 602.7014 |
| 4 | 9-10 | −240.8648 |
| 5 | 11-12 | 84.7535 |
| 6 | 13-14 | −35.4456 |
| 7 | 15-16 | −41.0502 |
| 8 | 16-17 | 30.8343 |
| 9 | 18-19 | −44.2291 |
| 10 | 20-21 | 91.3028 |
| 11 | 22-23 | −85.4413 |
| 12 | 24-25 | 55.0654 |
| 13 | 27-28 | 57.9365 |
| 14 | 29-32 | −72.9657 |
| 15 | 33-34 | 56.7192 |
| 16 | 35-36 | −72.8284 |
| 17 | 37-38 | ∞ |
| 18 | 39-40 | ∞ |
| 19 | 40-41 | ∞ |
| 20 | 42-43 | ∞ |

Zoom Lens group data:

| Group | Lens surface | f | Lens constitution length |
|---|---|---|---|
| 1 | 1-8 | 211.82332 | 17.05145 |
| 2 | 9-12 | 134.80517 | 13.93406 |
| 3 | 13-19 | −21.67413 | 17.40234 |
| 4 | 20-25 | 57.75838 | 13.50923 |
| 5 | 26-36 | 98.61837 | 55.28556 |
| 6 | 37-43 | ∞ | 6.06200 |

| | Position of | Position of |
|---|---|---|
| Group | front-side principal point | rear-side principal point |
| 1 | 0.98579 | −10.18231 |
| 2 | −0.11091 | −9.36220 |
| 3 | 4.63387 | −6.49418 |
| 4 | 5.40747 | −3.48568 |
| 5 | 5.10086 | −41.82761 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.41832 | 0.52185 |
| 3 | −0.52023 | −1.03741 |
| 4 | −4.97025 | 82.78882 |
| 5 | 0.22730 | −0.02128 |
| 6 | 1.00000 | 1.00000 |

| | |
|---|---|
| f₂/f_{w} | 2.58849 |
| f₁/f_{w} | 4.06737 |
| f₃/fₜ | −0.10730 |
| f₄/fₜ | 0.28593 |
| f₅/f_{w} | 1.89364 |
| F | 2.8~3.67098 |
| IH | 11.15 |
| fb/IH | 3.08292 |
| \|EW\| | 5.9867~7.74683 |

### Embodiment 7

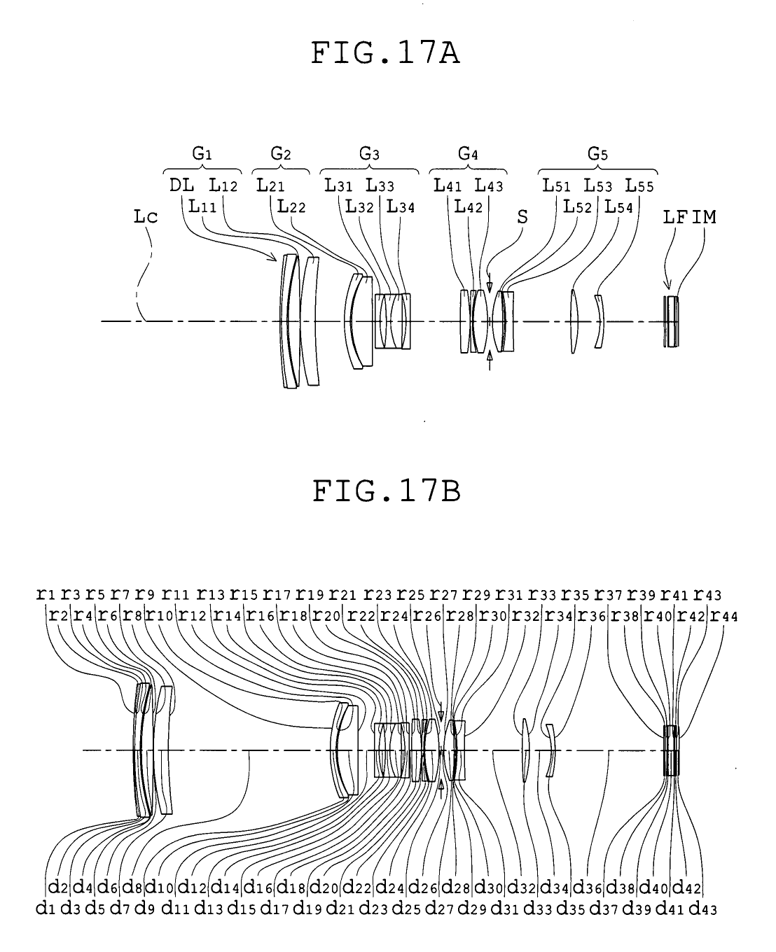

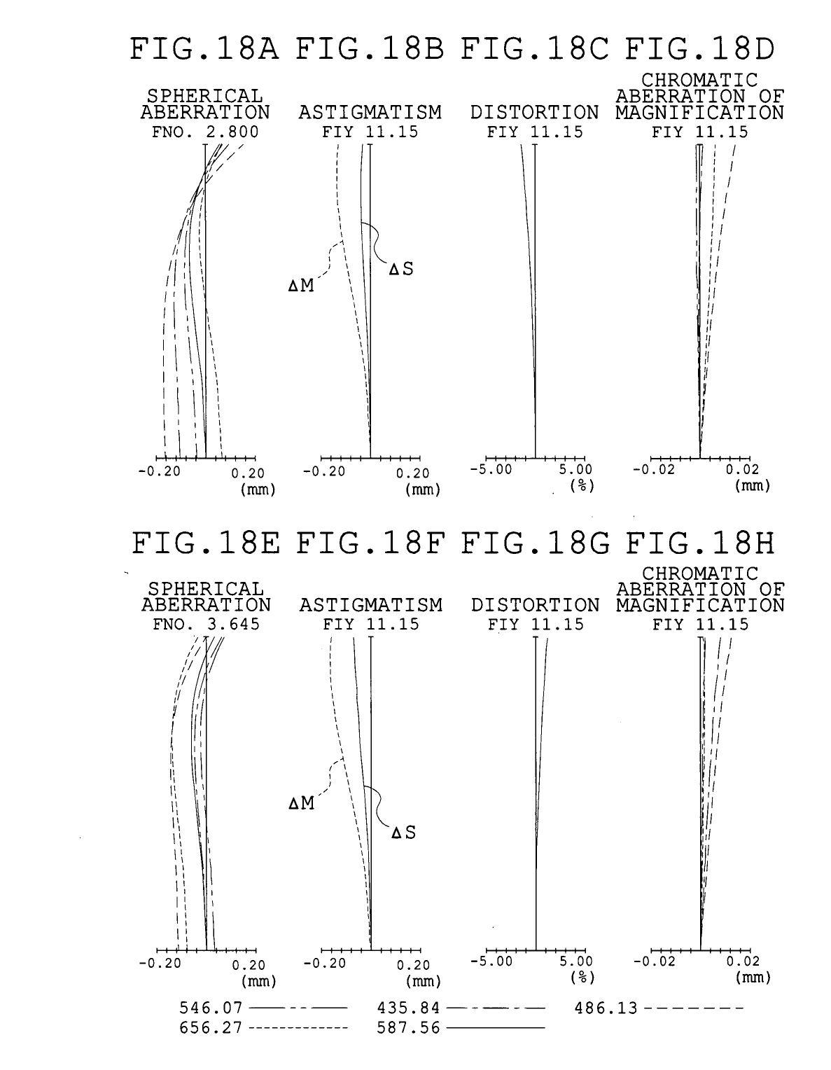

FIGS. 17A and 17B are a sectional view showing an optical formation in infinite object point focusing of an image pickup apparatus provided with a zoom lens according to the present embodiment, taken along the optical axis, and FIGS. 17A and 17B show the states in wide-angle end and telephoto end positions, respectively. FIGS. 18A, 18B, 18C, and 18D are views showing spherical aberration, astigmatism, distortion, and chromatic aberration of magnification in infinite object point focusing of the zoom lens shown in FIGS. 17A and 17B in the wide-angle end position, respectively, and FIGS. 18E, 18F, 18G, and 18H are views showing spherical aberration, astigmatism, distortion, and chromatic aberration of magnification in infinite object point focusing of the zoom lens shown in FIGS. 17A and 17B in the telephoto end position, respectively.

First, the optical formation of a zoom lens of the present embodiment is explained using FIGS. 17A and 17B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a piano-convex lens turning its convex surface toward the object side.

The third group G₃ has negative power as a whole. The third group G₃ comprises in order from the object side: a lens L₃₁ which is a piano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group Gₛ has positive power as a whole. The fifth group G₅ comprises, in order from the object side, a lens L₅₁ which is a biconvex lens, a lens L₅₂ the image-side surface of which is an aspherical surface and which is a negative meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 7
Unit: millimeter (mm)
Surface data:

| | | | | | effective |
|---|---|---|---|---|---|
| s | r | d | nd | νd | diameter |
| Object surface | ∞ | ∞ | | | |
| 1 | 218.8625 | 0.5266 | 1.63762 | 34.21 | 29.900 |
| 2* | 159.3964 | 0 | 1.0E+03 | −3.45 | 29.900 |
| 3 | 159.3985 | 2.8586 | 1.60999 | 27.48 | 29.900 |
| 4 | 110.6350 | 0.5000 | | | 29.900 |
| 5 | 101.8113 | 5.7517 | 1.51633 | 64.14 | 29.565 |
| 6 | −741.5701 | 0.1000 | | | 29.500 |
| 7 | 123.0468 | 7.0509 | 1.52542 | 55.78 | 29.199 |
| 8 | 197.3595 | variable | | | 28.470 |
| 9* | 55.7837 | 3.1842 | 1.63259 | 23.27 | 21.642 |
| 10 | 39.9112 | 0.5700 | | | 20.127 |
| 11 | 43.3571 | 10.1919 | 1.51633 | 64.14 | 20.112 |
| 12 | ∞ | variable | | | 19.133 |
| 13 | ∞ | 2.2200 | 1.88300 | 40.76 | 12.070 |
| 14 | 30.9738 | 3.4000 | | | 11.181 |
| 15 | −66.3647 | 2.0000 | 1.48749 | 70.23 | 11.210 |
| 16 | 28.8475 | 5.8213 | 1.84666 | 23.78 | 12.000 |
| 17 | −290.7168 | 2.0000 | | | 12.000 |
| 18 | −34.6524 | 2.0000 | 1.77250 | 49.60 | 12.000 |
| 19 | ∞ | variable | | | 12.550 |
| 20 | 233.8537 | 4.7151 | 1.69680 | 55.53 | 14.000 |
| 21 | −86.3088 | 0.1200 | | | 14.133 |
| 22 | 269.8871 | 1.1827 | 1.80610 | 40.92 | 14.061 |
| 23 | 54.8702 | 0.5000 | | | 13.937 |
| 24 | 52.9291 | 7.1506 | 1.51633 | 64.14 | 14.013 |
| 25 | −58.4051 | variable | | | 14.058 |
| 26 (stop) | ∞ | 1.2900 | | | 13.776 |
| 27 | 37.0595 | 5.0486 | 1.51823 | 58.90 | 13.947 |
| 28 | −145.7524 | 0.8700 | | | 13.764 |
| 29 | −66.0221 | 0.5112 | 1.63762 | 34.21 | 13.700 |
| 30* | −67.0967 | 0 | 1.0E+03 | −3.45 | 13.700 |
| 31 | −67.0955 | 3.5468 | 1.60999 | 27.48 | 13.700 |
| 32 | 129.4231 | 28.0621 | | | 13.700 |
| 33 | 140.7095 | 3.7729 | 1.65160 | 58.55 | 13.000 |
| 34 | −50.2631 | 10.4796 | | | 13.000 |
| 35 | −28.5111 | 1.8800 | 1.83481 | 42.72 | 11.181 |
| 36 | −54.3550 | variable | | | 11.469 |
| 37 | ∞ | 0.7000 | 1.51633 | 64.14 | 11.491 |
| 38 | ∞ | 0.9500 | | | 11.492 |
| 39 | ∞ | 0.4500 | 1.54200 | 77.40 | 11.492 |
| 40 | ∞ | 2.8000 | 1.54771 | 62.84 | 11.492 |
| 41 | ∞ | 0.4000 | | | 11.493 |
| 42 | ∞ | 0.7620 | 1.52310 | 54.49 | 11.493 |
| 43 | ∞ | variable | | | 11.493 |
| 44 (image plane) | ∞ | | | | |

Aspherical surface data:

The second surface
K = 0, A4 = −1.0534E−13, A6 = −2.4163E−15
The ninth surface
K = 0, A4 = −1.4037E−08, A6 = 6.7697E−11
The thirtieth surface
K = 0, A4 = −1.1113E−14

Various data:
Zoom ratio: 3.8770

| | Wide-angle | |
|---|---|---|
| | end position | Telephoto end position |
| f | 52.10143 | 201.99877 |
| Fno. | 2.80000 | 3.64521 |
| 2ω(°) | 24.50 | 6.25 |
| Image height | 11.15000 | 11.15000 |
| The total length of the lens | 192.42359 | 263.96429 |
| Back focus | 34.51001 | 58.53340 |
| Entrance pupil position | 87.90117 | 338.40811 |
| Exit pupil position | −82.17365 | −106.19704 |
| d8 | 14.33687 | 78.22755 |
| d12 | 1.08000 | 7.89854 |
| d19 | 24.19190 | 1.00000 |
| d25 | 1.00000 | 1.00000 |
| d36 | 29.22998 | 52.66889 |
| d43 | 0.86715 | 1.45162 |

Single lens data

| Lens | Lens surface | f |
|---|---|---|
| 1 | 1-4 | −376.2668 |
| 2 | 5-6 | 173.7827 |
| 3 | 7-8 | 602.2709 |
| 4 | 9-10 | −240.4236 |
| 5 | 11-12 | 83.9717 |
| 6 | 13-14 | −35.0780 |
| 7 | 15-16 | −40.9645 |
| 8 | 16-17 | 31.2574 |
| 9 | 18-19 | −44.8575 |
| 10 | 20-21 | 91.0243 |
| 11 | 22-23 | −85.6498 |
| 12 | 24-25 | 54.9785 |
| 13 | 27-28 | 57.5575 |
| 14 | 29-32 | −72.4225 |
| 15 | 33-34 | 57.2824 |
| 16 | 35-36 | −74.2894 |
| 17 | 37-38 | ∞ |
| 18 | 39-40 | ∞ |
| 19 | 40-41 | ∞ |
| 20 | 42-43 | ∞ |

Zoom lens group data:

| Group | Lens surface | f | Lens constitution length |
|---|---|---|---|
| 1 | 1-8 | 210.43468 | 16.78781 |
| 2 | 9-12 | 133.07978 | 13.94608 |
| 3 | 13-19 | −21.41054 | 17.44130 |
| 4 | 20-25 | 57.46929 | 13.66841 |
| 5 | 26-36 | 98.40533 | 55.46121 |
| 6 | 37-43 | ∞ | 6.06200 |

| | Position of | |
|---|---|---|
| Group | front-side principal point | Position of rear-side principal point |
| 1 | 0.96839 | −10.03339 |
| 2 | −0.09168 | −9.34931 |
| 3 | 4.58545 | −6.56410 |
| 4 | 5.47531 | −3.52984 |
| 5 | 5.54849 | −41.78360 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.41687 | 0.52118 |
| 3 | −0.51996 | −1.04554 |
| 4 | −5.08348 | 90.68013 |
| 5 | 0.22470 | −0.01943 |
| 6 | 1.00000 | 1.00000 |

| | |
|---|---|
| f₂/f_{w} | 2.55424 |
| f₁/f_{w} | 4.03894 |
| f₃/fₜ | −0.10599 |
| f₄/fₜ | 0.28450 |
| f₅/f_{w} | 1.88873 |
| F | 2.8~3.64521 |
| IH | 11.15 |
| fb/IH | 3.09507 |
| \|EW\| | 5.98086~7.69179 |

### Embodiment 8

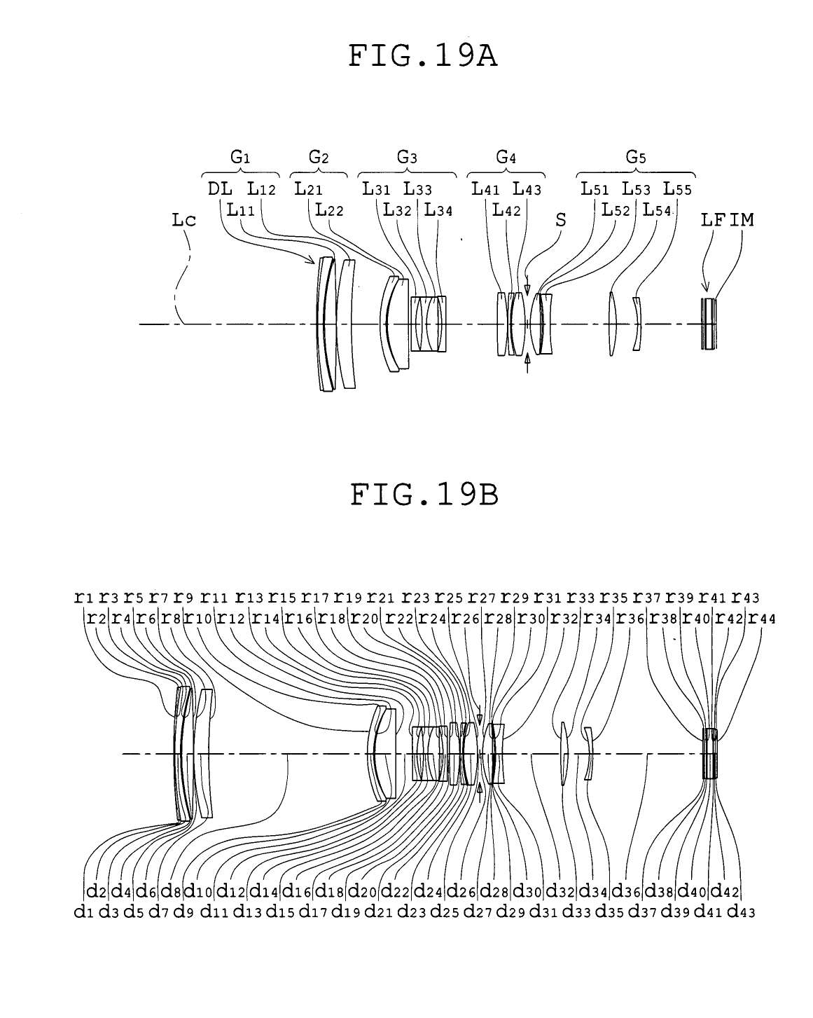

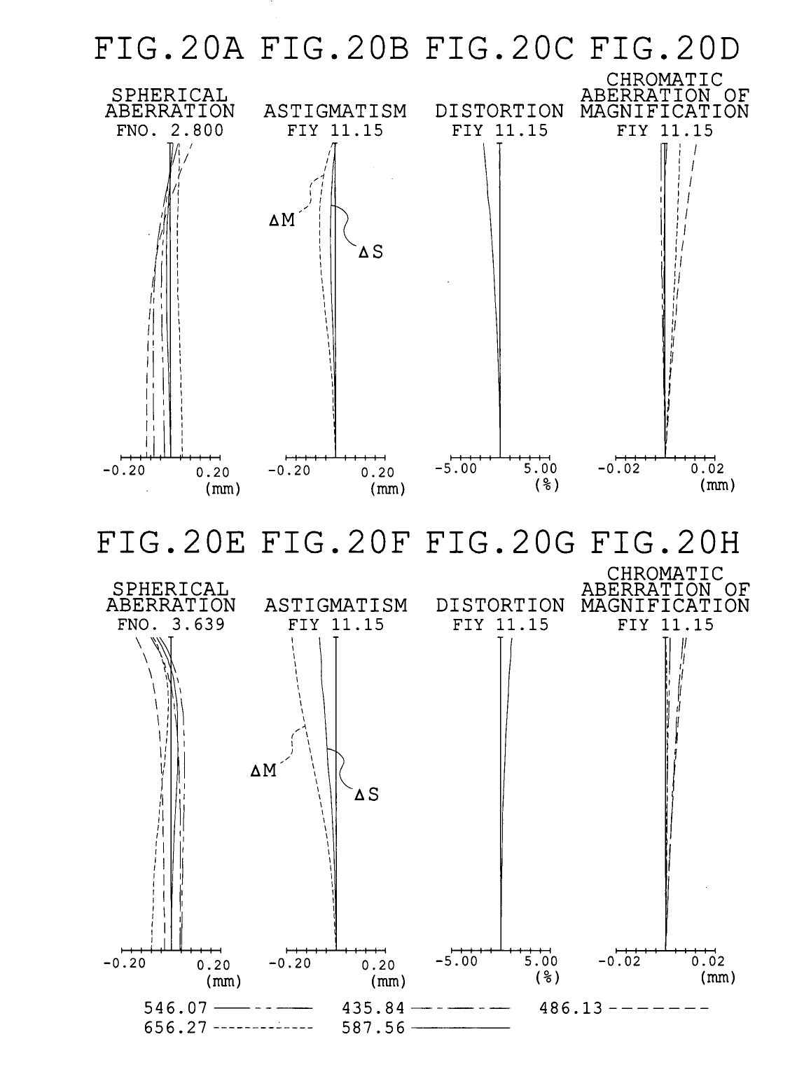

FIGS. 19A and 19B are a sectional view showing an optical formation in infinite object point focusing of an image pickup apparatus provided with a zoom lens according to the present embodiment, taken along the optical axis, and FIGS. 19A and 19B show the states in wide-angle end and telephoto end positions, respectively. FIGS. 20A, 20B, 20C, and 20D are views showing spherical aberration, astigmatism, distortion, and chromatic aberration of magnification in infinite object point focusing of the zoom lens shown in FIGS. 19A and 19B in the wide-angle end position, respectively, and FIGS. 20E, 20F, 20G, and 20H are views showing spherical aberration, astigmatism, distortion, and chromatic aberration of magnification in infinite object point focusing of the zoom lens shown in FIGS. 19A and 19B in the telephoto end position, respectively.

First, the optical formation of a zoom lens of the present embodiment is explained using FIGS. 19A and 19B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a piano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ the image-side surface of which is an aspherical surface and which is a positive meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 8
Unit: millimeter (mm)
Surface data:

| | | | | | effective |
|---|---|---|---|---|---|
| s | r | d | nd | νd | diameter |
| Object surface | ∞ | ∞ | | | |
| 1 | 224.0953 | 0.5150 | 1.63762 | 34.21 | 29.900 |
| 2* | 159.3964 | 0 | 1.0E+03 | −3.45 | 29.900 |
| 3 | 159.3983 | 2.9061 | 1.60999 | 27.48 | 29.900 |
| 4 | 110.0540 | 0.5000 | | | 29.900 |
| 5 | 101.1318 | 5.8739 | 1.51633 | 64.14 | 29.572 |
| 6 | −744.9689 | 0.1000 | | | 29.500 |
| 7 | 121.6306 | 6.9907 | 1.52542 | 55.78 | 29.207 |
| 8 | 198.9670 | variable | | | 28.496 |
| 9* | 55.9095 | 3.1412 | 1.63259 | 23.27 | 21.686 |
| 10 | 39.7000 | 0.5700 | | | 20.170 |
| 11 | 42.9000 | 10.4391 | 1.51633 | 64.14 | 20.160 |
| 12 | ∞ | variable | | | 19.166 |
| 13 | ∞ | 2.2200 | 1.88300 | 40.76 | 12.070 |
| 14 | 31.4682 | 3.4000 | | | 11.248 |
| 15 | −66.8258 | 2.0000 | 1.48749 | 70.23 | 11.276 |
| 16 | 28.8066 | 5.5898 | 1.84666 | 23.78 | 12.000 |
| 17 | −284.2911 | 2.0000 | | | 12.000 |
| 18 | −34.5147 | 2.0000 | 1.77250 | 49.60 | 12.000 |
| 19 | ∞ | variable | | | 12.550 |
| 20 | 234.8429 | 4.7622 | 1.69680 | 55.53 | 14.000 |
| 21 | −87.2108 | 0.1200 | | | 14.127 |
| 22 | 278.0643 | 1.1944 | 1.80610 | 40.92 | 14.052 |
| 23 | 53.4417 | 0.5000 | | | 13.922 |
| 24 | 52.7484 | 6.9917 | 1.51633 | 64.14 | 13.996 |
| 25 | −57.9741 | variable | | | 14.062 |
| 26 (stop) | ∞ | 1.2900 | | | 13.787 |
| 27 | 37.5324 | 5.0613 | 1.51823 | 58.90 | 13.966 |
| 28 | −143.7048 | 0.8700 | | | 13.785 |
| 29 | −67.6623 | 0.5136 | 1.63762 | 34.21 | 13.700 |
| 30* | −67.0938 | 0 | 1.0E+03 | −3.45 | 13.700 |
| 31 | −67.0926 | 3.5274 | 1.60999 | 27.48 | 13.700 |
| 32 | 125.0107 | 28.1164 | | | 13.700 |
| 33 | 140.0909 | 3.7014 | 1.65160 | 58.55 | 13.000 |
| 34 | −49.7574 | 10.6841 | | | 13.000 |
| 35 | −28.9957 | 1.8800 | 1.83481 | 42.72 | 11.154 |
| 36 | −56.2680 | variable | | | 11.431 |
| 37 | ∞ | 0.7000 | 1.51633 | 64.14 | 11.468 |
| 38 | ∞ | 0.9500 | | | 11.469 |
| 39 | ∞ | 0.4500 | 1.54200 | 77.40 | 11.470 |
| 40 | ∞ | 2.8000 | 1.54771 | 62.84 | 11.470 |
| 41 | ∞ | 0.4000 | | | 11.473 |
| 42 | ∞ | 0.7620 | 1.52310 | 54.49 | 11.473 |
| 43 | ∞ | variable | | | 11.474 |
| 44 (image plane) | ∞ | | | | |

Aspherical surface data:

The second surface
K = 0, A4 = −2.0682E−13, A6 = −1.8534E−15
The ninth surface
K = 0, A4 = 9.1388E−14, A6 = 3.8099E−11
The thirtieth surface
K = 0, A4 = −1.1065E−10, A6 = 1.7832E−13

Various data:
Zoom ratio: 3.8786

| | Wide-angle | |
|---|---|---|
| | end position | Telephoto end position |
| f | 52.08021 | 201.99899 |
| Fno. | 2.80000 | 3.63877 |
| 2ω(°) | 24.56 | 6.25 |
| Image height | 11.15000 | 11.15000 |
| The total length of the lens | 193.37493 | 263.66674 |
| Back focus | 34.78541 | 58.59117 |
| Entrance pupil position | 88.25541 | 335.28600 |
| Exit pupil position | −81.82412 | −105.79707 |
| d8 | 14.00278 | 77.75099 |
| d12 | 1.08000 | 7.86629 |
| d19 | 25.04845 | 1.00000 |
| d25 | 1.00000 | 1.00000 |
| d36 | 29.18521 | 53.15817 |
| d43 | 1.18731 | 1.02011 |

Single lens data:

| Lens | Lens surface | f |
|---|---|---|
| 1 | 1-4 | −362.0088 |
| 2 | 5-6 | 172.8639 |
| 3 | 7-8 | 577.5873 |
| 4 | 9-10 | −234.0360 |
| 5 | 11-12 | 83.0863 |
| 6 | 13-14 | −35.6380 |
| 7 | 15-16 | −41.0109 |
| 8 | 16-17 | 31.1484 |
| 9 | 18-19 | −44.6793 |
| 10 | 20-21 | 91.8245 |
| 11 | 22-23 | −82.2652 |
| 12 | 24-25 | 54.6664 |
| 13 | 27-28 | 57.9786 |
| 14 | 29-32 | −72.8302 |
| 15 | 33-34 | 56.7853 |
| 16 | 35-36 | −73.9820 |
| 17 | 37-38 | ∞ |
| 18 | 39-40 | ∞ |
| 19 | 40-41 | ∞ |
| 20 | 42-43 | ∞ |

Zoom Lens group data:

| Group | Lens surface | f | Lens constitution length |
|---|---|---|---|
| 1 | 1-8 | 210.61765 | 16.88567 |
| 2 | 9-12 | 132.79990 | 14.15030 |
| 3 | 13-19 | −21.70245 | 17.20980 |
| 4 | 20-25 | 58.95339 | 13.56835 |
| 5 | 26-36 | 97.36886 | 55.64418 |
| 6 | 37-43 | ∞ | 6.06200 |

| | Position of | |
|---|---|---|
| Group | front-side principal point | Position of rear-side principal point |
| 1 | 1.16079 | −9.91036 |
| 2 | −0.05716 | −9.45204 |
| 3 | 4.58217 | −6.47151 |
| 4 | 5.52398 | −3.40357 |
| 5 | 5.81860 | −41.63761 |
| 6 | 0 | −4.41289 |

Zoom lens group data (Magnification):

| | Magnification | Magnification |
|---|---|---|
| Group | (wide-angle end position) | (telephoto end position) |
| 1 | 0 | 0 |
| 2 | 0.41557 | 0.51913 |
| 3 | −0.53198 | −1.07137 |
| 4 | −5.19951 | 58.70954 |
| 5 | 0.21512 | −0.02937 |
| 6 | 1.00000 | 1.00000 |

| | |
|---|---|
| f₂/f_{w} | 2.54991 |
| f₁/f_{w} | 4.04410 |
| f₃/fₜ | −0.10744 |
| f₄/fₜ | 0.29185 |
| f₅/f_{w} | 1.86959 |
| F | 2.8~3.63877 |
| IH | 11.15 |
| fb/IH | 3.11977 |
| \|EW\| | 5.96830~7.65107 |

### Embodiment 9

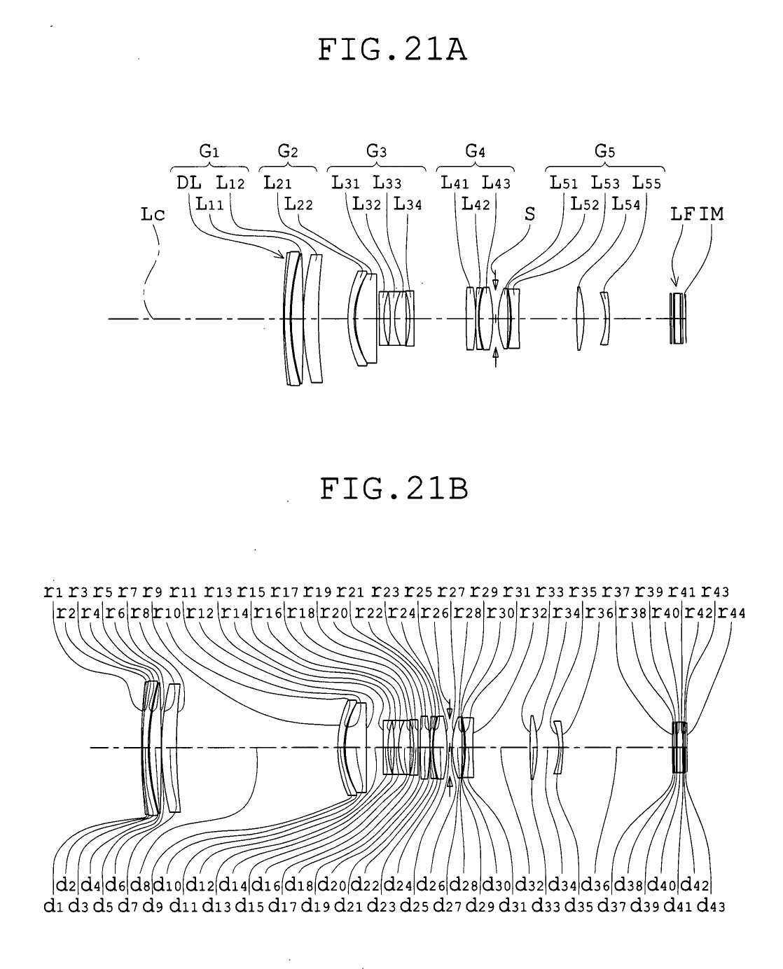

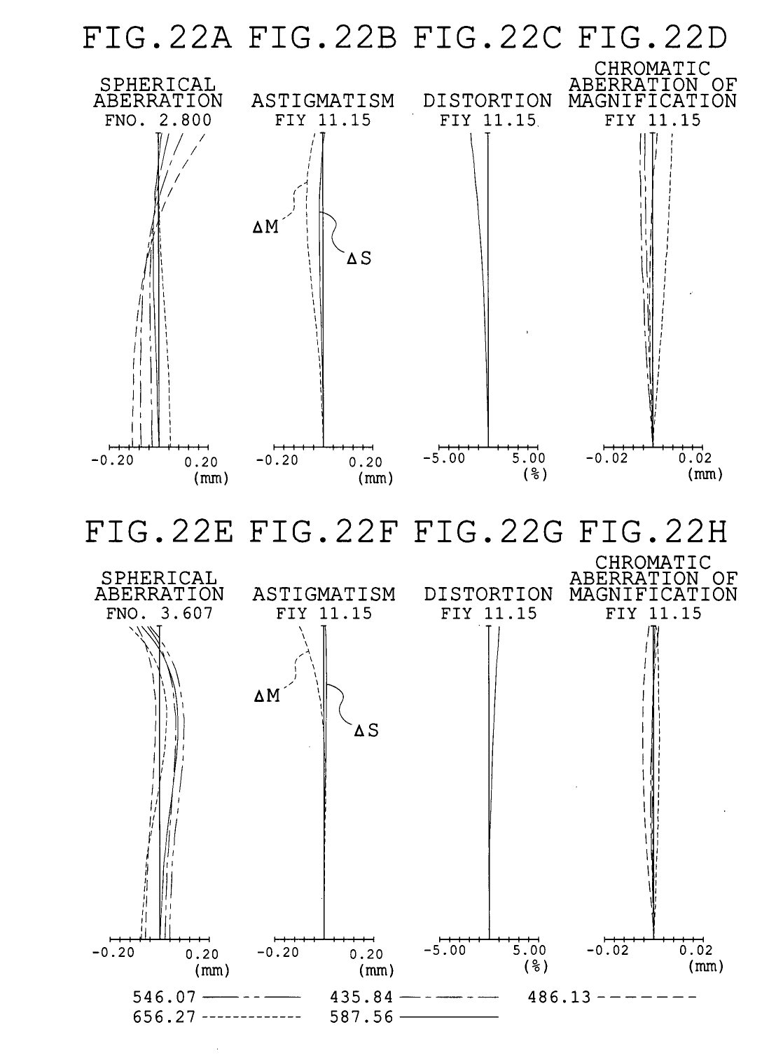

FIGS. 21A and 21B are a sectional view showing an optical formation in infinite object point focusing of an image pickup apparatus provided with a zoom lens according to the present embodiment, taken along the optical axis, and FIGS. 21A and 21B show the states in wide-angle end and telephoto end positions, respectively. FIGS. 22A, 22B, 22C, and 22D are views showing spherical aberration, astigmatism, distortion, and chromatic aberration of magnification in infinite object point focusing of the zoom lens shown in FIGS. 21A and 21B in the wide-angle end position, respectively, and FIGS. 22E, 22F, 22G, and 22H are views showing spherical aberration, astigmatism, distortion, and chromatic aberration of magnification in infinite object point focusing of the zoom lens shown in FIGS. 21A and 21B in the telephoto end position, respectively.

First, the optical formation of a zoom lens of the present embodiment is explained using FIGS. 21A and 21B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ the image-side surface of which is an aspherical surface and which is a negative meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 9
Unit: millimeter (mm)
Surface data:

| | | | | | effective |
|---|---|---|---|---|---|
| s | r | d | nd | νd | diameter |
| Object surface | ∞ | ∞ | | | |
| 1 | 226.5879 | 0.5102 | 1.63762 | 34.21 | 29.800 |
| 2* | 159.3964 | 0 | 1.0E+03 | −3.45 | 29.800 |
| 3 | 159.3984 | 2.8985 | 1.60999 | 27.48 | 29.800 |
| 4 | 110.1785 | 0.5000 | | | 29.800 |
| 5 | 99.2824 | 5.9956 | 1.51633 | 64.14 | 29.575 |
| 6 | −745.0560 | 0.1000 | | | 29.500 |
| 7 | 123.9750 | 7.1354 | 1.52542 | 55.78 | 29.200 |
| 8 | 198.4996 | variable | | | 28.461 |
| 9* | 55.5476 | 3.1514 | 1.63259 | 23.27 | 21.595 |
| 10 | 40.0002 | 0.5700 | | | 20.100 |
| 11 | 42.8473 | 10.4733 | 1.51633 | 64.14 | 20.068 |
| 12 | ∞ | variable | | | 19.042 |
| 13 | ∞ | 2.2200 | 1.88300 | 40.76 | 12.070 |
| 14 | 31.2127 | 3.4000 | | | 11.252 |
| 15 | −64.9550 | 2.0000 | 1.48749 | 70.23 | 11.275 |
| 16 | 29.1604 | 5.6192 | 1.84666 | 23.78 | 12.000 |
| 17 | −290.2397 | 2.0000 | | | 12.000 |
| 18 | −35.0722 | 2.0000 | 1.77250 | 49.60 | 12.000 |
| 19 | ∞ | variable | | | 12.550 |
| 20 | 237.8398 | 4.7618 | 1.69680 | 55.53 | 14.000 |
| 21 | −87.0869 | 0.1200 | | | 14.128 |
| 22 | 278.8784 | 1.1887 | 1.80610 | 40.92 | 14.052 |
| 23 | 53.2078 | 0.5000 | | | 13.922 |
| 24 | 52.9202 | 7.0238 | 1.51633 | 64.14 | 13.994 |
| 25 | −57.7573 | variable | | | 14.053 |
| 26 (stop) | ∞ | 1.2900 | | | 13.780 |
| 27 | 37.3862 | 5.0147 | 1.51823 | 58.90 | 13.964 |
| 28 | −143.8910 | 0.8700 | | | 13.789 |
| 29 | −66.9935 | 0.5219 | 1.63762 | 34.21 | 13.700 |
| 30* | −67.1265 | 0 | 1.0E+03 | −3.45 | 13.700 |
| 31 | −67.1253 | 3.5292 | 1.60999 | 27.48 | 13.700 |
| 32 | 125.5092 | 28.1998 | | | 13.700 |
| 33 | 141.4124 | 3.7486 | 1.65160 | 58.55 | 13.600 |
| 34 | −49.9516 | 10.6386 | | | 13.200 |
| 35 | −28.9148 | 1.8800 | 1.78800 | 47.37 | 13.200 |
| 36 | −57.7172 | variable | | | 11.603 |
| 37 | ∞ | 0.7000 | 1.51633 | 64.14 | 11.497 |
| 38 | ∞ | 0.9500 | | | 11.495 |
| 39 | ∞ | 0.4500 | 1.54200 | 77.40 | 11.493 |
| 40 | ∞ | 2.8000 | 1.54771 | 62.84 | 11.493 |
| 41 | ∞ | 0.4000 | | | 11.489 |
| 42 | ∞ | 0.7620 | 1.52310 | 54.49 | 11.488 |
| 43 | ∞ | variable | | | 11.487 |
| 44 (image plane) | ∞ | | | | |

Aspherical surface data:

The second surface
K = 0, A4 = −5.3261E−12, A6 = −1.4974E−17
The ninth surface
K = 0, A4 = −2.2783E−08, A6 = −3.7002E−12
The thirtieth surface
K = 0, A4 = −2.2597E−11, A6 = 1.9094E−13

Various data:
Zoom ratio: 3.8773

| | Wide-angle | |
|---|---|---|
| | end position | Telephoto end position |
| f | 52.09968 | 202.00420 |
| Fno. | 2.80000 | 3.60741 |
| 2ω(°) | 24.56 | 6.25 |
| Image height | 11.15000 | 11.15000 |
| The total length of the lens | 194.47540 | 264.07197 |
| Back focus | 35.05014 | 58.26984 |
| Entrance pupil position | 89.42962 | 339.46575 |
| Exit pupil position | −83.45389 | −106.67360 |
| d8 | 14.27258 | 78.04880 |
| d12 | 1.08000 | 7.89262 |
| d19 | 25.21198 | 1.00000 |
| d25 | 1.00000 | 1.00000 |
| d36 | 29.11978 | 53.05974 |
| d43 | 1.51746 | 0.79722 |

Single lens data:

| Lens | Lens surface | f |
|---|---|---|
| 1 | 1-4 | −358.9460 |
| 2 | 5-6 | 170.0861 |
| 3 | 7-8 | 608.4093 |
| 4 | 9-10 | −245.1713 |
| 5 | 11-12 | 82.9843 |
| 6 | 13-14 | 0.0121 |
| 7 | 15-16 | −40.9983 |
| 8 | 16-17 | 31.5518 |
| 9 | 18-19 | −45.4009 |
| 10 | 20-21 | 92.0381 |
| 11 | 22-23 | −81.7617 |
| 12 | 24-25 | 54.6675 |
| 13 | 27-28 | 57.8096 |
| 14 | 29-32 | −72.4330 |
| 15 | 33-34 | 57.0909 |
| 16 | 35-36 | −75.7085 |
| 17 | 37-38 | ∞ |
| 18 | 39-40 | ∞ |
| 19 | 40-41 | ∞ |
| 20 | 42-43 | ∞ |

Zoom lens group data:

| Group | Lens surface | f | Lens constitution length |
|---|---|---|---|
| 1 | 1-8 | 211.24688 | 17.13966 |
| 2 | 9-12 | 129.28578 | 14.19471 |
| 3 | 13-19 | −21.53804 | 17.23924 |
| 4 | 20-25 | 59.27756 | 13.59431 |
| 5 | 26-36 | 96.65079 | 55.69278 |
| 6 | 37-43 | ∞ | 6.06200 |

| | Position of | |
|---|---|---|
| Group | front-side principal point | Position of rear-side principal point |
| 1 | 1.07564 | −10.15516 |
| 2 | −0.02426 | −9.44850 |
| 3 | 4.53402 | −6.53904 |
| 4 | 5.56127 | −3.38402 |
| 5 | 6.70457 | −41.19942 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.40897 | 0.51232 |
| 3 | −0.54100 | −1.09682 |
| 4 | −5.28097 | 58.35558 |
| 5 | 0.21108 | −0.02916 |
| 6 | 1.00000 | 1.00000 |

| | |
|---|---|
| f₂/f_{w} | 2.48151 |
| f₁/f_{w} | 4.05467 |
| f₃/fₜ | −0.10662 |
| f₄/fₜ | 0.29345 |
| f₅/f_{w} | 1.85511 |
| F | 2.8~3.60741 |
| IH | 11.15 |
| fb/IH | 3.14351 |
| \|EW\| | 5.95375~7.57474 |

### Embodiment 10

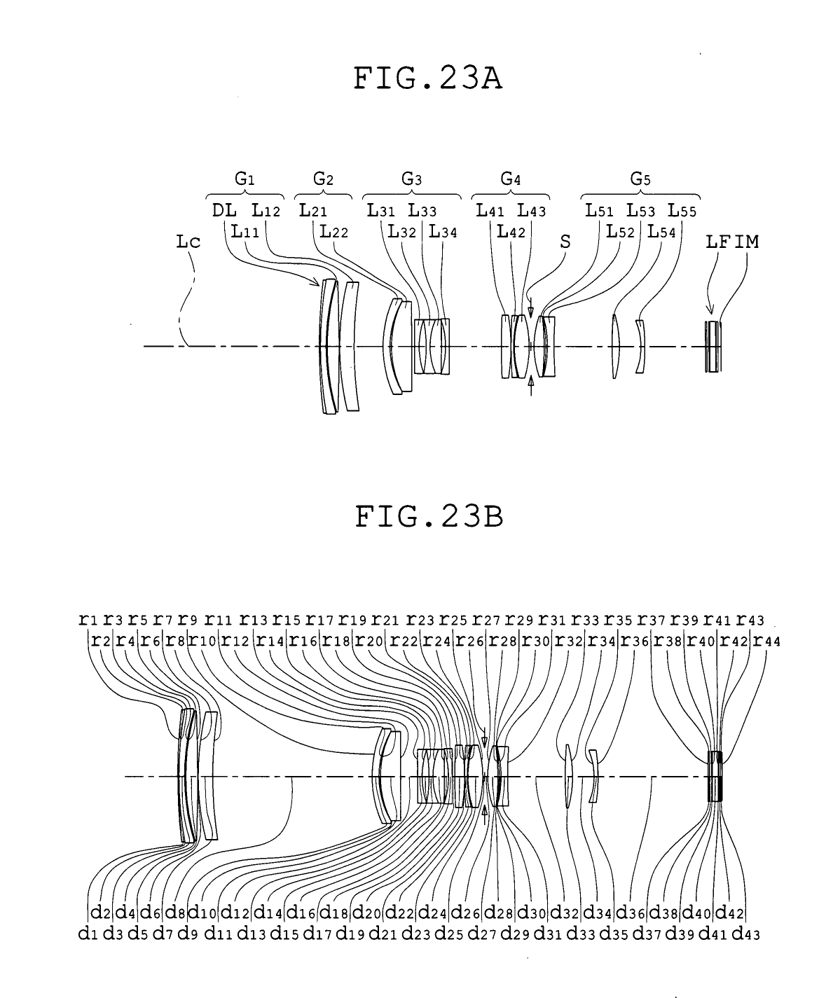

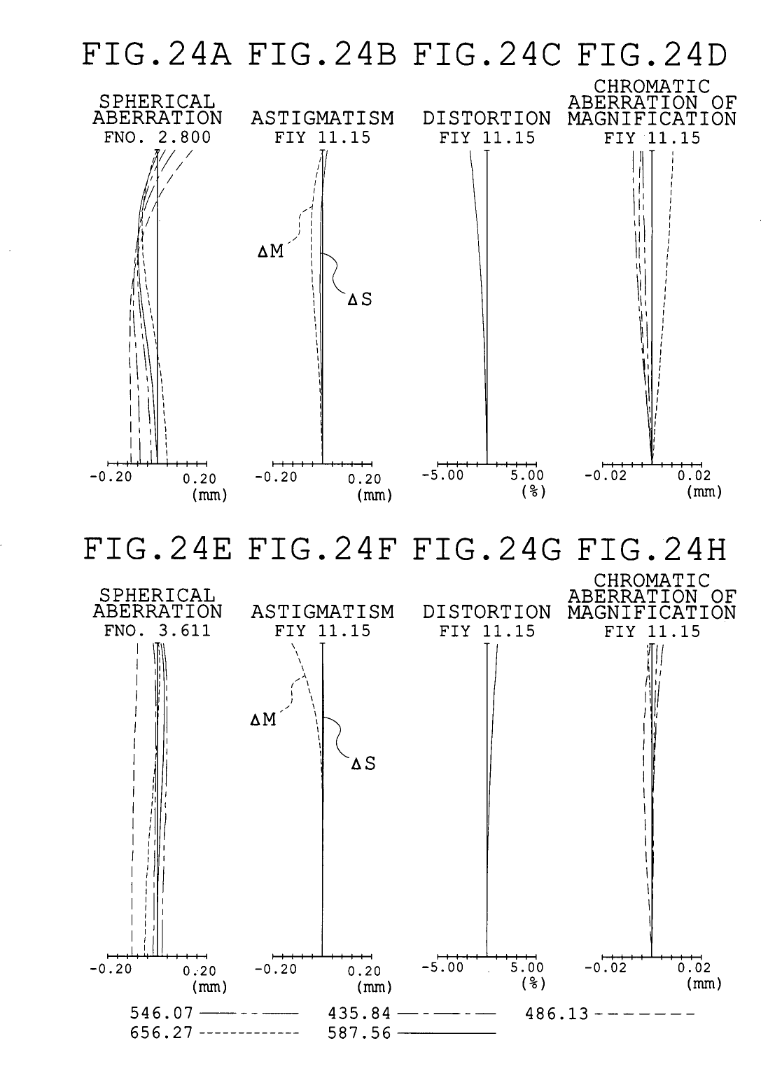

FIGS. 23A and 23B are a sectional view showing an optical formation in infinite object point focusing of an image pickup apparatus provided with a zoom lens according to the present embodiment, taken along the optical axis, and FIGS. 23A and 23B show the states in wide-angle end and telephoto end positions, respectively. FIGS. 24A, 24B, 24C, and 24D are views showing spherical aberration, astigmatism, distortion, and chromatic aberration of magnification in infinite object point focusing of the zoom lens shown in FIGS. 23A and 23B in the wide-angle end position, respectively, and FIGS. 24E, 24F, 24G, and 24H are views showing spherical aberration, astigmatism, distortion, and chromatic aberration of magnification in infinite object point focusing of the zoom lens shown in FIGS. 23A and 23B in the telephoto end position, respectively.

First, the optical formation of a zoom lens of the present embodiment is explained using FIGS. 23A and 23B. The zoom lens of the present embodiment comprises, in order from the object side, a first group G₁, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in to order from the object side, a diffraction-type optical element DL, a lens L₁₁ which is a biconvex lens, and a lens L₁₂ which is a positive meniscus lens turning its convex surface toward the object side.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ the image-side surface of which is an aspherical surface and which is a positive meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 10
Unit: millimeter (mm)
Surface data:

| | | | | | effective |
|---|---|---|---|---|---|
| s | r | d | nd | νd | diameter |
| Object surface | ∞ | ∞ | | | |
| 1 | 225.5739 | 0.5089 | 1.63762 | 34.21 | 30.000 |
| 2* | 159.3964 | 0 | 1.0E+03 | −3.45 | 30.000 |
| 3 | 159.3981 | 2.8986 | 1.60999 | 27.48 | 30.000 |
| 4 | 109.8583 | 0.5000 | | | 30.000 |
| 5 | 99.2363 | 5.9670 | 1.51633 | 64.14 | 29.573 |
| 6 | −748.1522 | 0.1000 | | | 29.500 |
| 7 | 122.9672 | 7.1143 | 1.52542 | 55.78 | 29.200 |
| 8 | 197.5677 | variable | | | 28.464 |
| 9* | 55.6662 | 3.1190 | 1.63259 | 23.27 | 21.579 |
| 10 | 39.6834 | 0.5700 | | | 20.078 |
| 11 | 42.3991 | 10.4068 | 1.51633 | 64.14 | 20.046 |
| 12 | ∞ | variable | | | 19.054 |
| 13 | ∞ | 2.2200 | 1.88300 | 40.76 | 12.070 |
| 14 | 31.3220 | 3.4000 | | | 11.252 |
| 15 | −65.0265 | 2.0000 | 1.48749 | 70.23 | 11.275 |
| 16 | 29.3955 | 5.5762 | 1.84666 | 23.78 | 12.000 |
| 17 | −288.2398 | 2.0000 | | | 12.000 |
| 18 | −35.0052 | 2.0000 | 1.77250 | 49.60 | 12.000 |
| 19 | ∞ | variable | | | 12.550 |
| 20 | 238.4755 | 4.8197 | 1.69680 | 55.53 | 14.000 |
| 21 | −87.4042 | 0.1200 | | | 14.131 |
| 22 | 279.7680 | 1.1916 | 1.80610 | 40.92 | 14.058 |
| 23 | 53.5465 | 0.5000 | | | 13.930 |
| 24 | 52.6557 | 7.0814 | 1.51633 | 64.14 | 14.004 |
| 25 | −58.0039 | variable | | | 14.072 |
| 26 (stop) | ∞ | 1.2900 | | | 13.798 |
| 27 | 37.3877 | 5.0730 | 1.51823 | 58.90 | 13.980 |
| 28 | −145.2109 | 0.8700 | | | 13.799 |
| 29 | −67.2644 | 0.5181 | 1.63762 | 34.21 | 13.700 |
| 30* | −67.1252 | 0 | 1.0E+03 | −3.45 | 13.700 |
| 31 | −67.1239 | 3.5013 | 1.60999 | 27.48 | 13.700 |
| 32 | 124.6773 | 28.3275 | | | 13.700 |
| 33 | 141.0864 | 3.7110 | 1.65100 | 56.16 | 13.200 |
| 34 | −49.9555 | 10.5827 | | | 13.200 |
| 35 | −28.8960 | 1.8800 | 1.78800 | 47.37 | 11.340 |
| 36 | −57.7151 | variable | | | 11.609 |
| 37 | ∞ | 0.7000 | 1.51633 | 64.14 | 11.495 |
| 38 | ∞ | 0.9500 | | | 11.494 |
| 39 | ∞ | 0.4500 | 1.54200 | 77.40 | 11.492 |
| 40 | ∞ | 2.8000 | 1.54771 | 62.84 | 11.491 |
| 41 | ∞ | 0.4000 | | | 11.487 |
| 42 | ∞ | 0.7620 | 1.52310 | 54.49 | 11.486 |
| 43 | ∞ | variable | | | 11.485 |
| 44 (image plane) | ∞ | | | | |

Aspherical surface data:

The second surface
K = 0, A4 = −4.4094E−12, A6 = 2.3296E−17
The ninth surface
K = 0, A4 = −3.2364E−08, A6 = 3.0054E−11
The thirtieth surface
K = 0, A4 = 1.8957E−12, A6 = −3.9127E−14

Various data:
Zoom ratio: 3.8783

| | Wide-angle end position | Telephoto end position |
|---|---|---|
| f | 52.07893 | 201.97523 |
| Fno. | 2.80000 | 3.61092 |
| 2ω(°) | 24.58 | 6.25 |
| Image height | 11.15000 | 11.15000 |
| The total length of the | 194.33240 | 264.18241 |
| lens | | |
| Back focus | 34.99021 | 58.39359 |
| Entrance pupil position | 89.14562 | 339.03622 |
| Exit pupil position | −83.49714 | −106.90052 |
| d8 | 14.29681 | 78.06082 |
| d12 | 1.08000 | 7.88109 |
| d19 | 25.11846 | 1.00000 |
| d25 | 1.00000 | 1.00000 |
| d36 | 29.15109 | 53.06080 |
| d43 | 1.42623 | 0.91990 |

Single lens data:

| Lens | Lens surface | f |
|---|---|---|
| 1 | 1-4 | −356.9391 |
| 2 | 5-6 | 170.0957 |
| 3 | 7-8 | 600.0956 |
| 4 | 9-10 | −236.3576 |
| 5 | 11-12 | 82.1163 |
| 6 | 13-14 | −35.4724 |
| 7 | 15-16 | −41.2409 |
| 8 | 16-17 | 31.7619 |
| 9 | 18-19 | −45.3142 |
| 10 | 20-21 | 92.3545 |
| 11 | 22-23 | −82.3437 |
| 12 | 24-25 | 54.6455 |
| 13 | 27-28 | 57.9225 |
| 14 | 29-32 | −72.6164 |
| 15 | 33-34 | 57.1085 |
| 16 | 35-36 | −75.6118 |
| 17 | 37-38 | ∞ |
| 18 | 39-40 | ∞ |
| 19 | 40-41 | ∞ |
| 20 | 42-43 | ∞ |

Zoom lens group data:

| Group | Lens surface | f | Lens constitution length |
|---|---|---|---|
| 1 | 1-8 | 210.95715 | 17.08889 |
| 2 | 9-12 | 129.66880 | 14.09575 |
| 3 | 13-19 | −21.53005 | 17.19617 |
| 4 | 20-25 | 59.09443 | 13.71259 |
| 5 | 26-36 | 96.93444 | 55.75353 |
| 6 | 37-43 | ∞ | 6.06200 |

| | Position of front-side | |
|---|---|---|
| Group | principal point | Position of rear-side principal point |
| 1 | 1.08129 | −10.11658 |
| 2 | −0.00472 | −9.36557 |
| 3 | 4.53925 | −6.51534 |
| 4 | 5.59787 | −3.42415 |
| 5 | 6.71438 | −41.29285 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.41006 | 0.51363 |
| 3 | −0.53850 | −1.09011 |
| 4 | −5.24762 | 60.22954 |
| 5 | 0.21304 | −0.02839 |
| 6 | 1.00000 | 1.00000 |

| | |
|---|---|
| f₂/f_{w} | 2.48985 |
| f₁/f_{w} | 4.05071 |
| f₃/fₜ | −0.10660 |
| f₄/fₜ | 0.29258 |
| f₅/f_{w} | 1.86130 |
| F | 2.8~3.61092 |
| IH | 11.15 |
| fb/IH | 3.13814 |
| \|EW\| | 5.94125~7.57081 |

### Embodiment 11

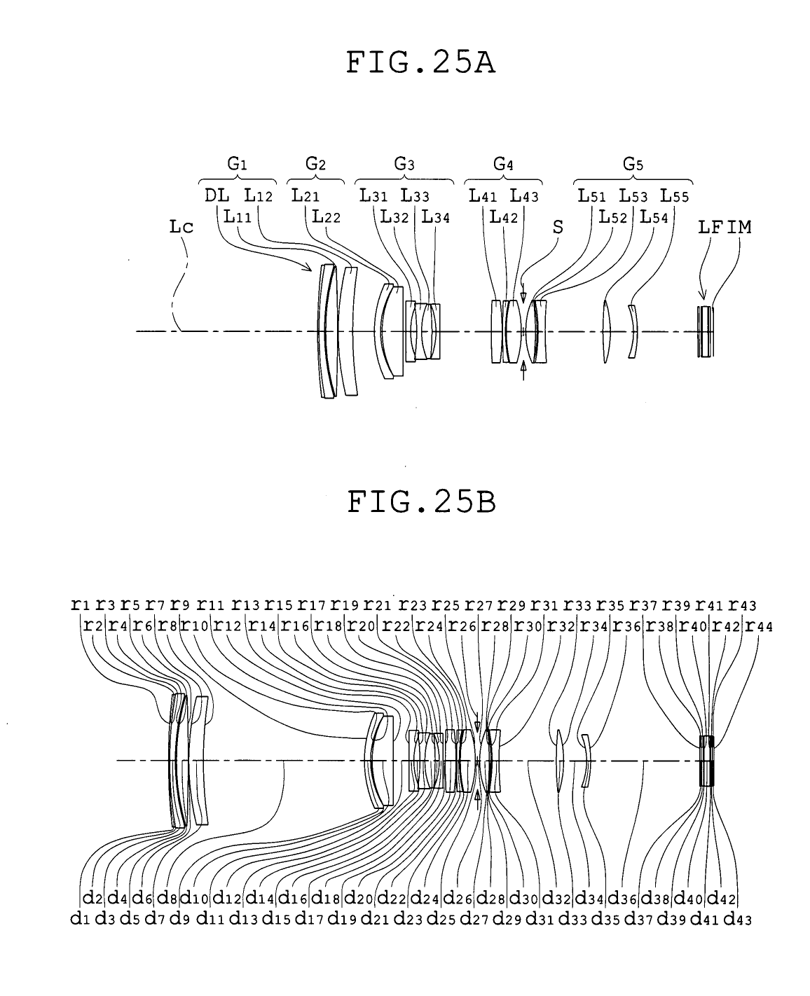

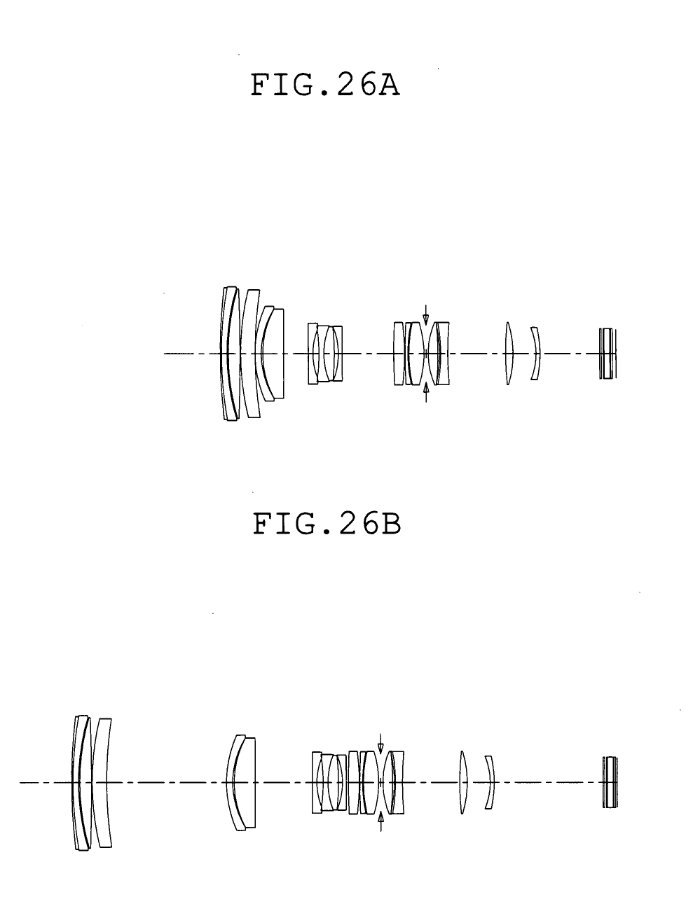

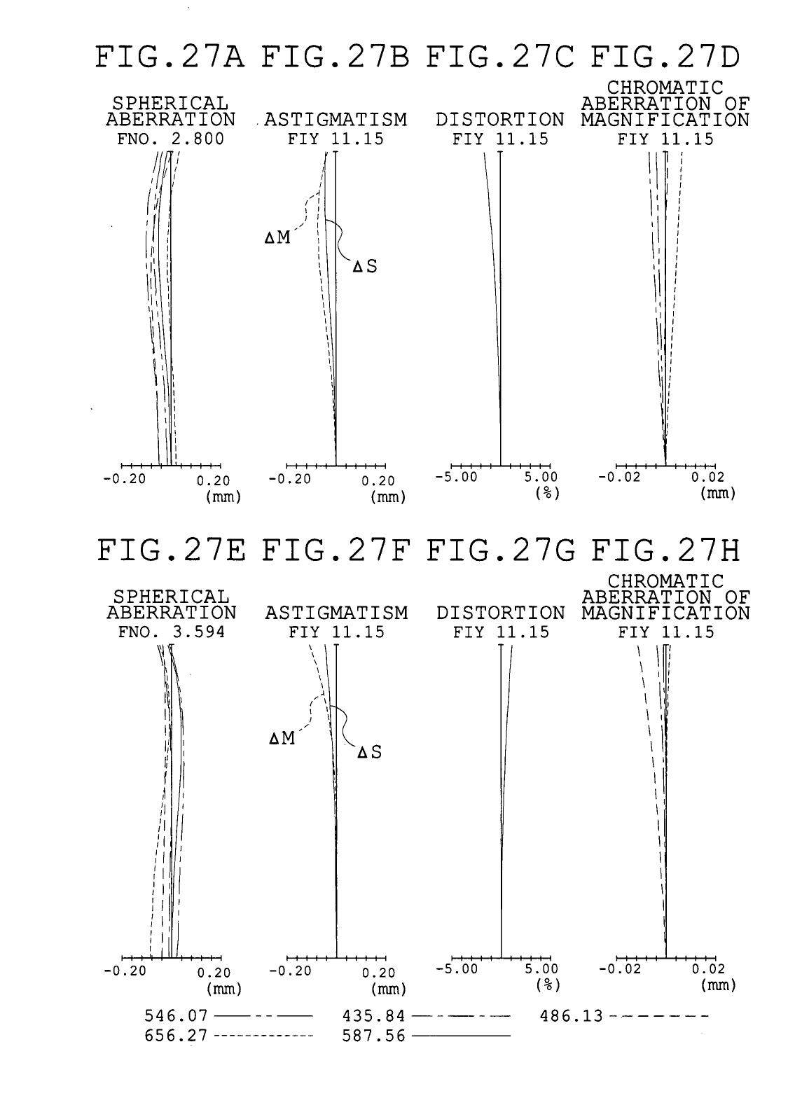

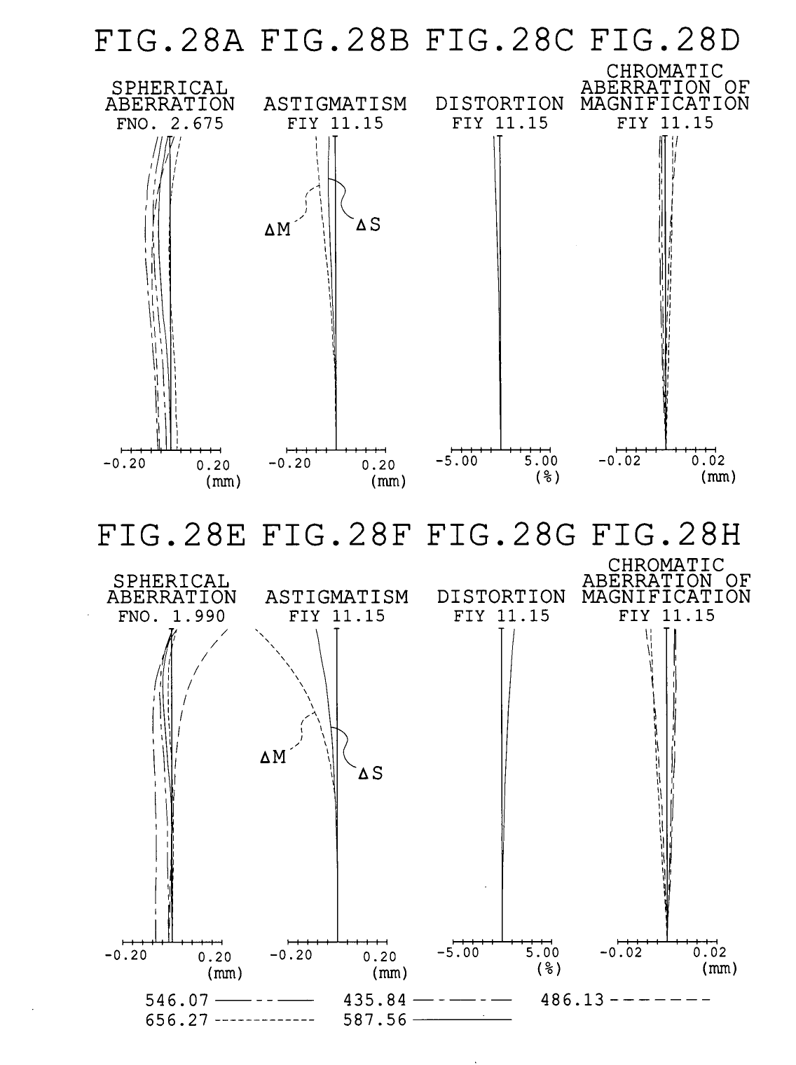

FIGS. 25A and 25B are a sectional view showing an optical formation in infinite object point focusing of an image pickup apparatus provided with a zoom lens according to the present embodiment, taken along the optical axis, and FIGS. 25A and 25B show the states in wide-angle end and telephoto end positions, respectively. FIGS. 26A and 26B are a sectional view showing an optical formation in close-far object point focusing of the image pickup apparatus provided with the zoom lens according to the present embodiment, taken along the optical axis, and FIGS. 26A and 26B show the states in wide-angle end and telephoto end positions, respectively. FIGS. 27A, 27B, 27C, and 27D are views showing spherical aberration, astigmatism, distortion, and chromatic aberration of magnification in infinite object point focusing of the zoom lens shown in FIGS. 25A, 25B, 26A, and 26B in the wide-angle end position, respectively, and FIGS. 27E, 27F, 27G, and 27H are views showing spherical aberration, astigmatism, distortion, and chromatic aberration of magnification in infinite object point focusing of the zoom lens shown in FIGS. 25A, 25B, 26A, and 26B in the telephoto end position, respectively. FIGS. 28A, 28B, 28C, and 28D are views showing spherical aberration, astigmatism, distortion, and chromatic aberration of magnification in close object point focusing of the zoom lens shown in FIGS. 25A, 25B, 26A, and 26B in the wide-angle end position, respectively, and FIGS. 28E, 28F, 28G, and 28H are views showing spherical aberration, astigmatism, distortion, and chromatic aberration of magnification in close object point focusing of the zoom lens shown in FIGS. 25A, 25B, 26A, and 26B in the telephoto end position, respectively.

First, the optical formation of a zoom lens of the present embodiment is explained using FIGS. 25A, 25B, 26A, and 26B. The zoom lens of the present embodiment comprises, in order from the object side, a first group G_{I}, a second group G₂, a third group G₃, a fourth group G₄, and a fifth group G₅ on the optical axis Lc. Besides, a stop S which is formed integratedly with the fifth group G₅ is arranged between the fourth group G₄ and the fifth group G₅. Also, a CCD the pixel pitch of which is about 3 to 5.5 μm and which has an image pickup plane IM is arranged on the image side of the fifth group G₅. Also, an optical low-pass filter LF which is given an IR-cut coating or the like is arranged between the fifth group G₅ and the image pickup plane IM. Further, a CCD cover glass or the like may be arranged between the fifth group G₅ and the image pickup plane IM.

The first group G₁ has positive power as a whole. The first group G₁ comprises, in order from the object side, a diffraction-type optical element DL, a lens L₁₁ which is a biconvex lens, and a lens L₁₂ which is a positive meniscus lens turning its convex surface toward the object side.

Besides, the diffraction-type optical element DL has negative power as a whole. The diffraction-type optical element DL comprises: a negative meniscus lens the image-side surface of which is an aspherical surface and which turns its convex surface toward the object side; and a negative meniscus lens which turns its convex surface toward the object side. And, a relief pattern is formed on the boundary surface between these negative meniscus lenses and the boundary surface becomes a diffractive surface.

The second group G₂ has positive power as a whole. The second group G₂ comprises in order from the object side: a lens L₂₁ the object-side surface of which is an aspherical surface and which is a negative meniscus lens turning its convex surface toward the object side; and a lens L₂₂ which is a plano-convex lens turning its convex surface toward the object side.

The third group G₃ has negative power as a whole. The third group G₃ comprises in order from the object side: a lens L₃₁ which is a plano-concave lens turning its concave surface toward the image side; a cemented lens which comprises a biconcave lens L₃₂ and a biconvex lens L₃₃ and has positive power; and a lens L₃₄ which is a plano-concave lens turning its concave surface toward the object side.

The fourth group G₄ has positive power as a whole. The fourth group G₄ comprises, in order from the object side, a lens L₄₁ which is a biconvex lens, a lens L₄₂ which is a negative meniscus lens turning its convex surface toward the image side, and a lens L₄₃ which is a biconvex lens.

The fifth group G₅ has positive power as a whole. The fifth group G₅ comprises, in order from the object side, a lens L₅₁ which is a biconvex lens, a lens L₅₂ the image-side surface of which is an aspherical surface and which is a positive meniscus lens turning its concave surface toward the object side, a lens L₅₃ which is a biconcave lens, a lens L₅₄ which is a biconvex lens, and a lens L₅₅ which is a negative meniscus lens turning its concave surface toward the object side.

Also, in changing a magnification from the wide-angle end position to the telephoto end position, the first group G₁ moves toward the object side on the optical axis Lc. The second group G₂ moves toward the object side on the optical axis Lc in such a way that the space between the first and second groups G₁ and G₂ is expanded. The third group G₃ is fixed, so that the third group G₃ does not move. The fourth group G₄ moves toward the object side on the optical axis Lc in such a way that the space between the third and fourth groups G₃ and G₄ is shortened. The fifth group G₅ moves toward the object side on the optical axis Lc in such a way that the space between the fourth and fifth groups G₄ and G₅ is expanded first and then is shortened. In this case, the stop S moves integratedly with the fifth group G₅.

Besides, only the third group G₃ has negative power and, accordingly, the third group has relatively high power, so that manufacturing errors cause wide variation in performance. As a result, variation in performance of the zoom lens also becomes wide in making the zoom lens. Accordingly, in the present embodiment, the third group G₃ is fixed in changing a magnification from the wide-angle end position to the telephoto end position in order to check the variation in performance occurring in making the zoom lens.

Also, a focusing is carried out by moving the second group G₂.

Next, the constitution and numerical data of lenses which constitute the zoom lens according to the present embodiment are shown.

Numerical value data 11
Unit: millimeter (mm)
Surface data:

| | | | | | effective |
|---|---|---|---|---|---|
| s | r | d | nd | νd | diameter |
| Object surface | ∞ | ∞ | | | |
| 1 | 226.9685 | 0.5098 | 1.63762 | 34.21 | 30.000 |
| 2* | 159.3964 | 0 | 1.0E+03 | −3.45 | 30.000 |
| 3 | 159.3980 | 2.7460 | 1.60999 | 27.48 | 30.000 |
| 4 | 107.1176 | 0.5000 | | | 30.000 |
| 5 | 101.7920 | 5.6969 | 1.51633 | 64.14 | 29.564 |
| 6 | −876.9097 | 0.1000 | | | 29.500 |
| 7 | 115.2563 | 7.3188 | 1.52542 | 55.78 | 29.241 |
| 8 | 208.0249 | variable | | | 28.535 |
| 9* | 54.8917 | 3.0821 | 1.63259 | 23.27 | 21.556 |
| 10 | 39.9967 | 0.5700 | | | 20.323 |
| 11 | 45.1321 | 10.3906 | 1.51633 | 64.14 | 20.325 |
| 12 | ∞ | variable | | | 19.356 |
| 13 | ∞ | 2.2200 | 1.88300 | 40.76 | 12.070 |
| 14 | 32.4077 | 3.4000 | | | 11.433 |
| 15 | −68.3662 | 2.0000 | 1.48749 | 70.23 | 11.458 |
| 16 | 29.6036 | 5.1528 | 1.84666 | 23.78 | 12.100 |
| 17 | −286.1328 | 2.0000 | | | 12.100 |
| 18 | −34.8060 | 2.0000 | 1.77250 | 49.60 | 12.100 |
| 19 | ∞ | variable | | | 12.600 |
| 20 | 237.2747 | 5.4705 | 1.69680 | 55.53 | 14.000 |
| 21 | −90.7627 | 0.1200 | | | 14.229 |
| 22 | 315.3327 | 1.1328 | 1.80610 | 40.92 | 14.229 |
| 23 | 55.2538 | 0.5000 | | | 14.175 |
| 24 | 52.1342 | 7.4789 | 1.51633 | 64.14 | 14.296 |
| 25 | −56.9780 | variable | | | 14.368 |
| 26 (stop) | ∞ | 1.2900 | | | 14.067 |
| 27 | 37.7698 | 4.7162 | 1.51823 | 58.90 | 14.215 |
| 28 | −129.1322 | 0.8700 | | | 14.083 |
| 29 | −67.4881 | 0.5585 | 1.63762 | 34.21 | 14.000 |
| 30* | −67.0546 | 0 | 1.0E+03 | −3.45 | 14.000 |
| 31 | −67.0532 | 3.3250 | 1.60999 | 27.48 | 14.000 |
| 32 | 119.8564 | 28.3207 | | | 14.000 |
| 33 | 129.8099 | 3.5890 | 1.52542 | 55.78 | 13.000 |
| 34 | −45.3974 | 11.2066 | | | 13.000 |
| 35 | −27.4859 | 1.8800 | 1.78800 | 47.37 | 11.269 |
| 36 | −47.2132 | variable | | | 11.582 |
| 37 | ∞ | 0.7000 | 1.51633 | 64.14 | 11.508 |
| 38 | ∞ | 0.9500 | | | 11.507 |
| 39 | ∞ | 0.4500 | 1.54200 | 77.40 | 11.506 |
| 40 | ∞ | 2.8000 | 1.54771 | 62.84 | 11.506 |
| 41 | ∞ | 0.4000 | | | 11.503 |
| 42 | ∞ | 0.7620 | 1.52310 | 54.49 | 11.503 |
| 43 | ∞ | variable | | | 11.502 |
| 44 (image plane) | ∞ | | | | |

Aspherical surface data:

The second surface
K = 0, A4 = 3.0177E−12, A6 = 5.0962E−16
The ninth surface
K = 0, A4 = 4.3032E−08, A6 = 6.8529E−11
The thirtieth surface
K = 0, A4 = −2.1243E−10, A6 = 1.3871E−13

Various data:
Zoom ratio: 3.8783

| | Wide-angle end position | Telephoto end position |
|---|---|---|
| f | 52.08168 | 201.99903 |
| Fno. | 2.80000 | 3.59384 |
| 2ω(°) | 24.57 | 6.25 |
| Image height | 11.15000 | 11.15000 |
| The total length of the | 191.11070 | 264.09489 |
| lens | | |
| Back focus | 35.05860 | 58.03014 |
| Entrance pupil position | 81.97457 | 336.85958 |
| Exit pupil position | −84.03103 | −107.00256 |
| Object surface | ∞ | ∞ |
| d8 | 10.77513 | 78.36403 |
| d12 | 1.08000 | 7.55546 |
| d19 | 25.05171 | 1.00000 |
| d25 | 1.00000 | 1.00000 |
| d36 | 29.11482 | 53.26169 |
| d43 | 1.53089 | 0.35556 |

| | Wide-angle |
|---|---|
| | end position in close object point focusing |
| f | 58.61786 |
| Fno. | 2.68352 |
| 2ω(°) | 20.73 |
| Image height | 11.15000 |
| The total length of the lens | 191.11070 |
| Back focus | 35.05860 |
| Entrance pupil position | 99.30983 |
| Exit pupil position | −84.03103 |
| Object surface | 910.00000 |
| d8 | 0.17509 |
| d12 | 11.68004 |
| d19 | 25.05171 |
| d25 | 1.00000 |
| d36 | 29.11482 |
| d43 | 1.53089 |
| | Telephoto |
| | end position in close object point focusing |
| f | 186.49073 |
| Fno. | 1.99028 |
| 2ω(°) | 3.71 |
| Image height | 11.15000 |
| The total length of the lens | 264.09489 |
| Back focus | 58.03014 |
| Entrance pupil position | 531.13779 |
| Exit pupil position | −107.00256 |
| Object surface | 787.99837 |
| d8 | 58.63970 |
| d12 | 27.27979 |
| d19 | 1.00000 |
| d25 | 1.00000 |
| d36 | 53.26169 |
| d43 | 0.35556 |

Single lens data:

| Lens | Lens surface | f |
|---|---|---|
| 1 | 1-4 | −337.4676 |
| 2 | 5-6 | 176.9916 |
| 3 | 7-8 | 478.8823 |
| 4 | 9-10 | −253.3163 |
| 5 | 11-12 | 87.4095 |
| 6 | 13-14 | −36.7019 |
| 7 | 15-16 | −42.0951 |
| 8 | 16-17 | 31.9257 |
| 9 | 18-19 | −45.0564 |
| 10 | 20-21 | 94.8667 |
| 11 | 22-23 | −83.2690 |
| 12 | 24-25 | 53.9866 |
| 13 | 27-28 | 56.9384 |
| 14 | 29-32 | −71.7939 |
| 15 | 33-34 | 64.4696 |
| 16 | 35-36 | −87.1389 |
| 17 | 37-38 | ∞ |
| 18 | 39-40 | ∞ |
| 19 | 40-41 | ∞ |
| 20 | 42-43 | ∞ |

Zoom lens group data:

| Group | Lens surface | f | Lens constitution length |
|---|---|---|---|
| 1 | 1-8 | 209.82096 | 16.87146 |
| 2 | 9-12 | 137.55898 | 14.04274 |
| 3 | 13-19 | −22.19489 | 16.77282 |
| 4 | 20-25 | 58.83489 | 14.70222 |
| 5 | 26-36 | 102.28166 | 55.75602 |
| 6 | 37-43 | ∞ | 6.06200 |

| | | Position of |
|---|---|---|
| Group | Position of front-side principal point | rear-side principal point |
| 1 | 1.30600 | −9.76383 |
| 2 | −0.21252 | −9.53575 |
| 3 | 4.55147 | −6.32758 |
| 4 | 6.12411 | −3.53792 |
| 5 | 5.85468 | −42.76227 |
| 6 | 0 | −4.41289 |

Zoom lens group data (magnification):

| | Magnification | Magnification |
|---|---|---|
| Group | (wide-angle end position) | (telephoto end position) |
| 1 | 0 | 0 |
| 2 | 0.42060 | 0.53016 |
| 3 | −0.52421 | −1.06745 |
| 4 | −4.70745 | −116.83503 |
| 5 | 0.23915 | 0.01456 |
| 6 | 1.00000 | 1.00000 |

| | Magnification |
|---|---|
| Group | (wide-angle end position in close object point focusing) |
| 1 | −0.29911 |
| 2 | 0.34354 |
| 3 | −0.52421 |
| 4 | −4.70745 |
| 5 | 0.23915 |
| 6 | 1.00000 |

| | Magnification |
|---|---|
| Group | (telephoto end position in close object point focusing) |
| 1 | −0.36443 |
| 2 | 0.38678 |
| 3 | −1.06745 |
| 4 | −116.83503 |
| 5 | 0.01456 |
| 6 | 1.00000 |

| | |
|---|---|
| f₂/f_{w} | 2.64122 |
| f₁/f_{w} | 4.02869 |
| f₃/fₜ | −0.10988 |
| f₄/fₜ | 0.29126 |
| f₅/f_{w} | 1.96387 |
| F | 2.8~3.59384 |
| MG | −0.25596 |
| Δd/fₜ | 0.09765 |
| IH | 11.15 |
| fb/IH | 3.14427 |
| \|EW\| | 5.93705~7.52752 |

Also, a zoom lens of the present invention may be formed as described below. In a zoom lens of the present invention, a flare stop may be arranged in addition to an aperture stop in order to cut off unwanted light such as ghost and/or flare. Besides, the flare stop may be arranged at any of positions on the object side of the first lens group, between the first and second lens groups, between the second and third lens groups, between the third and fourth lens groups, between the fourth and fifth lens groups, and between the fifth lens group and the image pickup plane. Also, the flare stop may be constructed with a frame member or with another member. In addition, the flare stop may be formed in such a way that it is printed directly on an optical member or that paint, an adhesive seal, or the like is used. The flare stop may have any of shapes of a circle, an ellipse, a rectangle, a polygon, and a contour surrounded by a function curve. The flare stop may be formed to cut off not only detrimental light beams but also light rays such as coma flare on the periphery of an image surface.

Also, in a zoom lens of the present invention, antireflection coat may be applied to each lens so that ghost and/or flare is reduced. In this case, in order to lessen ghost and/or flare more effectively, it is desirable that the antireflection coat to be applied is a multi-coat. Also, an Infrared-cutoff coat may be applied not to a low-pass filter but to the lens surface of each lens, a cover grass and so on.

Besides, in order to prevent ghost and/or flare from occurring, it is generally performed that the antireflection coat is applied to the air contact surface of a lens. On the other hand, the refractive index of an adhesive on the cementing surface of a cemented lens is much higher than that of air. Hence, the cementing surface of a cemented lens often has the reflectance originally equal to or less than a single layer coat, and thus the coat is not particularly applied in most case. However, when the antireflection coat is positively applied also to the cementing surface of a cemented lens, ghost and/or flare can be further lessened and a more favorable image can be obtained.

In particular, high-refractive index grass materials by which the high effect of correction for aberration is obtained have been popularized in recent years and have come to be often used in optical systems for cameras. However, when the high-refractive index glass material is used for the cemented lens, reflection at the cementing surface ceases to be negligible. In this case, the application of the antireflection coat to the cementing surface is particularly effective.

Such effective use of the coat of the cementing surface is disclosed in each of Japanese patent Kokai Nos. Hei 2-27301, 2001-324676, 2005-92115 and U.S. Pat. No. 7,116,482. It is only necessary that a relatively high-refractive index coating substance, such as Ta₂O₅, TiO₂, Nb₂O₅, ZrO₂, HfO₂, CeO₂, SnO₂, In₂O₃, ZnO, or Y₂O₃, or a relatively low-refractive index coating substance, such as MgF₂, SiO₂, or Al₂O is properly selected as a coating substance used for the coat in accordance with the refractive index of a lens for a substrate and the refractive index of the adhesive and is set to a film thickness such as to satisfy a phase condition.

Also, as a matter of course, the coat of the cementing surface, like the coating on the air contact surface of a lens, may be used as a multi-coat. A proper combination of a coat substance used with the number of films of two or more layers and a film thickness of the coat substance makes it possible to reduce reflectance more and it possible to control the spectral characteristic and/or the angular characteristic of the reflectance. Also, it goes without saying that it is effective to make a coat of a cementing surface in a cementing surface of lenses in lens groups except the first lens group on the basis of the same idea.

Also, in a zoom lens of the present invention, it is preferred that focusing for focus adjustment is carried out by the third lens group. However, focusing for focus adjustment may be carried out by any one of the first lens group, the second lens group and the fourth lens group, or by more than one lens group. Also, the focusing may be carried out by moving the whole of the zoom lens, or by moving a part of the lenses in the zoom lens.

Also, in the zoom lens of the present invention, a decline in brightness of the periphery of an image may be reduced by shifting a micro lens of a CCD. For example, a design for a micro lens of a CCD may be changed in accordance with an angle of incidence of a light ray in each image height, or an amount of a decline in brightness of the periphery of an image may be corrected by an image processing.

The above-described zoom lenses according to the present invention can be used for an image pickup apparatus in which photograph is carried out by imaging an object image formed by the zoom lens in an image pickup element such as a CCD, especially, a digital camera, a video camera, or the like. The embodiments of the image pickup apparatuses will be shown below.

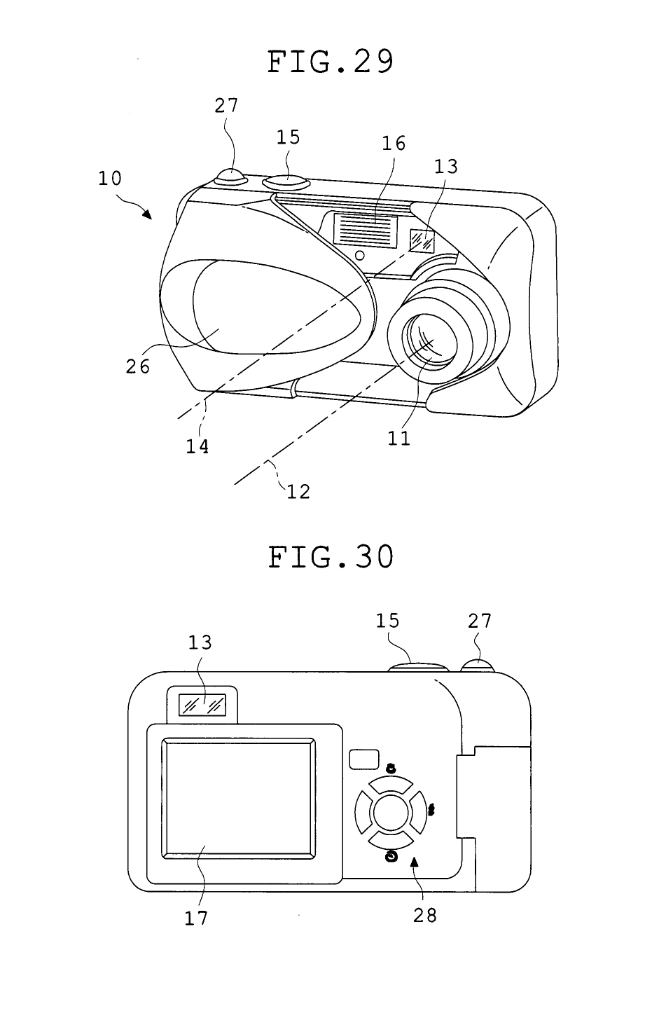

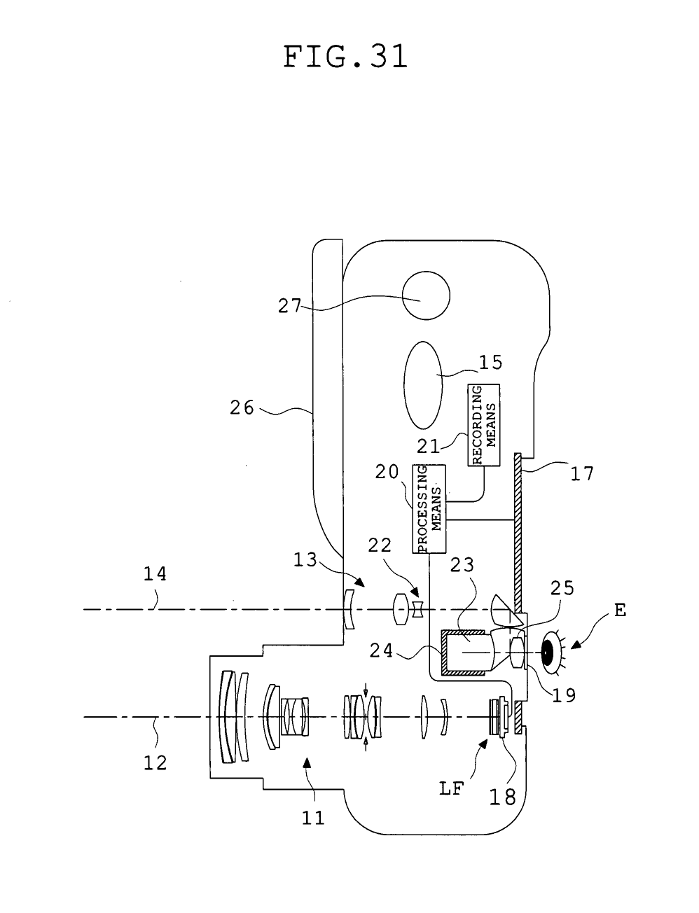

FIGS. 29, 30, and 31 are a conceptual view showing the formation of a digital camera using the present invention. FIG. 29 is a front perspective view showing the appearance of the digital camera, FIG. 30 is a rear elevation of the digital camera shown in FIG. 29, and FIG. 31 is a transparent plane view schematically showing the formation of the digital camera. In this case, FIGS. 29 and 31 are a view showing the digital camera in which the zoom lens is not collapsed.

A digital camera 10 is provided with a zoom lens 11 arranged on a photography optical path 12, a finder optical system 13 arranged on a finder optical path 14, a shutter button 15, a flash light emitting section 16, a liquid crystal display monitor 17, a focal length-changing button 27, and a setting change switch 28. Also, the digital camera 10 is formed in such a way that a cover 26 slides and covers the zoom lens 11 and the finder optical system 13 in collapsing the zoom lens 11.

When the cover 26 is opened and the digital camera 10 is set in a photographing state, the zoom lens 11 is set in a non-collapsed state as shown in FIG. 29. When the shutter button 15 arranged on the upper face of the digital camera 10 is pressed in this state, photography is linked to the press of the shutter button 15 and is carried out through the zoom lens 11, for example, the zoom lens as described in the first embodiment of the present invention. An object image is formed on the image pickup plane of a CCD 18 of a charge coupled device through the zoom lens 11, a low-pass filter LF, and a cover grass CG. The image information of the object image formed on the image pickup plane of the CCD 18 is recorded in a recording means 21 through a processing means 20. Also, the image information recorded in the recording means 21 is taken out by the processing means 20, and the image information can be also displayed as an electronic image on the liquid crystal display monitor 17 which is provided on the rear face of the camera.

Further, a finder objective optical system 22 is arranged on the finder optical path 14. The finder objective optical system 22 comprises more than one lens group (three groups are shown in the drawing) and two prisms. The finder objective optical system 22 is linked to the zoom lens 11 and the focal length changes by the linkage. In the finder objective optical system 22, an object image is formed on a field frame 24 for an erecting prism 23 which is a member for erecting an image. And, eyepiece optical system 25 is arranged on the rear side of the erecting prism 23 and leads an image formed as an erecting image to an observer's eye E. Besides, a cover member 19 is arranged on the exit side of the eyepiece optical system 25.

In the digital camera 10 with such formation, the zoom lens 11 has a high variable magnification ratio, the size of the zoom lens 11 is small, and it is possible to make a collapsible storage of the zoom lens 11, so that it is possible to downsize the digital camera 10 with good performances for the camera secured.

What is claimed is:

1. A zoom lens comprising, in order from the object side, at least, a positive first group with a diffraction-type optical element, a positive second group, and a negative third group,
wherein a space between the first and second groups and a space between the second and third groups increase in changing a magnification from the wide-angle end position to the telephoto end position, and the third group is fixed.

2. A zoom lens according to claim 1 comprising, in order from the object side, the positive first group with a diffraction-type optical element, the positive second group, the negative third group, a positive fourth group, and a positive fifth group,
wherein each of spaces between the groups changes in changing a magnification.

3. A zoom lens comprising, in order from the object side, a positive first group with a diffraction-type optical element, a positive second group, a negative third group, a positive fourth group, and a positive fifth group,
wherein, in changing a magnification, at least the first group is capable of moving, and each of spaces between the groups changes.

4. A zoom lens according to claim 3, wherein the first group is located on the object side more in the telephoto end position than in the wide-angle end position.

5. An image pickup apparatus comprising a zoom lens according to any one of claims 1 to 4 and an image pickup element which is arranged on the image side of the zoom lens and transforms an image formed by the zoom lens into electrical signals.
